(19) United States
(12) Patent Application Publication
(10) Pub. No.: US 2010/0211413 A1
(43) Pub. Date: Aug. 19, 2010

(54) REVISING CONTAINERIZED PROCESSING LOGIC FOR USE IN INSURANCE CLAIM PROCESSING

(75) Inventors: Rob Tholl, Calgary (CA); Raymonf Leung, Calgary (CA); Clayton Russell, Calgary (CA)

Correspondence Address: OCCHIUTI ROHLICEK & TSAO, LLP, 10 FAWCETT STREET, CAMBRIDGE, MA, 02138, US

(73) Assignee: Emergis Inc., Calgary (CA)

(21) Appl. No.: 12/388,283

(22) Filed: Feb. 18, 2009

(51) Int. Cl. G06Q 40/00; G06Q 10/00

(52) U.S. Cl. 705/4

(57) ABSTRACT

A system and method for revising one or more hierarchies of an insurance plan, the insurance plan for use in adjudicating one or more insurance claims. The method and system comprising obtaining one or more claims from a claims queue, the claims queue for storing claims selected for review. The system and method comprising accessing at least one of a set of benefit codes or a set of adjudication rules associated with the insurance plan of the obtained one or more claims, wherein at least some of the set of benefit codes or the set of adjudication rules are structured in a plurality of containers. The system and method comprising reconfiguring selected content of the at least one of a set of benefit codes or the set of adjudication rules in view of identified reasons for review of the one or more claims; and storing the reconfigured at least one of a set of benefit codes or the set of adjudication rules in a memory for subsequent use as at least one of a redeployed version of the insurance plan or a revised said at least one of a set of benefit codes or the set of adjudication rules for use in development of other insurance plans for adjudication of claims other than the one or more claims obtained from the claims queue; wherein the revised insurance plan, once deployed, is adapted for use by an adjudication engine for processing insurance claims received by the adjudication engine.

### FIELD OF THE INVENTION

This invention relates to reconfiguration of insurance plan definitions used in insurance claim processing.

### BACKGROUND OF THE INVENTION

It is recognised in the health care industry that in order to service patient population, health care providers, by necessity, have become participants in many networks. This requires the complex management of many fee schedules, rule sets, and service code definitions, a process that is commonly outside of the capabilities of most practice management systems. The process is then left up to the carrier adjudicating the insurance claims, creating further inefficiencies and added costs to health plans. Further, it is recognised that there are many industry efforts in place to reduce cost, as well as constant Federal and State legislative changes, electronic transaction code sets, and privacy and security requirements. Therefore, health claims processing has become a costly and time consuming endeavour in the current health care industry.

For example, the current healthcare claims system is the source where inefficiencies contribute in administrative overhead and delays. Furthermore, providers are suffering from bad debt expenses on patient payment amounts. In addition the current medical claims system is fraught with the high potential for errors and omissions resulting in more cost to process claims. Providers realise that the reduction of their Account Receivables balance and reconciliation time is desirable. This reduction can happen through more direct eligibility verification, streamlined management of many network relationships, and faster payment. For payers, a key to more efficient plan management is increasing their membership. This membership increase can happen through a value proposition which includes increasing auto-adjudication rates by reducing rejected claims and eliminating many of the steps required in order to accomplish today's claims administration. There is a need for the implementation of a tool for helping to increase auto-adjudication rates of an adjudication engine in the processing of insurance claims, such that the tool is configured as flexible enough to implement revised plans/benefits and associated adjudication rules and benefit code configurations more rapidly and/or at lower costs than current insurance plan systems, based on errors encountered during the adjudication process.

### SUMMARY OF THE INVENTION

It is an object of the present invention to provide a benefit and rule reconfiguration environment to obviate or mitigate at least some of the above-presented disadvantages.

There is a need for the implementation of a tool for helping to increase auto-adjudication rates of an adjudication engine in the processing of insurance claims, such that the tool is configured as flexible enough to implement revised plans/benefits and associated adjudication rules and benefit code configurations more rapidly and/or at lower costs than current insurance plan systems, based on errors encountered during the adjudication process. Contrary to current systems, there is provided a system and method for revising one or more hierarchies of an insurance plan, the insurance plan for use in adjudicating one or more insurance claims. The method and system comprising obtaining one or more claims from a claims queue, the claims queue for storing claims selected for review. The system and method comprising accessing at least one of a set of benefit codes or a set of adjudication rules associated with the insurance plan of the obtained one or more claims, wherein at least some of the set of benefit codes or the set of adjudication rules are structured in a plurality of containers. The system and method comprising reconfiguring selected content of the at least one of a set of benefit codes or the set of adjudication rules in view of identified reasons for review of the one or more claims; and storing the reconfigured at least one of a set of benefit codes or the set of adjudication rules in a memory for subsequent use as at least one of a redeployed version of the insurance plan or a revised said at least one of a set of benefit codes or the set of adjudication rules for use in development of other insurance plans for adjudication of claims other than the one or more claims obtained from the claims queue; wherein the revised insurance plan, once deployed, is adapted for use by an adjudication engine for processing insurance claims received by the adjudication engine.

A first aspect provided is method for revising one or more hierarchies of an insurance plan, the insurance plan for use in adjudicating one or more insurance claims, the method comprising the steps of: obtaining one or more claims from a claims queue, the claims queue for storing claims selected for review; accessing at least one of a set of benefit codes or a set of adjudication rules associated with the insurance plan of the obtained one or more claims, wherein at least some of the set of benefit codes or the set of adjudication rules are structured in a plurality of containers; reconfiguring selected content of the at least one of a set of benefit codes or the set of adjudication rules in view of identified reasons for review of the one or more claims; and storing the reconfigured at least one of a set of benefit codes or the set of adjudication rules in a memory for subsequent use as at least one of a redeployed version of the insurance plan or a revised said at least one of a set of benefit codes or the set of adjudication rules for use in development of other insurance plans for adjudication of claims other than the one or more claims obtained from the claims queue; wherein the revised insurance plan, once deployed, is adapted for use by an adjudication engine for processing insurance claims received by the adjudication engine.

A further aspect provided is system for revising one or more hierarchies of an insurance plan, the insurance plan for use in adjudicating one or more insurance claims, the system comprising: a claims queue for obtaining one or more claims there from, the claims queue for storing claims selected for review; a claims module adapted for accessing at least one of a set of benefit codes or a set of adjudication rules associated with the insurance plan of the obtained one or more claims, wherein at least some of the set of benefit codes or the set of adjudication rules are structured in a plurality of containers; a reconfiguration module adapted for reconfiguring selected content of the at least one of a set of benefit codes or the set of adjudication rules in view of identified reasons for review of the one or more claims; and a deployment module adapted for storing the reconfigured at least one of a set of benefit codes or the set of adjudication rules in a memory for subsequent use as at least one of a redeployed version of the insurance plan or a revised said at least one of a set of benefit codes or the set of adjudication rules for use in development of other insurance plans for adjudication of claims other than the one or more claims obtained from the claims queue; wherein the revised insurance plan, once deployed, is adapted for use by an adjudication engine for processing insurance claims received by the adjudication engine.

A further aspect provided is a memory for storing data for access by an application program being executed on a data processing system, comprising: a data structure stored in said memory, said data structure including information resident in a database used by said adjudication engine program and including: a set of adjudication rules stored in said memory appropriate to processing a received claim of an adjudication engine, the set of adjudication rules structured in a plurality of containers including a primary rule container and a plurality of secondary rule containers, each of the plurality of secondary rule containers being coupled to the primary rule container by a respective container reference, each of the plurality of secondary rule containers containing one or more adjudication rules adapted for processing the claim content of the received claim, each of the one or more adjudication rules being coupled to their respective secondary container by a respective rule reference, the set of adjudication rules defining a rule hierarchy; wherein processing the content of the received claim with the one or more adjudication rules is facilitated by an execution order defined by the ordering of the container references in the primary rule container.

A further aspect provided of the data structure is a set of benefit codes stored in said memory appropriate to the received claim, the set of benefit codes structured in a plurality of benefit containers including a primary benefit container and a plurality of secondary benefit containers, each of the plurality of secondary benefit containers being coupled to the primary benefit container by a respective benefit container reference, each of the plurality of secondary benefit containers containing one or more benefit codes adapted for processing the claim content of the received claim, each of the one or more benefit codes being coupled to their respective secondary benefit container by a respective benefit reference, the set of benefit codes defining a benefit hierarchy.

The application program can be any of the engines, such as a composer engine, a reconfiguration engine, a reconfiguration engine and a plan engine.

### BRIEF DESCRIPTION OF THE DRAWINGS

Exemplary embodiments of the invention will now be described in conjunction with the following drawings, by way of example only, in which:

FIG. 1 is a schematic of a claim processing environment;

FIG. 2 is a block diagram of an exemplary embodiment of the environment of FIG. 1;

FIG. 3 is a block diagram of a structured memory of the environment of FIG. 1;

FIG. 4 shows an example claim of the environment of FIG. 1;

FIG. 5a is example grammar logic of the rule engine of FIG. 2;

FIG. 5b is an example parameterized rule using the logic of FIG. 5a;

FIG. 6a shows an example embodiment of a rule data structure of FIG. 3;

FIG. 6b shows a further embodiment of the rule data structure of FIG. 6a;

FIG. 6c shows an example embodiment of a service code data structure of FIG. 3;

FIG. 7 is an example interface of the rule engine 20 of FIG. 2;

FIG. 8 is another example interface of the rule engine 20 of FIG. 2;

FIG. 9 is another example interface of the rule engine 20 of FIG. 2;

FIG. 10 is an embodiment of the rule and service code data structure of FIG. 3;

FIG. 11 is an example configuration of the rule engine of FIG. 2;

FIG. 12a is an example configuration of the rules of FIG. 3;

FIG. 12b is an example configuration of the rule blocks of FIG. 3;

FIG. 13 shows a block diagram of a computer device for implementing the components of the environment of FIG. 1;

FIG. 14 is a flow-chart of steps performed by the adjudication engine of the environment of FIG. 2;

FIG. 15 is a flow-chart of steps performed by the composer engine of the environment of FIG. 2;

FIG. 16 is a diagram of an example management process for the environment of FIG. 1;

FIG. 17 is an example configuration of a modification process of rule and/or benefit hierarchies of the system of FIG. 2;

FIG. 18 is an example block diagram of modifications performed by a plan engine of the system of FIG. 2;

FIG. 19 is an example block diagram of an embodiment of the plan engine of FIG. 18;

FIG. 20 shows an example workflow of the plan engine of FIG. 18;

FIG. 21 is a flow chart of steps performed by the plan engine of FIG. 2;

FIG. 22 is a block diagram of an example configuration of the engines of FIG. 2;

FIG. 23 is an example configuration of engines of FIG. 2;

FIG. 24 is an example configuration of a reconfiguration engine of the environment of FIG. 2;

FIG. 25 is an example interface provided by the engine of FIG. 24

FIG. 26 is a flow-chart of steps performed by the engine FIG. 24; and

FIGS. 27-78 are example user screen shots generated by the rule engine of FIG. 2.

### DETAILED DESCRIPTION OF THE EMBODIMENT(S)

### System 10

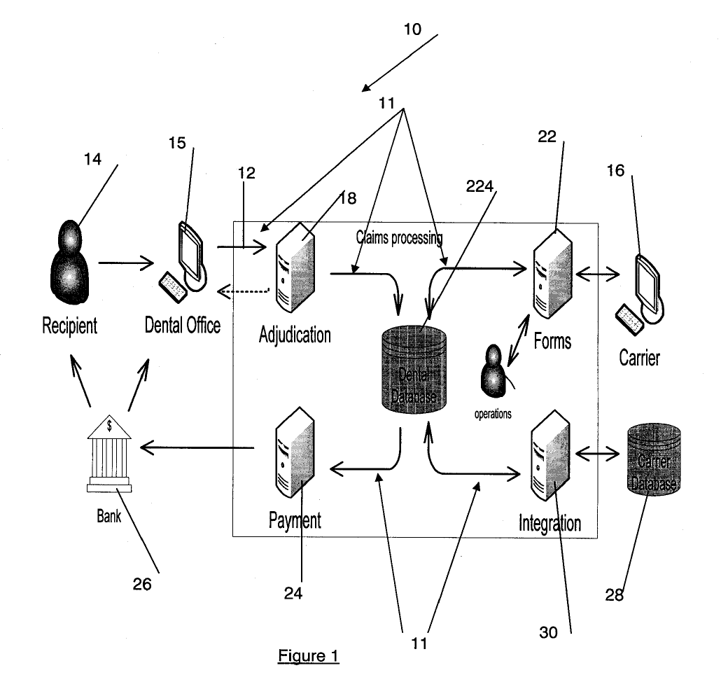

Referring to FIG. 1, shown is the basic workflows involved with an insurance claim 12 (e.g. dental, vision, drug, etc, or a combination thereof). The process starts with a person 14 going to a medical office 15 to get insured services performed (e.g. dental) and/or for the purchase of insured products (e.g. drugs). The office 15 submits the electronic claim 12 over a communications network 11 to the recipient's insurance carrier 16. The carrier 16 adjudicates the claim 12 via an adjudication system 18 and returns to the dental office 15 the amount that it will cover the performed services/purchased products. The Recipient 14 then has to pay the office 15 the difference if there is any. The adjudicated claim 12 is stored in a database 224 and later read into a payment processing system 24. Payment processing 24 can either EFT or generate a cheque to the payee 26 indicated on the claim 12. the carrier 16 also has a carrier database 28 coupled to the database 224, for supplying updates to any carrier/recipient specific information used during the adjudication 18 and/or payment 24 processes. Further, the carrier 16 can also provide a forms interface 22 for use by the recipient 14 and/or the dental office 15, as desired, in completing the electronic forms of the claim 12 for submission over the network 11 (e.g. intra and/or extranet). The carrier 16 may also share/integrate certain data with the database 224 through an integration server 30.

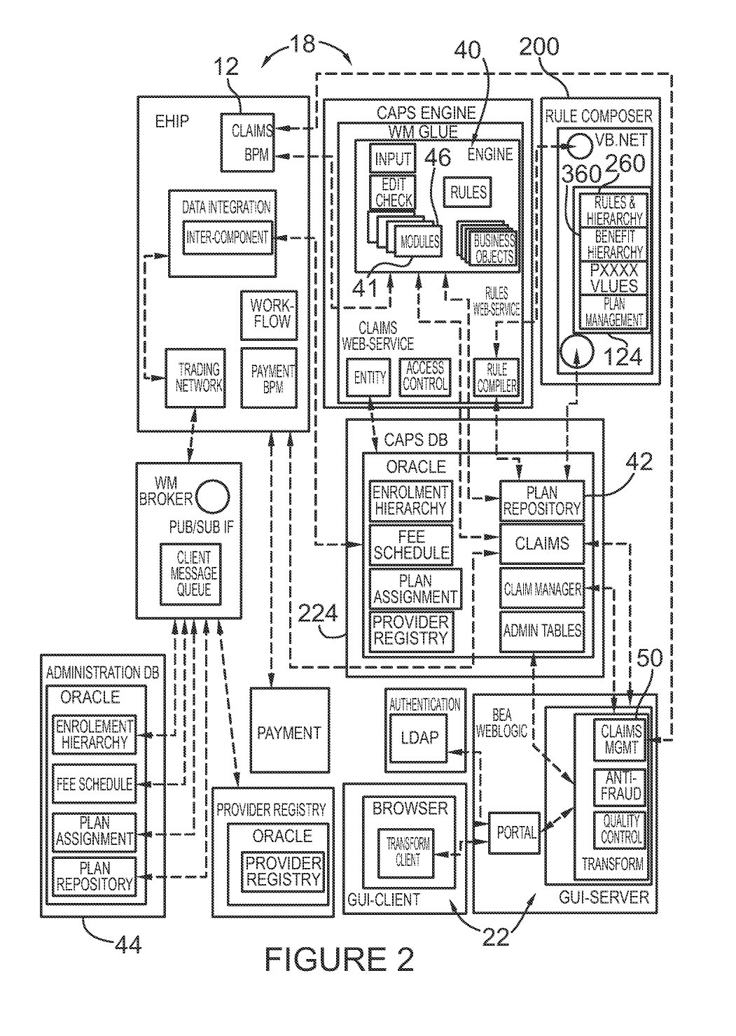

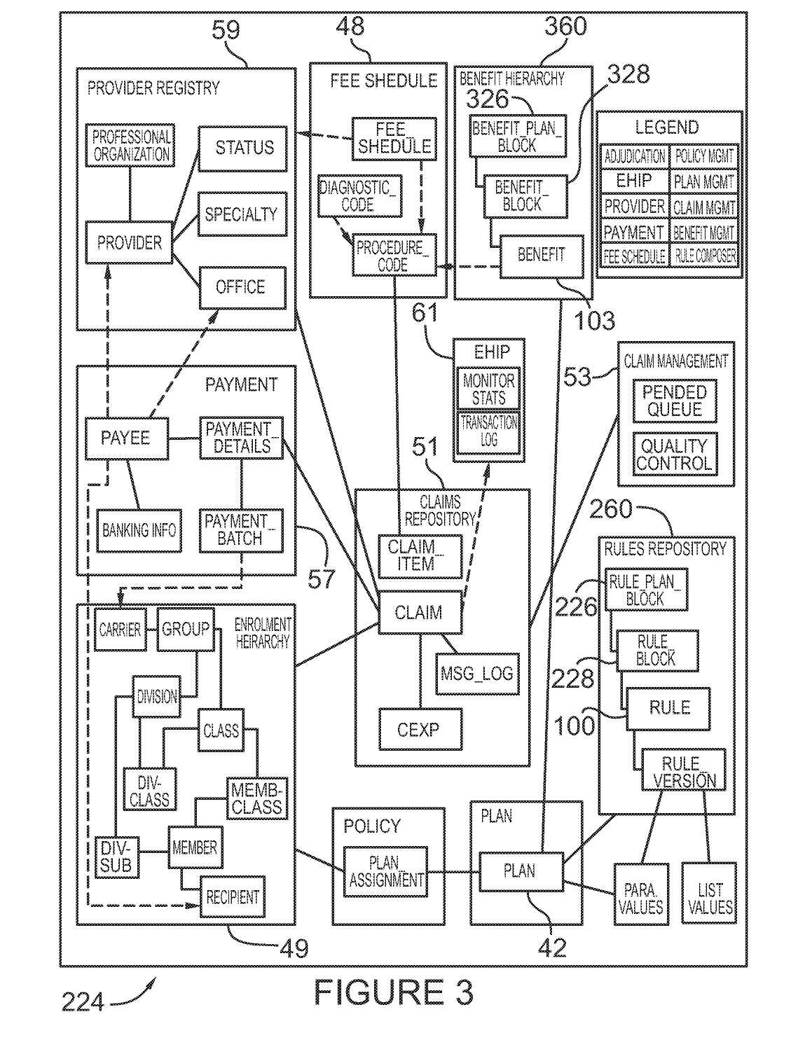

Referring to FIG. 2, shown is a block diagram of main components of the system 10 of FIG. 1. The system 10 has an adjudication engine 40 of the adjudication system 18 that obtains rules 100 and benefits 103a s defined in a deployed plan 42, from the data base 224, for use in adjudication of received claims 12 that reference the plan 42. A plan manager 44 is used to deploy the plan 42, taking into account customized rules 100 and benefits 103 (see FIG. 3) as supplied from a rule engine 200 used to compose and/or otherwise organize the rules 100 into a rule hierarchy 260 and the benefits 103 into a benefit hierarchy 360, further described below. The Plan Manager 44 application lets users create and manage plan 42 coverage templates that are used as the basis of plan administration. Plans 42 are built by combining benefit blocks 326,328 with rules 100 (organized in blocks 226,228) (see FIG. 3) and business-specific parameter-value groupings to create a unique coverage specification (e.g. the deployed plan 42 resident in the memory 224). Once a valid plan 42 reaches its Active Date, the plan can be promoted to a production server for access by the plan manager 44.

A module interface 46 is used by the adjudication engine 40 to load and execute adjudication rules 100 and associated benefits 103, as defined in the deployed plan 42. Through this design, all adjudication rules 100 and associated benefits 103 will fire their respective points in the order of execution (e.g. sequential as listed), as defined in the blocks 226,228,326,328 and/or their relationship models 260,360. The adjudication rules 100 discussed here are the ones attached to the plan 42. For example, the deployed plan 42 consists of elements such as but not limited to: adjudication rules 100 (and their associated block 226,228 configuration via references 227,229); a list of service codes 103 (and their associated block 326,328 configuration via references 327,329); a fee guide for defining the fees payable for services/products accepted in the claim 12 as processed via the adjudication 18 and payment 24 processing (see FIG. 1); and a set of fiscal parameters (e.g. co-insurance, maximum and COB) that are used to customize the rules 100 and/or service codes 103 in the deployed plan 42 that is used in claim 12 processing by the adjudication engine 40. Accordingly, it is recognised that the rules 100 and their associated service codes 103 (via the configuration defined in the hierarchies 260,360) provide for the implementation of the deployed plan 42 used in processing the claims 12. For example, the rules 100 are used to determine whether a given service code 103 can be paid by the plan 42, upon review and processing of the claim 12 information by the adjudication engine 40.

Referring to FIG. 3, shown is a further embodiment of the memory 224, including the benefit hierarchy 360 and the rule hierarchy 260, as well as their respective data structures consisting of parent/child (e.g. independent/dependent) blocks 326,328, benefits 103 and blocks 226,228 and rules 100, as further described below. It is recognised that the memory 224 can also include claims information 51, carrier/member/recipient information 49, payment information 57, provider information 59, fee schedules 48, and pended/quality control information 61, as desired.

### Claim 12 Concept Overview

Referring to FIGS. 1,2, and 4, there are many different definitions of a claim 12 based on the perspective of the viewer. The following example definition and design of the claim 12 is from the perspective of the adjudication engine 40 for use in adjudication processing 18 using the configured rules 100 and/or benefit codes 103 of the plan 42 associated with the claim 12. A claim-item 60 can a procedure or product code (e.g. dental teeth cleaning). There can be multiple procedure codes on a single claim 12. Multiple procedure codes can sometimes be packaged together under 1 procedure code, as desired. The claim description 62 can be a unique combination of: Patient (registered with a specific carrier 231 and associated plan 42); Provider (of the insured service(s)/product(s) of the plan 42; and Service date (a measure of when the insured service(s)/product(s) took place). For example, the claim description 62 can describe a visit and resultant outcome of the patient to the provider. Note that multiple claims in a day (e.g. service date) are possible. A transaction 64 can be made up of one or more individual claim descriptions and can, for example: be a box of receipts all submitted at once; extend across multiples patients and providers; possibly represent a single EDI (CDA) claim with multiple service dates; and/or can represent a claim submitted on a periodic frequency (e.g. Labour Force Reentry (LMR) type claims pertaining to retraining/rehabilitation of the patient over an extended period of time).

### Adjudication Engine 40

The adjudication engine 40 of the adjudication system 18 is configured to access or otherwise obtain rules 100 and benefits 103 as defined in a deployed plan 42, from the data base 224, for use in adjudication of received claims 12 that reference the plan 42. As further described below, the rules 100 and benefits 103 are configured as rule and benefit objects in respective hierarchies 260, 360.

The adjudication engine 40 can have a comparison module 41 configured for comparing the claim date to each of the an effective date and an expiry date of the container references 229, in order to determine if the respective secondary rule container 228 is part of the set of adjudication rules for use in processing the received claim 12, such that the non-matching dates exclude the respective secondary rule container 228 from being included in an execution order as listed in the corresponding primary rule container 226. Further, the adjudication engine 40 can have the comparison module 41 configured for comparing the claim date to the effective date and/or a expiry date of the rule references 227, in order to determine if the respective adjudication rules 100 associated with the rule references 227 is/are part of the set of adjudication rules 100 for use in processing the received claim 12, such that the non-matching dates exclude the respective adjudication rule 100 from being included in the execution order of their respective secondary rule container 228.

Further, the adjudication engine 40 can have the comparison module 41 configured for comparing the claim date to each of the an effective date and an expiry date of the benefit container references 329, in order to determine if the respective secondary benefit container 328 is part of the set of benefit codes 103 for use in processing the received claim 12, such that the non-matching dates exclude the respective secondary benefit container 328 from being included in an execution order as listed in the corresponding primary benefit container 326. Further, the adjudication engine 40 can have the comparison module 41 configured for comparing the claim date to the effective date and/or a expiry date of the benefit references 327, in order to determine if the respective benefit codes 103 associated with the benefit references 327 is/are part of the set of benefit codes 103 for use in processing the received claim 12, such that the non-matching dates exclude the respective benefit codes 103 from being included in the execution order of their respective secondary benefit container 328.

Accordingly, as further described below, the adjudication engine 40 uses date matching of the references 227,229,327,329 with the claim date, in order to assemble the set of adjudication rules appropriate to the content of the received claim 12. The comparison module 41 may be part of the adjudication engine 41, as shown, and/or may be part of the database 224 or other third party (not shown).

Referring to FIG. 3, the adjudication engine 40 during the adjudication process 18 (see FIG. 1) determines that claims 12 that cannot be automatically adjudicated according to the hierarchies 260, 360 as defined in the deployed plan 42 associated with the received claims 12. Accordingly, in the case of error(s) occurring during the adjudication process 18, the adjudication engine 40 makes note of the adjudication error(s) and sends the adjudication interrupted claim 12 to a Pended Claims queue 53. Pended claims 12 are determined by the engine modules and rules, according to the plan 42. Paper claims also has the ability to flag a claim 12 to be pended to the claims queue 53 for an adjudicator to view, via the review engine 50, as further described below.

Further, fraud claims 12 can also be detected by the engine 40 during adjudication and are flagged as such and sent to the claims queue 53 also for review by the review engine 50. For example, the last step on the engine 40 can decide if the claim 12 has completed adjudication or not. If it is, and the fraud-flag had been set during the adjudication process 18, in view of application of the plan 42 to the contents of the received claim 12 by the adjudication engine 40, the claim 12 can be put into a special state in the claims queue, such that: the claim 12 is not ready for payment; and the claim 12 is not ready for Quality Control, for example.

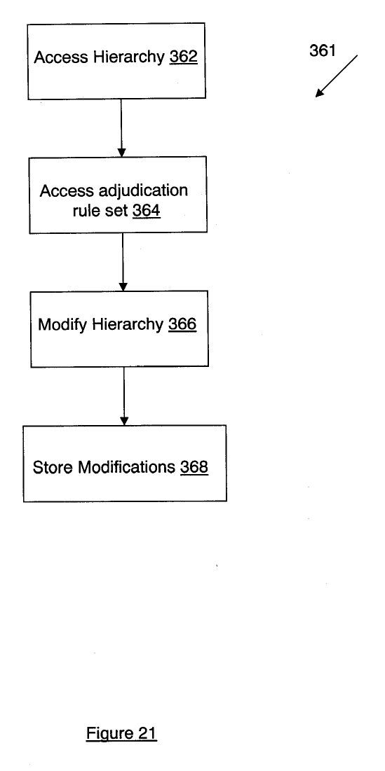

As further described below, anti-Fraud determination of claims 12 in the queue 53 can be managed by a screen(s) 102 in the review engine 50. This can be a table driven feature with a custom module in the engine 50 to execute the logic for review and possible revision/reconfiguration of the claim 12 and/or the hierarchies 260,360 associated with the claim 12. The table data can be updated in real-time, and it is understood that Anti-Fraud can sometimes make mistakes and either miss, or catch too many claims 12, at least initially. However, based on the potential for revision/reconfiguration of the hierarchies 260,360, via the review engine 50, in view of the analysis of the queued claim 12, it is understood that iterative updates/revisions 54 of the hierarchies 260,360 (e.g. of the plan(s) 42) may provide for increases in auto adjudication levels for the received claims 12, in view of iterative updates/revisions 54 of the hierarchies 260,360 based on claim review (by a claim module 536—see FIG. 24) of the claims 12 submitted to the claims queue 53.

### Adjudication Rules 100

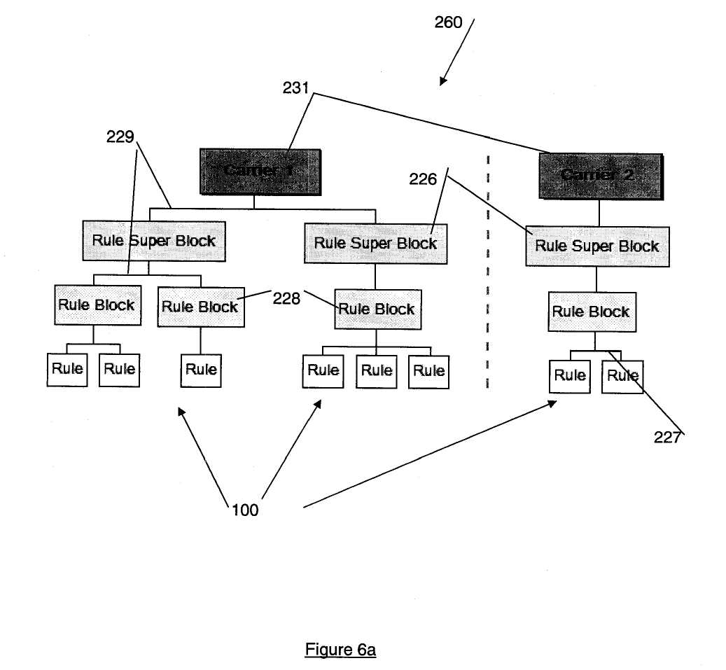

The Rules 100 can be used by the adjudication engine 40 to determine whether a given service code 103 is authorized to be paid by a plan 42 deployed on behalf of the carrier 231 (see FIG. 6a).

### Rule Grammar

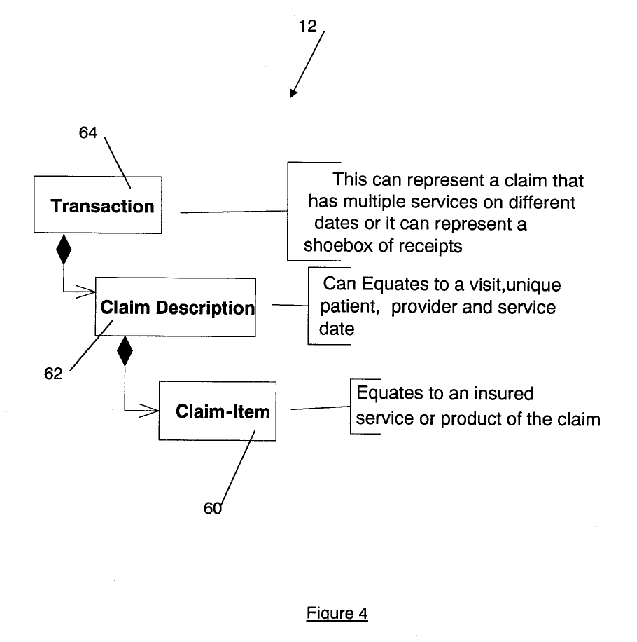

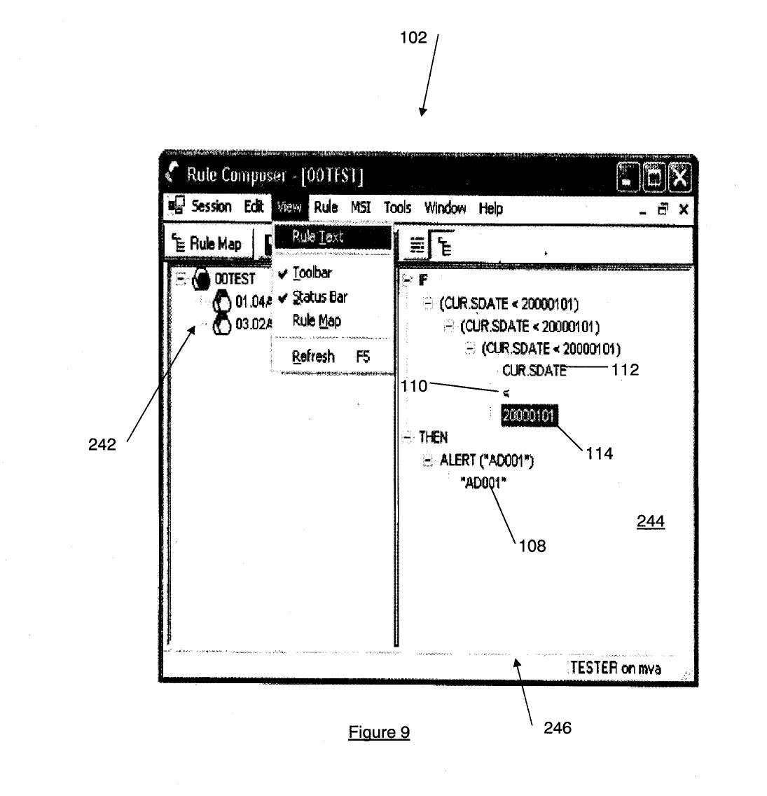

Reference is next made to FIGS. 4 and 11, which illustrates the generalized structure of a Rule 100. Each rule 100 is a discrete logical expression that, when evaluated, returns a condition of either “TRUE” or “FALSE”. One example of the rule 100 is a logical structure of IF {condition(s)} THEN {action(s)} statement. The defined grammar logic 212 is available to a composer module 202 of the rule engine 200 for use in creating/amending the rules 100 for a new plan 42 and/or for facilitating editing of rules 100 in an existing plan 42 obtained from the memory 224 (see FIG. 3). Rules 100 are evaluated by the adjudication engine 40 when claims 12 are submitted by an insured person as will be described below and are used to process claims 12. The complete set of rules 100 in the rules database 224 is the complete set of business logic that will be analysed by the adjudication engine 40 in processing a claim 12. An action or method 104 of the grammar logic 212 can be performed by the adjudication engine 40 if the condition 102 of the rule 100 is “TRUE”. The action 104 is not performed if the condition 102 of the rule 100 is “FALSE”.

Conditions 102 of the grammar logic 212 are expressions that result in a true or false answer. The expressions 102 can be comprised of the rule elements described in a Business Object Model (BOM) file. Conditions 102 can be as simple as (OBJ.A=1). A rule 100 can also have multiple conditions 102 joined together by logical operators and each condition can be nested with other conditions. An exemplary more complicated rule 100 with several logical operators and nested conditions is the following:

### ((OBJ1.A+OBJ1.B=2) OR ((OBJ1.D=10) AND (OBJ2.E=OBJ2.F)) OR (OBJ.FUNCTION(A,B)=25

The elements of the grammar logic 212 that comprise conditions and actions can be specific to the implementation and are described in a Business Object Model (BOM) file. The BOM file is an XML file that provides the rule engine 200 with information on rule elements of the grammar logic 212 available for use creating/editing/deleting the rules 100, such as but not limited to:
Business objects such as a claim
Attributes associated with business object such as a recipient
Methods associated with each business object such as calculations based on the recipient's claim history
Data types associated with each rule element
Global functions such as those used to manipulate or compare data
Actions such as pay or refuse the claim (or line item of the claim)
Operators for comparisons and arithmetic

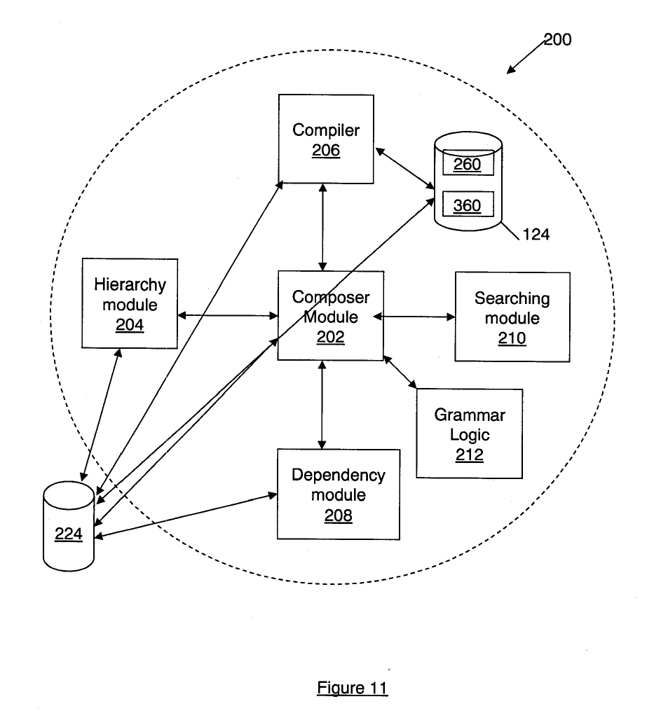

The rules 100 in the BOM have customizable labels and descriptions that the user will see when interacting with the tool. Changes to the BOM are easily implemented by interacting with a rule composer interface (e.g. interface 102 coupled to the composer module 202) and may not require an application code update. The rule composer interface 102 (see FIG. 13) is in communication with thr rule engine 200 which performs the functionality upon instruction by the user. The BOM is a system file that may not be normally modified directly by the user without using the rule composer interface 102.

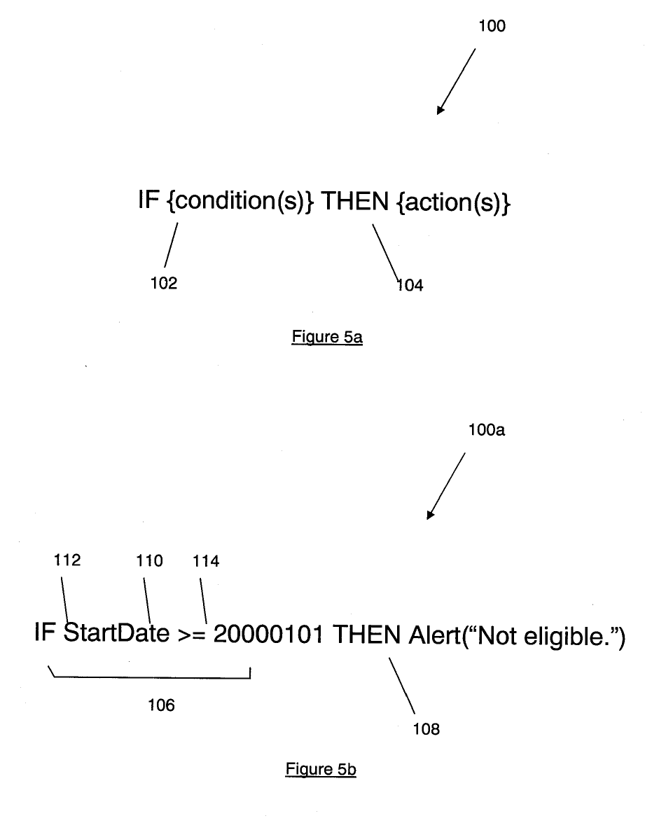

An example rule 100a is shown in FIGS. 5a,b. The rule 100a includes an expression 106 and an action 108. When the rule 100a is evaluated by the adjudication engine 40, the adjudication engine 40 will determine whether the expression 106 is in a FALSE condition or a TRUE condition. If the expression is in the TRUE condition, then the adjudication engine 40 will execute the action 104 specified in the rule 100. If the expression is in the FALSE condition, then the adjudication engine 40 will take no action.

In rule 100a, the expression 106 includes a literal value 112, an operator 110 and a parameter value 114. The literal value 112 represents the “StartDate” of the employee submitting the claim 12. It will be appreciated that the literal value 112 of a rule 100 may be any literal value 112 that is available in the database 224. Other literal values 112, for example, may correspond to an employment start date, an employment end date, employment status (e.g. full-time, part-time, contract) or other literal values 112 as will be understood in the art. The literal values 112 may be set to a default value in the rule 100 creation process (via the rules engine 200) and be edited when a rule 100 is attached to the plan 42, as further described below.

It is recognised that business objects are objects to which information is attached, as utilized by the rule engine 200. A claim 12 (see FIG. 1) is an example of a business object. Attached to the claim 12, as received by the adjudication engine 40 (see FIG. 2), is information such as the identity of the claim's recipient and the service for which the claim 12 is being made, as well as the carrier 231 that is responsible (i.e. for providing the configuration of the rules 100 and/or for payment of the claim 12, once adjudicated) for the claim 12. Business objects provide the context in which the rules 100 would be evaluated during adjudication of the claim 12 by the adjudication engine 40. It is recognised that methods can also be attached to the business objects, in order to perform calculations in the context of the business object or retrieves information about the business object that is not available as an attribute. It is recognised that the attributes and methods attached to the business object are referenced in the rule(s) 100 using a syntax of the rule grammar of the grammar logic 212, such as object.attribute and object.method syntax respectively.

Attributes are the pieces of information attached to a business object. The attributes can have values that can be used for comparisons or calculations, depending on the data type, in order to assist in execution of the rules 100 when processing of the received business object (e.g. claim 12) by the adjudication engine 40.

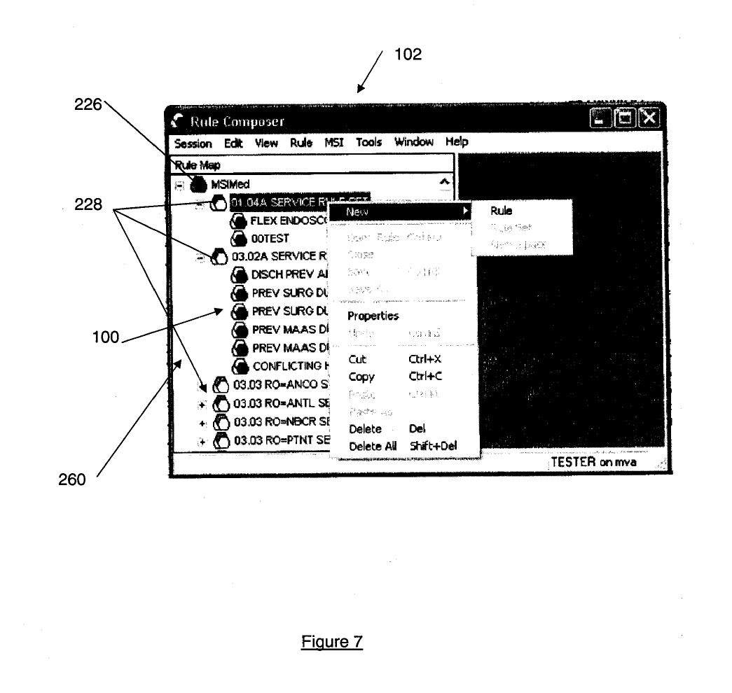

The methods and functions associated with the business object (e.g. via the rules 100) are used to return a calculated value and/or a true/false logic decision, return a state, and/or perform action(s). Operators are uses when comparing two or more values and/or in joining two or more conditions. The logical operators AND, OR, AND NOT, OR NOT, and NOT of the grammar logic 212 are used in the rules 100, as input through the user via the rules manager 202. Other operators of the grammar logic 212 can be such as but not limited to: EQUALS; NOT EQUALS; etc. An example of a rule 100 in the rule hierarchy 260 is shown in FIG. 9.

### Rule Blocks 228 and Superblocks 226

Referring to FIGS. 2,3, the blocks 226, 228 and rules 100 are used as rule objects in the hierarchy 260, thus providing for multiple instances of the same rule object in any particular rule hierarchy 260 (i.e. specific instances of coupled blocks 226,228 and rules 100) configuration.

A Rule Block 228 is a logical grouping of Rules 100, such that specific instances of the Rule Blocks 228 have a name and description but may not have any inherent processing logic. A Rule Super Block 226 is a logical grouping of Rule Blocks 228. Rule Super Blocks 226, such that specific instances of the Rule Blocks 226 have a name and description but may not have any inherent processing logic. A name and description in a second language can be supported. The Rule Super Block 226 can be used to define the execution order of the blocks 228 listed/referenced 229 therein (e.g. each referenced block 228 in the list of blocks 228 in the super block 226 is processed in sequential order).

The organization of adjudication rules 100 is represented by Rule Containers 226, 228 (e.g. Super Blocks and Blocks) and the Rules 100 within them. The adjudication rules 100 and their organization in the hierarchy 260 are stored as data organised via the blocks 226,228 within the database 224. The rule data is then used by the adjudication engine 40 to process claims 12 received. Referring to FIG. 6a, the rule hierarchy 260 consists of Carriers 231, Rule Containers 226, 228, and Rules 100. Carrier 231 is the root container for the Rule Hierarchy 260. Rule Objects refer to both Rules 100 and Rule Containers 226,228, such that Rule Super Blocks 226 contain Rule Blocks 228 and Rule Blocks 228 contain Rules 100, for example, as a container relationship structure used to organize and define the rule hierarchy 260.

The term Rule 100 refers to a specific implementation of the processing logic of a business policy. A Rule Block 226,228 is a logical grouping of Rules 100. Rules 100 belong to a Rule Block 226,228 by way of a reference 227,229 (also referred to as Rule Inclusions). Rule Objects exist at the specified level in the hierarchy 260 (specific configuration of the blocks 226, 228 and rules 100 through the references 227,229. The Rule Hierarchy 260 is built on references 227 to Rule Objects rather than containing the Rule Objects; where Rule Objects only exist once in the database, regardless of how many times they appear in the Rule Hierarchy 260. For example, a named rule 100 (e.g. an instance of the rule 100) is an example of a rule object that is then referenced 227 in the containers 226,228 of the hierarchy 260. Also, it is recognised that named containers 226,228 (e.g. an instance of the container 226,228) is an example of a rule object that is then referenced 229 in the containers 226,228 of the hierarchy 260. The use of references 227,229 provides for efficient reuse of common Rules 100 and Rule Containers 226,228 in a large Rule Hierarchy 260. When changes are required on a Rule Object, the changes need only be applied to the single instance rather than in multiple copies.

Referring to FIG. 6a, the rules 100 are organized into a collection of primary 226 and secondary 228 containers, also referred to as superblocks 226 and blocks 228. It is recognised that a particular rule 100 may exist only once in the database 224 but can be found in multiple containers 226,228 by one or more references 227,229, such that the reference 227 is a link between a rule 100 and a secondary container 228 and a reference 229 is a link between a secondary container 228 and a primary container 226. Accordingly, rule objects can exist only once in the database 224, regardless of how many times the appear in the rule hierarchy 260, since the rule hierarchy 260 can be built on references to the rule objects rather than containing the rules objects themselves. One advantage in using references 227,229 is that it can allow for reuse of common rules 100 and rule containers 226,228 in a complex rule hierarchy 260, such that when changes/modifications are done on a rule object, the changes/modifications are only applied to the single instance of the rule object rather than to multiple copies of the rule objects.

It is recognised that the rules 100 linked via references 227 to the secondary containers 228 are also included in the primary containers 226 via the references 229, e.g. a primary container 226 contains all contents of the linked 229 secondary containers 228 (e.g. as a child of the primary container 226) and the contents of the secondary containers 228 are the linked 227 rules 100 (e.g. the rules 100 are children of the secondary containers 228). Hence, the described relationship between the containers 226, 228 and the rules 100 can be such that each rule is a dependent/child of the associated secondary container 228 and each secondary container in turn is a dependent/child of the primary container 226. As well, each primary container 226 is a dependent/child of one or more carriers 231, as shown by example in FIG. 6a.

### References 227,229, 327,329

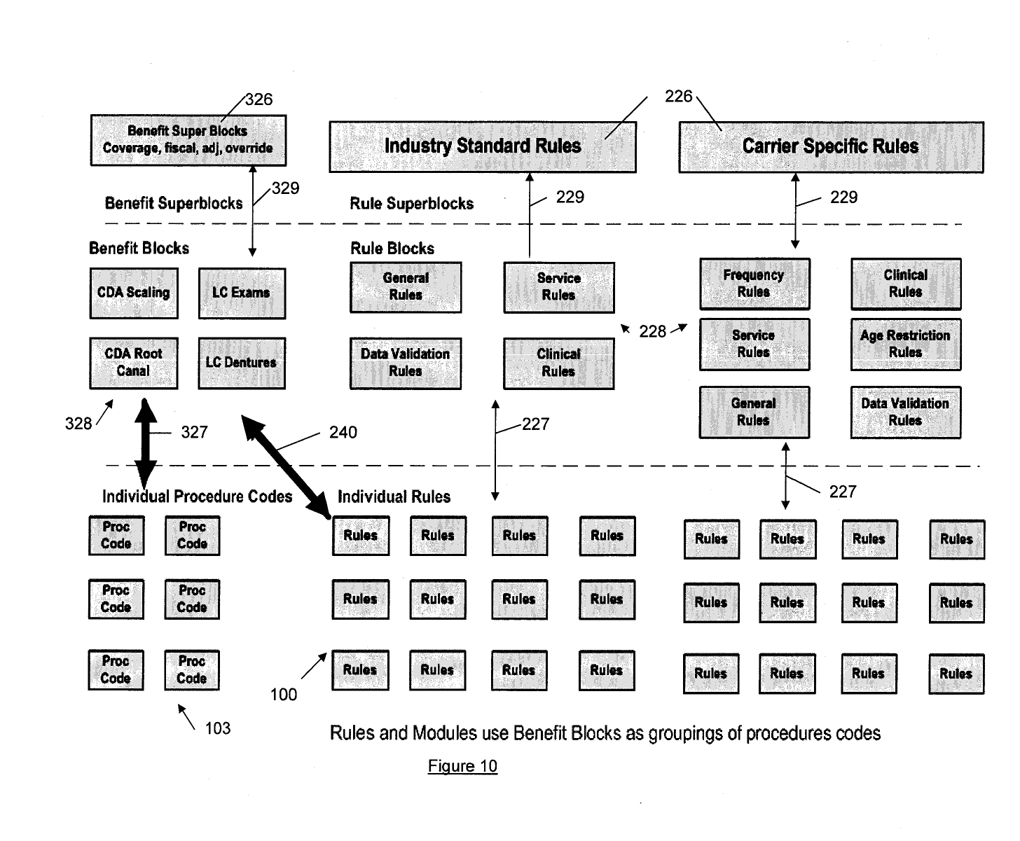

Referring to FIG. 12a,b, a Rule Version is a specific implementation of a Rule 100 using the rule grammar. Different implementations may be valid at different points in time in time span 301 ordering of the rules 100 and corresponding blocks 228. A version date 300 of a rule version determines which implementation is applicable over the history of the Rule 100. A Rule 100 is a member of a Rule Block 228 by way of the reference 227 and those references can be called Rule Inclusions. The order of Rule Inclusions 227 within a Rule Block 228 determines the order of processing by the adjudication engine 40 of the rules associated via the hierarchy 260 for the particular plan 42 associated (e.g. via a plan ID associated with the patient name of the claim 12) with the received claim 12 for processing (see FIG. 3). The chronological dependency of Rule Inclusions 227 for a Rule 100 within a Rule Block 228 is called a Rule Timeline 302.

A Rule Block 228 is a member of a Rule Super Block 226 by way of the reference 229 and those references can be called Rule Block Inclusions 229. The order of Rule Block Inclusions 229 within a Rule Super Block 226 can determine the order of processing by the adjudication engine 40. It is recognised that Rule Block Inclusions 229 may or may not have a time dependency.

Accordingly, rule processing order by the adjudication engine 40 is configured in the hierarchy via the references 227,229. For example, Rule Inclusions 227 can have an effective date and expiry date (e.g. on the timeline 302). These dates specify the start and end of when the Rule 100 is considered to belong to the Rule Block 228. The Rule Inclusions 227 that a claim 12 will encounter during processing depends on a service date of the claim 12, as well as the plan ID for associating the claims 12 with the rules 100 and benefits 103 related to the claims via the corresponding deployed plan 42. Each Rule 100 referenced by the Rule Inclusions 227 may have multiple versions of the logic implementation. The rule version 300 used for a claim 12 can be the most recent one relative to the claim 12 service date. Each version 300 can have a distinct Version Date that specifies the start date of the version 300. The end date of a Rule Version 300 is implied by the start date of the next version, for example or can be independently specified, as desired. Rule Inclusions 227 may or may not point to a specific Rule Version 300, where the version 300 used during claim 12 processing can be determined by the claim 12 date.

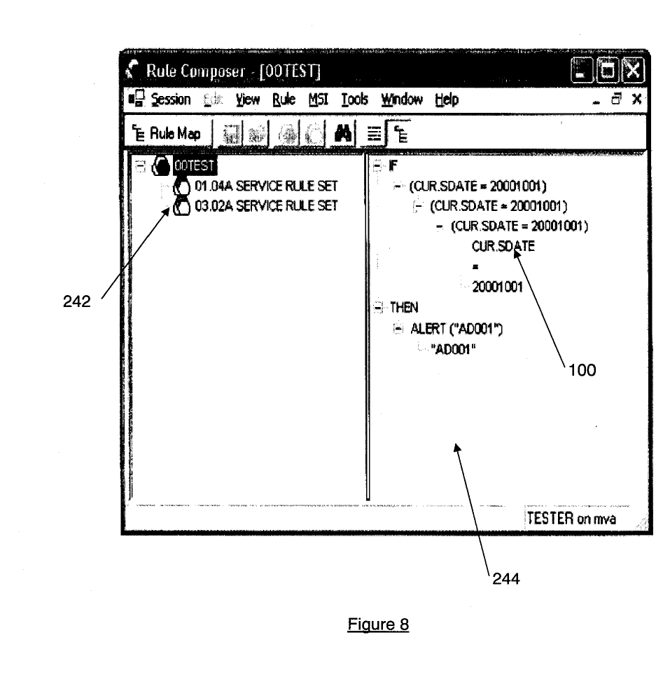

Further, a benefit Version is a specific implementation of a benefit 103. Different implementations may be valid at different points in time in time span 301 ordering of the benefit 103 and corresponding blocks 328. A version date 300 of a benefit version determines which implementation is applicable over the history of the benefit 103. A benefit 103 is a member of a benefit Block 328 by way of the reference 327 and those references can be called benefit Inclusions. The order of benefit Inclusions 327 within the Block 328 can determines the order of processing by the adjudication engine 40 of the benefits associated via the hierarchy 360 (as well as linked to specific rules via links 240—see FIG. 10) for the particular plan 42 associated (e.g. via a plan ID associated with the patient name of the claim 12) with the received claim 12 for processing (see FIG. 3). The chronological dependency of benefit Inclusions 327 for a benefit 103 within a Block 328 is called a Timeline 302.

A Block 328 is a member of a Super Block 326 by way of the reference 329 and those references can be called Block Inclusions 329. The order of benefit Block Inclusions 329 within a benefit Super Block 326 can determine the order of processing by the adjudication engine 40. It is recognised that Block Inclusions 229 may or may not have a time dependency.

Accordingly, benefit processing by the adjudication engine 40 is configured in the hierarchy via the references 327,329. For example, Inclusions 327 can have an effective date and expiry date (e.g. on the timeline 302). These dates specify the start and end of when the benefit 103 is considered to belong to the Block 328. The Inclusions 327 that a claim 12 will encounter during processing depends on a service date of the claim 12, as well as the plan ID for associating the claims 12 with the rules 100 and benefits 103 related to the claims 12 via the corresponding deployed plan 42. Each benefit 103 referenced by the Inclusions 327 may have multiple versions of the logic implementation. The benefit version 300 used for a claim 12 can be the most recent one relative to the claim 12 service date. Each benefit version 300 can have a distinct benefit Version Date that specifies the start date of the benefit version 300. The end date of a benefit Version 300 is implied by the start date of the next benefit version, for example or can be independently specified, as desired. Inclusions 327 may or may not point to a specific benefit Version 300, where the benefit version 300 used during claim 12 processing can be determined by the claim 12 date.

FIG. 12a illustrates the Timeline 302 and Version 300 concepts with example rules 100. The definition of Rule A has three versions 300 with Version Dates of 2002/01/01, 2003/07/01 and 2005/01/01. Rule A is included in the example Rule Block 228 from 2002/01/01 to 2004/01/01 and again from 2006/01/01 with no expiry date. Between 2004/01/01 and 2006/01/01 Rule A is not included in the Rule Block 228. The first claim 12 with a date of 2003/01/01 will see the first version 300 of Rule A. The second claim 12 with a date of 2003/10/01 will see the second version 300 of Rule A. The third claim 12 will not see any version 300 of Rule A because the Rule Inclusion 227 is not in effect at that time. Accordingly, the rule inclusion 227 can be used to coordinate which rule 100 at which time is relevant for use in adjudication processing 18 (see FIG. 1) based matching the date of the rule inclusion 227 with the claim date.

When multiple Rule Versions 300 exist for a given Rule Inclusion 227, the appropriate version date can be shown as child nodes under the Rule Inclusion 227. The version 300 dates shown can fall between the start and end of the respective time span 302 dates. For example, a Rule 100 can have multiple versions 300 grouped under different version dates (e.g. 2000/03/22 and 2007/04/08). For each time span 302 the appropriate version dates can be displayed as child nodes of the Rule 100 rule inclusion 227 node of the hierarchy 260 (see FIG. 6a).

FIG. 12b illustrates the Timeline 302 and Version 300 concepts with example blocks 228. The definition of block A has three versions 300 with Version Dates of 2002/01/01, 2003/07/01 and 2005/01/01. Block A is included in the example super Block 226 from 2002/01/01 to 2004/01/01 and again from 2006/01/01 with no expiry date. Between 2004/01/01 and 2006/01/01 block A is not included in the super Rule Block 226. The first claim 12 with a date of 2003/01/01 will see the first version 300 of block A. The second claim 12 with a date of 2003/10/01 will see the second version 300 of block A. The third claim 12 will not see any version 300 of block A because the Inclusion 229 is not in effect at that time. Accordingly, the inclusion 229 can be used to coordinate which block 228 at which time is relevant for use in adjudication processing 18 (see FIG. 1) in the corresponding superblock 226, based matching the date of the inclusion 229 with the claim 12 date.

When multiple Rule Versions 300 exist for a given Inclusion 229, the appropriate version date can be shown as child nodes under the Inclusion 229. The version 300 dates shown can fall between the start and end of the respective time span 302 dates. For example, a block 228 can have multiple versions 300 grouped under different version dates (e.g. 2000/03/22 and 2007/04/08). For each time span 302 the appropriate version dates can be displayed as child nodes of the inclusion 229 node of the hierarchy 260 (see FIG. 6a).

It is recognised that similar use of references 327, 329 for the benefits 103 can be said for FIGS. 12a,b, whereby the benefit inclusion 327 can be used to coordinate which benefit 103 at which time is relevant for use in adjudication processing 18 (see FIG. 1) based matching the date of the benefit inclusion 227 with the claim 12 date. Further, it is recognised that, the inclusion 329 can be used to coordinate which block 328 at which time is relevant for use in adjudication processing 18 (see FIG. 1) in the corresponding superblock 326, based matching the date of the inclusion 329 with the claim 12 date.

### Benefit Blocks 328 and Superblocks 326

As mentioned above, the plans 42 are built by combining, via links 240 between rules 100 and benefits 103 (see FIG. 10), benefit blocks 326,328 with rules 100 and associated rule blocks 226,228 and business-specific parameter-value groupings to create a unique coverage specifications, which are applied to the received claims 12 as processed by the adjudication engine 40, see FIG. 3. Once a valid plan 42 reaches its Active Date, the plan 42 can be promoted to a production server (e.g. storage 224) for eventual access by the adjudication engine 40, once deployed in the storage 224 (see FIG. 3). Accordingly, the Plan 42 is a grouping of various attributes (e.g. of the hierarchies 260, 360) to assist in determining whether a dental service (or other insured products/services) of the claim 12 is covered and any restrictions on the reimbursement, a result of the adjudication processing 18.

Referring to FIG. 6c, a benefit hierarchy 360 allows users to create unique plan 42 configurations from a shared set of plan and benefit data, as well as to provide for instruction to the adjudication engine 40 in adjudication of the claims 12 that are associated with the respective deployed plan 42. The benefit hierarchy 360 can crosses multiple lines of business such as dental, drug, medical, and vision. Generally, each benefit super-block 326 can contain only blocks 328 of benefits 103 of the same business. However, for reporting purposes users can define super-blocks 326 that cross multiple lines of business. There can be basic elements in the benefit hierarchy 360, such as but not limited to: Benefit-Super-Blocks 326, Benefit-Blocks 328, and Benefits 103, which are linked to one another similarly to the arrangement of the rule blocks 226,228 and rules 100 (see FIGS. 6a,b), using references 327,329, as further described below.

Benefit Super-blocks 326 represents a grouping of benefit blocks 328 used to create an overall coverage list for the plan 42, such that the benefit super blocks 326 can be used to define the execution order of the blocks 328 listed/referenced 329 therein (e.g. each referenced block 328 in the list of blocks 328 in the super block 326 is processed (e.g. in sequential order as listed in the blocks 326). The Super Benefit Block 326 can be identified as an Inclusive or Exclusive grouping, for example. A Super Benefit Block 326 can include an Identifier, a Label Name, a Type and a Description. The Benefit Super-blocks 326 can be the highest object in the hierarchy 360, and are assigned to a plan 42, or as an override to an enrolment hierarchy (not shown). Super-blocks 326 can be assigned to the plan 42 and/or become a plan component. A super-block 326 can contain any number of benefit blocks 328, via references 329. Benefit blocks 328 can be included or excluded, and are time-lined via the references 329, allowing them to change over time if required. Benefit Super-Blocks 326 can be created in a number of different types, such as but not limited to: Coverage—include or exclude specific benefit blocks 328; Override—include or exclude benefits 103 and override plan coverage; Fiscal—assign specific Coinsurance, Deductible, and Maximum methods/functions; and Adjudication—assign specific rules 100 (for example, Pricing, COB, etc.) depending on business requirements.

A Benefit block 328 represents a grouping of other benefit blocks 328 or a logical grouping of benefit/service codes 103. A Benefit Block 326 can include an Identifier, a Label Name, a Type and a Description. These blocks 328 can represent industry-level categorization or carrier-specific groupings. Benefit blocks 328 can be created once and may be referenced by multiple plans 42. Benefit blocks 328 can be time-lined, meaning that a benefit block 328 can contain a different number of benefits 103 over time, as referenced by the references 327, providing for a benefit 103 that is no longer covered to remove itself from the block 328 (and in turn any associated plans 42 will no longer cover the benefit 103).

Benefits 103 generically refer to a claimable item such as a dental procedure or a pharmacy prescription, for example. A benefit code 103 is a re-usable component. Each benefit 103 can be defined only once, and can have a relationship 327 with multiple blocks 328. Each benefit 103 is defined with attributes such as benefit code, label, and line of business (dental/medical etc.). Most benefit codes 103 can be derived from the CDA industry standards, for example. Accordingly, benefit objects can exist only once in the database 224, regardless of how many times the appear in the rule hierarchy 360, since the benefit hierarchy 360 can be built on references to the benefit objects rather than containing the benefit objects themselves. One advantage in using references 327,329 is that it can allow for reuse of common benefits 103 and benefit containers 326,328 in a complex benefit hierarchy 360, such that when changes/modifications are done on a benefit object, the changes/modifications are only applied to the single instance of the benefit object rather than to multiple copies of the benefit objects.

A Benefit Block 326,328 is identified as a Type to indicate what the grouping is supporting. The following are valid types of benefit blocks 326,328, for example but not limited to: Coverage List—groupings to create the coverage list of service codes 103, such that these groupings can be made in benefit blocks 328 that will support the coinsurance structure of a policy; Plan—groupings created to support the fiscal restrictions within a plan 42, for example: if frequency is to be attached to ‘exams’, the Plan Specialist will group benefit blocks 326,328 and/or service codes 103 together an create a benefit block label ‘exams’, which can then allow the Plan Specialist to create a rule 100 using this label to set up parameterized values and structure the frequency as required by the policy of the plan 42; and Adj Logic—groupings created to support the dental (or other insurance types) interaction rules 100 required by the insurance industry (e.g. can be carrier specific, for example).

Parameterized Values of the benefit codes 103 can be attributes within a plan 42 or Rule 100 (e.g. via link 240—see FIG. 10) where the user can enter in a specific value. Benefit Inclusion is a term used to identify that a particular service code 103 or grouping of service codes 103 are additionally being covered outside of the defined plan 42—coverage list. Benefit Exclusion is a term used to identify that a particular service code 103 or grouping of service codes 103 are additionally being excluded from coverage outside of the defined plan 42—coverage list. Plan Components references functionality that is coded in the adjudication engine 42 to perform various functions related to the service codes 103 and rules 100 associated with the plan 42 used to assist in adjudication of the received claims 12.

The contents of benefit blocks 328 are used to define a list of service codes 103 that are consider as eligible dental (or other insurance types) services for reimbursement. Benefit Block 326,328 labels are concise and make business sense. Benefit blocks 326,328 are intended to be re-used in the benefit hierarchy 360, and can also identify the coinsurance groupings of the covered insured services. Benefit block labels, when re-used for the fiscal coinsurance groupings, can be returned in a claims experience log (not shown).

As discussed above for use of references 227,229 with rules 100 and rule blocks 226,228, the benefit blocks 326,328 and benefit codes 103 can also use similar references 327,329 to Set Expiry Dates for Benefit(s) 103 in a Block 328, and Set Effective Dates for Benefits 103 in a Block 328. As well, the references 329 can be used to set the respective linked block(s) 328 with the super block(s) 326, thereby facilitating the time dependent and/or version 300 dependent inclusion of the codes 103 in the blocks 328 and/or time dependent and/or version 300 dependent inclusion of the blocks 328 in the superblocks 326, as desired, see FIG. 12b.

Accordingly, it is recognised that a super-block 326 may contain any number of benefit blocks 328. Benefit blocks 328 can be included or excluded and are time-lined 302 using the references 329, thus providing for the contents of the blocks 326 to change over time, if desired. For example, selecting a new expiry date for all selected blocks 328 will provide for the specified blocks 328 (via the reference(s) 329) will no longer be functional in this super block 326 after the expiry date has lapsed. Also, for example, selecting a new effective date for all selected blocks 328 will provide for the specified blocks will not be functional in this super block 326 until the effective date has been reached. Further, benefit super blocks 326 can be interpreted (e.g. sequentially) in the specified order in the hierarchy 360, in ascending order; benefits 103 that are part of an excluded block 328 are ignored if they are part of a later included block 328, for example.

It is recognised that the above described benefit hierarchy 360 is used by a plan manager 44 to assemble the rules 100 and benefit codes 103 (as ordered by the blocks 226,228,326,328 and associated references 227,229,327,329 to create a specific plan version 42 that is then stored for use by the adjudication engine 40 in processing the received claims 12 that are associated with the specific plan version 42 as deployed in the memory 224.

### Rule Hierarchy 260 and Benefit Hierarchy 360

As shown in FIG. 6a,b, rules 100 are grouped into blocks 228 and superblock 226 for processing by the engine 40 and for visualization by the user when using the rule/benefit composer engine 200. A superblock 226 can be the highest container in the hierarchy 260 (other than the specific carrier 231) such that each of the other blocks 226,228 and rules 100 related to the superblock 226. There may be no limit on the number of blocks 226,228 so a particular rule hierarchy 260 can theoretically have any number of tiers (e.g. having block 226 to block 226 links, block 226 to block 228 links, block 228 to block 228 links, and block 228 to rule 100 links, as well as block 226 to rule 100 links where appropriate). The grouping of rules 100 into blocks 228 and superblocks 226 is dependent on the wishes of the user. As an example, a user of the engine 200 may wish to configure the hierarchy 260 to have a superblock 226 for standards set by the Canadian Dental Association and a second superblock 226 for customized business logic for processing claims 12. As another example, a user may wish to have a superblock 226 for different insurance types such as dental, automobile, life insurance as will be appreciated. The superblock 226 node contains child nodes representing a first level of rule blocks 228. The first level of rule blocks 228 may contain additional rule blocks 228 or rules, depending on how many container levels the hierarchy 260 is configured for.

The rule hierarchy 260 can be both an interactive visual representation (e.g. with the user via the composer engine 200) of the relationship(s) between rule objects, and a data structure in the rules database 224 which describes the relationship between rule objects for use by the adjudication engine 40 in processing of the claims 12. It will be appreciated that each rule object (i.e. superblock 226, blocks 228 and rules 100) may exist only once in the database 224 but is referenced by each other rule objects that it is related to in a parent or child relationship of the hierarchy 260. For example, in a situation where there is only one superblock 226, each other rule object is referenced 229 in the database 224 by the superblock 226. The reference(s) 227, 229 may be implemented via generic fields in a data record that stores data (for e.g. attributes) of the blocks 226,228. In another embodiment, a data record of the blocks 226,228 may reference 227,229 a (e.g. dynamic) table that contains references 227, 229 to each of the other rule objects that are in a child relationship with the block. The references 227, 229 to rule objects may be in the form of a globally unique identifier or GUID, or other type of identifier, which is a type of identifier used in the engine 200,40 applications in order to provide a reference number which is unique in any context (hence, “globally”), for example, in defining the internal reference for a type of access point in a set of stored instructions for execution by the computer processor 150 in FIG. 13, or for creating unique keys in a database. The reference 227 to a rule 100 can also indicate whether a rule object is a child or parent of another rule object (e.g. rule block 228).

The benefit hierarchy 360 can be both an interactive visual representation (e.g. with the user via the composer engine 200) of the relationship(s) between benefit objects, and a data structure in the database 224 which describes the relationship between benefit objects for use by the adjudication engine 40 in processing of the claims 12. It will be appreciated that each benefit object (i.e. superblock 326, blocks 328 and benefit 103) may exist only once in the database 224 but is referenced by each other benefit objects that it is related to in a parent or child relationship of the hierarchy 360. For example, in a situation where there is only one superblock 326, each other benefit object is referenced 329 in the database 224 by the superblock 326. The reference(s) 327, 329 may be implemented via generic fields in a data record that stores data (for e.g. attributes) of the blocks 326,328. In another embodiment, a data record of the blocks 326,328 may reference 327,329 a (e.g. dynamic) table that contains references 327, 329 to each of the other benefit objects that are in a child relationship with the block. The references 327,329 to benefit objects may be in the form of a globally unique identifier or GUID, or other type of identifier, which is a type of identifier used in the engine 200,40 applications in order to provide a reference number which is unique in any context (hence, “globally”), for example, in defining the internal reference for a type of access point in a set of stored instructions for execution by the computer processor 150 in FIG. 13, or for creating unique keys in a database. The reference 327 to a benefit 103 can also indicate whether a benefit object is a child or parent of another benefit object (e.g. benefit block 328).

FIG. 6b illustrates the structural data relationship between rule objects. Rule objects refer collectively to superblocks 226, blocks 228 and rules 100. As shown, each rule object may exist once in the rules database 224. It is to be appreciated that the rule objects may exist in a single database 224 or in multiple databases that reference each other. As shown, superblock 226 references two blocks 228a and 228b. Block 228a references rule 2 and 3, and block 228b references rule 1 and rule 3. Superblock 226 also references rules 1, 2 and 3 by its own reference to blocks 228a, 228b. In another embodiment, superblock 226 may directly reference rules 100 in addition to blocks 228a, 228b. Further block 228b refers to block 228c which refers to rule “n”.

When a user interacts with the tool 12 and changes the hierarchical relationship between rule objects, a rule engine 200 implements the change by changing the references in the rules database 224 as is described below. It will be appreciated that if any of the rule objects are moved and/or deleted, the structural relationship depicted in FIG. 3b will be altered by the rule engine 200, a new data structure (e.g. rule hierarchy 260) will exist in the rules database 224 or collection of rules databases 224.

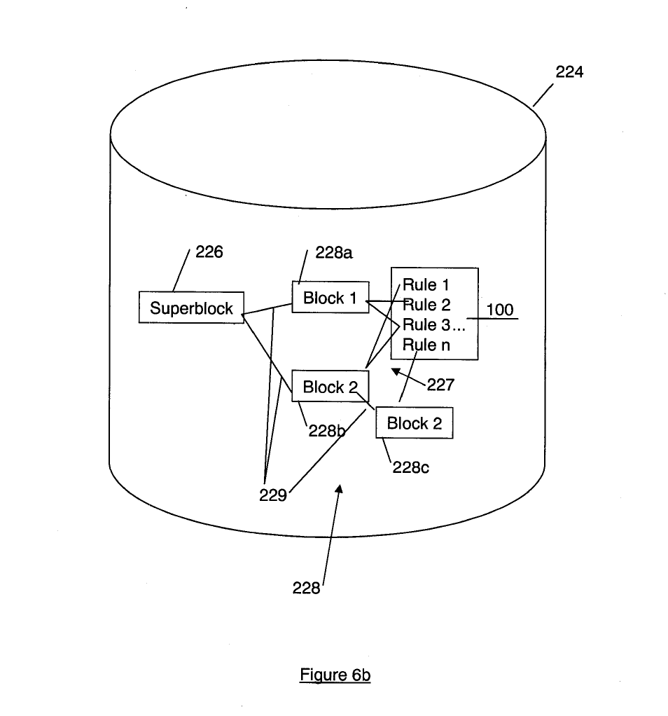

An exemplary rule hierarchy 260 is illustrated in FIG. 7. As shown, the rule hierarchy 260 has a superblock 226 entitled ‘MSIMed’, several blocks 228 and several rules 100. A user is able to expand the rule hierarchy 260 (e.g. using a hierarchy module 204 of the engine 2000—see FIG. 11) by clicking on the ‘+’ buttons and is able to contract the hierarchy 260 by clicking on the ‘−’ buttons via the interface 102 (see FIG. 13). In this way a user is able to precisely focus on a particular rule 100, a block 228 or a superblock 226 as desired. The rule hierarchy 260 can be a graphical tree view that is similar to a folder tree view of a file system as displayed on the display 152, for example. The nodes on the tree view represent the Rule Objects in the rule hierarchy 260 in a parent-child relationship.

The order in which rules 100 and rule block 228 are evaluated by the adjudication engine 40 can affect the adjudication result of the claims 12. New rules 100 and rule blocks 228 can be placed at the bottom of the hierarchy 260 by default, for example. To rearrange the order of the rules 100 in the hierarchy 260 using the engine 200, a user can drag and drop rule objects wherever desired so that the new rule object is in the target node. When a user moves a rule object, the rule engine 200 instructs component modules (e.g. module 202, 204, 206, 208, 210) of the engine 200 to modify the data relationship between the moved rule objects and to render a new visual rule hierarchy 260 to the screen as is described below.

One example implementation of the rule hierarchy 260 is where individual rules 100 can only exist at the bottom most rule container 228 level and that rule containers 226,228 that contain a rule object 100 (e.g. via references 227,229) cannot be moved to a different level of the hierarchy 260. These reference limitations, as managed by the Hierarchy manager 204, help to reduce the complexity of maintaining the hierarchy 260 of circular references 227, as desired. It is recognised that there can be a number of hierarchy levels containing secondary containers 228 (i.e. a secondary container references 227 another secondary container 228 which then references 227 the rules 100, e.g. Block 228b references Block 228c which references the rules 100).

Further, the benefit hierarchy 360 has a superblock 326, several blocks 328 and several benefits 103, for example. A user is able to expand the benefit hierarchy 360 (e.g. using a hierarchy module 204 of the engine 200—see FIG. 11) by clicking on the ‘+’ buttons and is able to contract the hierarchy 360 by clicking on the ‘−’ buttons via the interface 102 (see FIG. 13). In this way a user is able to precisely focus on a particular benefit 103, a block 328 or a superblock 326 as desired. The benefit hierarchy 360 can be a graphical tree view that is similar to a folder tree view of a file system as displayed on the display 152, for example. The nodes on the tree view represent the benefit Objects in the benefit hierarchy 260 in a parent-child relationship.

The order in which benefits 103 and benefit blocks 326,328 are evaluated by the adjudication engine 40 can affect the adjudication result of the claims 12. New benefits 103 and blocks 328 can be placed at the bottom of the hierarchy 360 by default, for example. To rearrange the order of the benefits 103 in the hierarchy 360 using the engine 200, a user can drag and drop benefit objects wherever desired so that the new benefit object is in the target node. When a user moves a benefit object, the engine 200 instructs component modules (e.g. module 202, 204, 206, 208, 210) of the engine 200 to modify the data relationship between the moved benefit objects and to render a new visual benefit hierarchy 360 to the screen 152 as is described below.

One example implementation of the benefit hierarchy 360 is where individual benefits 103 can only exist at the bottom most benefit container 328 level and that benefit containers 326,328 that contain a benefit object 103 (e.g. via references 327,329) cannot be moved to a different level of the hierarchy 360. These reference limitations, as managed by the Hierarchy manager 204, help to reduce the complexity of maintaining the hierarchy 360 of circular references 327, as desired. It is recognised that there can be a number of hierarchy levels containing secondary containers 328 (i.e. a secondary container references 327 another secondary container 328 which then references 327 the benefits 103, e.g. Block 328 references Block 328 which references the benefits 103).

### Composer Rule/Benefit Engine 200

Reference is next made to FIG. 11, which illustrates the Engine 200 of the claims processing environment 10. The engine 200 is for, such as but not limited to, creating, editing, organizing and maintaining adjudication rules 100 in a hierarchical relationship 260 and/or creating, editing, organizing and maintaining adjudication benefit codes 103 in a hierarchical relationship 360, as well as links 240—see FIG. 10—between the rules 100 and benefit codes 103 (it is recognised that the links 240 can also be established between the rules 100 and the blocks 326,328 and/or between the benefits 103 and the blocks 226,228, as desired).

The engine 200 includes a composer module 202 for creating, editing, deleting and saving individual rules 100 and benefits 103, as well as other objects of the hierarchies 260,360. A user of the engine 2000 interacts with the interfaces 102,152 (see FIG. 13) to create, edit, delete and save adjudication rules 100 and benefits 103, as well as the relationships (e.g. parent/child) between blocks 226, blocks 228, and rules 100, as well as the relationships (e.g. parent/child) between blocks 326, blocks 328, and benefits 103, as well as their execution order as organized by the ordering of the references 227,229,327,329 within the respective blocks 226,228,326,328. The composer module 202 performs functions as dictated by the user via the interface 102 and the composer module 202 saves adjudication rules 100 into the local database 124 in the form of the rules hierarchy 260. The composer module 202 performs functions as dictated by the user via the interface 102 and the composer module 202 saves adjudication benefit codes 100 into the local database 124 in the form of the benefit hierarchy 360. The engine 200 can also use the composer module 202, for example, to transfer completed hierarchies 260,360 to the storage 224 for use in deployment of the plan 42.

The engine 200 can also includes a compiler 206 for converting rule and benefit statements into an extensible mark-up language such as XML or into machine readable code, for subsequent use in adjudication of the claims 12 by the adjudication engine 40, whereby the links 240 are used to couple the rules 100 with the benefits 103, for benefits 103 associated with specific rules 100 as is known in the art. In an embodiment of the tool, the compiler 206 converts a rule 100 into XML whenever the user interacts with a compile button (not shown) on the user interface 102. XML is a general-purpose specification for creating custom markup languages. It is classified as an extensible language, because it allows the user to define the mark-up elements. XML's purpose is to aid information systems in sharing structured data of the database 224, especially via the Internet, to encode documents, and to serialize data. In another embodiment, the engine 200 interprets a rule 100 statement in real time and renders an error message if the rule does not meet the syntax standards required and enforced by the engine 200.

It is also recognised that the engine 200 can also be used for, such as but not limited to, creating, editing, organizing and maintaining the benefit codes 103 in the hierarchical relationship 360. The engine 200 includes the composer module 202 for creating, editing, deleting and saving individual rules 100 and/or benefit codes 103. The composer module 202 performs functions as dictated by the user and thrcomposer module 202 saves benefit codes 103, and their configuration, into the database 224. The engine 200 also includes a compiler 206 for converting benefit code 103 statements into an extensible mark-up language such as XML or into machine readable code. In an embodiment of the tool, the compiler 206 converts the codes 103 into XML whenever the user interacts with a compile button (not shown) on the user interface 102. In another embodiment, the engine 200 interprets code 103 statements in real time and renders an error message to the interface 102 if the code statement 103 does not meet the syntax standards required and enforced by the engine 200. The engine 200 can also use the composer module 202, for example, to transfer completed hierarchies 260,360 to the storage 224 for use in deployment of the plan 42.

The order in which codes 103 and blocks 328 are evaluated by the adjudication engine 40 can affect the adjudication result of the claims 12. New codes 103 and blocks 328 are placed at the bottom of the hierarchy 360 by default, for example. To rearrange the order, a user can drag and drop code objects (e.g. codes 103, blocks 326, blocks 328) wherever desired so that the new code object is in the target node. When a user moves a code object, the rule engine 200 instructs component modules of the engine 200 to modify the data relationship between the moved code objects and to render a new visual code hierarchy 360 to the screen (e.g. interface 102) as is described below.

One example implementation of the code hierarchy 360 is where individual codes 103 can only exist at the bottom most code container 328 level and that containers 326,328 that contain a code object 103 (e.g. via references 327,329) cannot be moved to a different level of the hierarchy 360. These reference limitations, as managed by the Hierarchy manager 204, help to reduce the complexity of maintaining the hierarchy 360 of circular references 327, as desired. It is recognised that there can be a number of hierarchy levels containing secondary containers 328 (i.e. a secondary container references 327 another secondary container 328 which then references 327 the codes 103.

Accordingly, the engine 200 can be considered a GUI application for defining plans 24, for eventual deployment in the database 224 for specified carrier/patient relationships. The engine 200 provides for grammar logic 212 to be based on operators, methods, business objects, and their attributes. Data types may be defined and enforced within the grammar logic 212 definitions, so that, for example, a date can only be compared to a date. The adjudication engine 40 can export its plan 42 configuration to the composer engine 200 (e.g. into the local memory 124) so that the exported plans 42 can be edited by the composer engine 200, for example. As well, the composer engine 200 is configured so that it can export any changed plan 42 definitions (e.g. content and/or configuration of the hierarchies 260,360) back to the database 224 and have those exported items (e.g. plan components, rule sets benefit sets, rule/benefit blocks, and individual rules 100/benefits 103, as well as links 240 there-between) re-evaluated and compiled into code (e.g. Java byte code) for use by the engine 40 in adjudication of received claims 12 that pertain to the now redeployed plan 42. It is also recognised that the redeployed plan 42 could also be reconfigured by the plan manager 44 (e.g. for specified inclusion/exclusion of blocks 226,228,326,328, rules 100, benefits 103, links 240) by using the edited plan 42 returned/exported by the engine 200 back to the database 224.

### Composer Module 202

The composer module 202 of the rule engine 200 can provide a graphical view of the rule database called a Rule Map of the rule hierarchy 260 (see FIG. 7), as well as a benefit map of the code hierarchy 360, not shown. The Rule Map shows the current Rule Organization and active Rules 100 based on the system date. The Rule Map provides access through the Rule Containers 226, 228 to individual Rules 100 for viewing and editing. Management of the Rule Container hierarchy 260 can be done through drag/drop and cut/paste features on Rule Map via the rule manager 202, and/or through the hierarchy manager 204, further described below.

The composer module 202 is used to manage the rule inclusions 227 within a Rule Block 228, for example. As described with reference to FIG. 12a, the Timeline 302 feature is applicable to the organization of Rules 100 within Rule Blocks 228. The Timeline 302 keeps track of where and when Rules 100 are included in the Rule Block 228. This means that a snapshot of the rule data that is in effect at any point in time is available. The point in time can be in the past or future. This feature is useful for processing claims 12 that have been back dated and for implementing changes that are future dated, as the rule hierarchy 260 provides guidance for instructing the engine 40 in processing claims 12 using appropriate rules 100 and/or benefits 103 where the claim service date matches the effective/expiry date(s) of the associated references 227,229,327,329.

It is recognised that timelines 302 are not the same as Rule Versions 300, where: Rule Versions 300 track the history of changes to the definition of a rule 100. Timelines 302 track when and where a Rule 100 is used and do not specify a particular Rule Version 300, for example. However, it is recognised that the timelines 302 can also be used to specify particular rule versions 300, when desired.

The Rule Map of the hierarchy 260 can show the Rule 100 organization that is in effect at the current time as determined by the clock (or other defined chronological time) of the user interface 102. The Rule Map displays Rule Inclusions 227 depending on their status, for example using color and font style differences/distinctions (e.g. Expired Rule Inclusions 227 can be displayed in grayed type, unreleased Rule Inclusions 227 can be displayed in normal type, and released Rule Inclusions 227 are displayed in bold type).

The composer module 202 can provide a detailed view and addition/modification of the Rule Inclusions 227 over time. This view can be logically segmented into Time Spans. Each Time Span can represent a period in which the Inclusions 227 are static. The boundary between Time Spans represent the point in time where at least one Inclusion 227 changes. Time spans can be calculated in memory by the application and may not necessarily map one for one with records in a Rule-Rule Block table of the hierarchy 260. For example, A Rule Dependency Map is displayed on each composer module 202 window (displayed in the interface 102) next to the a Text/Tree View of the rule 100. The Dependency Map can show the all Rule Blocks 228 that reference 227 that rule 100 and in turn the Rule Super Blocks 226 that reference 229 the Rule Blocks 228 (see FIG. 7 for example). It is recognised that composer module 202 can configure and display to the user (via the interface 102) current and historical views of the Rule Blocks 226,228.

It is to be appreciated that a rule statement may be referenced by any number of blocks 228 or superblocks 226; however, each rule 100 will only exist once in the rules database 224.

### Dependency Manager 208

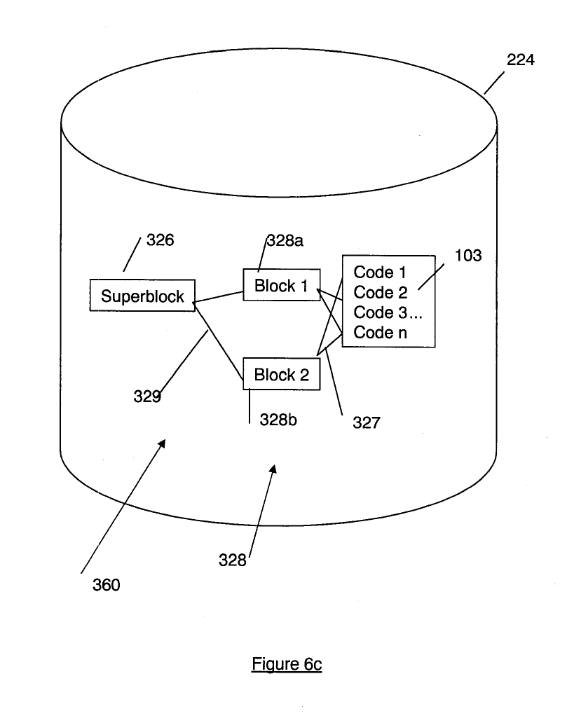

The engine 200 includes a Dependency Manager 208 for tracking the relationship between rules 100 and blocks 228 and superblocks 226. The advantage of using references to rules 100 rather than actual copies is the ability to share common rule objects. Changes made to a rules object are automatically picked up by all the references to the rule object. It is appreciated, however, that with the possibility of any number of references to a rule object it may be difficult to keep track of the dependencies. The dependency manager 208 is operable to manage the dependencies of each rule object and to visually display the dependency relationship as a dependency map for the convenience of the user. The dependency map 242 helps a user keep track of rule dependencies by mapping the rule hierarchy 260 from the bottom up. Each rule container (or rule block 226,228) is shown with its parent container and so on up the family tree. An exemplary dependency map 242 is illustrated in FIG. 8. As shown, rule 240 is named ‘00TEST’ and is connected to two different rule blocks 228, namely ‘01.04A SERVICE RULE SET’ and ‘03.02A SERVICE RULE SET’. As shown, the dependency map 242 is shown to the left of the rule editor window 244, although it is to be appreciated that the dependency map 242 may be located in any location on the visual interface. As the user edits the rule 246, the user is able to visualize that each reference to the rule 246 will also be modified.

The engine 200 includes a Dependency Manager 208 for tracking the relationship between benefits 103 and blocks 328 and superblocks 326. The advantage of using references to benefits 103 rather than actual copies is the ability to share common benefit objects. Changes made to a benefits 103 object are automatically picked up by all the references to the rule object. It is appreciated, however, that with the possibility of any number of references to a benefit object it may be difficult to keep track of the dependencies. The dependency manager 208 is operable to manage the dependencies of each benefit object and to visually display the dependency relationship as a dependency map for the convenience of the user. The benefit dependency map helps a user keep track of benefit dependencies by mapping the benefit hierarchy 360 from the bottom up. Each benefit container (block 326,328) is shown with its parent container and so on up the family tree.

### Search Module 210

The rule engine 200 also includes a search module 210 for allowing a user to find a particular rule 100 (as well as blocks 226,228) in the rules database 224 for editing, deletion or for analysis. When the user interacts with a searching window on the user interface 102, the rule module 202 communicates with the searching module 210 and instructs the searching module to find rules 100/blocks 226,228 that correspond to the searching criteria pre-entered by the user. The searching module 210 queries with the rule database 224 with the searching criteria. If one or more rules 100/blocks 226,228 are returned from the database 224, the searching module renders the results as a list of rules 100/blocks 226,228 on the visual interface 102. If no rules 100/blocks 226,228 are returned from the database 224 that match the searching criteria, the searching module 210 notifies the user that no rules 100/blocks 226,228 were found.

The rule engine 200 also includes the search module 210 for allowing a user to find a particular benefit 103 (as well as blocks 326,328) in the rules database 224 for editing, deletion or for analysis. When the user interacts with a searching window on the user interface 102, the module 202 communicates with the searching module 210 and instructs the searching module to find benefits 103/blocks 326,328 that correspond to the searching criteria pre-entered by the user. The searching module 210 queries with the rule database 224 with the searching criteria. If one or more rules benefits 103/blocks 326,328 are returned from the database 224, the searching module renders the results as a list of benefits 103/blocks 326,328 on the visual interface 102. If no benefits 103/blocks 326,328 are returned from the database 224 that match the searching criteria, the searching module 210 notifies the user that no benefits 103/blocks 326,328 were found.

### Hierarchy Module 204

The rule engine 200 also includes a hierarchy module 204 for managing the child-parent relationships in the rules database 224 and the visual representation of the hierarchy 260 on the interface 102. The rule engine 200 also includes the hierarchy module 204 for managing the child-parent relationships in the database 224 and the visual representation of the hierarchy 360 on the interface 102.

Users of the tool interact with rule/benefit objects via the interface 102, an example of which is shown in FIG. 9. As shown, a user is able to click on the components of a rule object with a mouse cursor. For example, if the user wishes to change parameter ‘20000101 ’, the user is able to click on the parameter and directly change its value by typing on the keyboard. Once the user is satisfied with the new value, the user can choose to save the rule 100 in the memory 124 associated with the engine 200. The interaction is processed by the module 202 which is operable to save the new rule 100/benefit 103 object in the rules database 224. Likewise, when a user moves a rule 100/benefit 103 to another location in the hierarchy 260, 360, the module 202 instructs the hierarchy module 204 to change the references to the rule 100/benefits 103 in the rules database 224. The dependency module 208 also manages the dependency relationship and renders the new dependency relationship to the visual interface 102 as a dependency map 242 when the user wishes to view the dependency map 242 for a particular rule 100/benefit 103.

The dependency module is also adapted for coupling the adjudication rules 100 to the secondary rule container 228 by the rule reference 227 associated with the content of the secondary rule container 228 and is adapted for coupling the secondary rule container 228 to the primary rule container 226 by the container reference 229 associated with the content of the primary rule container 226, such that the adjudication rules 100, the containers 226,228, and the rule and container references 227,229 define the rule hierarchy 260 for representing the set of adjudication rules.

### Business Management Process 400

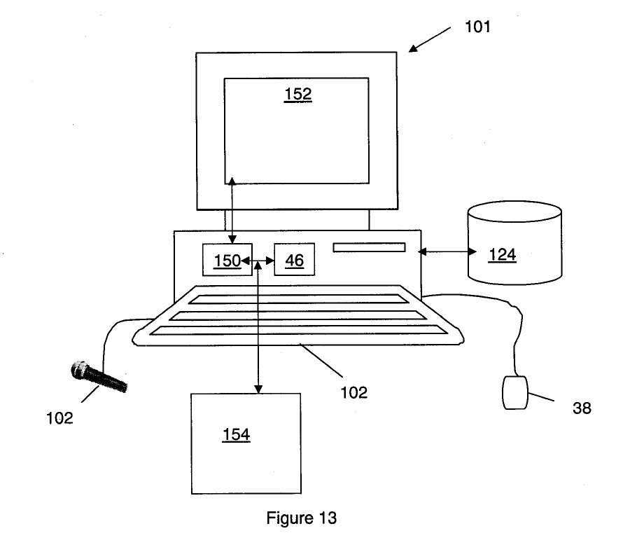

Referring to FIG. 16, shown is an example workflow of the adjudication environment 10, showing the major components of a business management process 400 for facilitating the adjudication of claims 12 submitted by insured products and/or service providers 15 (e.g. dentists, doctors, pharmacies, etc.) on behalf of the patient 14 (e.g. recipient), for example. In addition to the components of the environment 10 of FIG. 1, the example management process 400 includes components such as but not limited to: a fee guide maintenance 402 for monitoring updates to fee guides used by the adjudication engine 40, such that the fee guides map prices to service codes 103 (e.g. government and/or carrier 231 specific); the above mentioned rule and benefit hierarchy 260, 360 creation process implemented by the composer engine 200; a plan creation and/or enrolment process (collectively referred to as a deployment process 404) as implemented by the plan management engine 44 for facilitating deployment of plans 42 to the database 224 using rule and benefit hierarchies 260, 360 created by the composer engine 200, as further described below; a member enrolment and management process 406 for enrolling providers 15, patients 14, patient groupings (e.g. companies and other organizations), etc.; a provider update process 408 for maintaining relevant provider 15 information; a claims receiving process 410 configured to receive the claims 12 from a variety of provider/patient sources and for distributing the received claims to the adjudication process 18 for processing by the adjudication engine 40 in view of the appropriate deployed plan(s) 42 stored in the memory 224; a claims management process 412 for reviewing by a review engine 50 the performance of the adjudication process 18 (e.g. level of received claims 12 that had specified types of error(s) during the adjudication process 18) and for modifying 414 the deployed plan 42 and potentially the rules creation process (i.e. operation of the composer engine 200) based on the results generated by the review engine 50; and an inquiry process 416 for providing status and other historical process information for the claims 12 (e.g. reports for transacted claims 12—e.g. EOBs—as well as status for claim transactions in progress). It is recognised that all of the processes of the business management process 400 can be coupled for interaction with one or more memories 224 (e.g. databases), in order to access data required for implementation of the respective process as well as to store the results of the respective process.

Further, as shown in FIG. 1, it is recognised that the components of the business management process 400 can communicate with one another via one or more communication networks 11, including otherwise than as shown. Further, it is recognised that the interactions between the components and/or between the components and the database(s) 224 can be message based (e.g. request—response), such that or each class of message that forms part of the workflow of the process 400 can be defined as a message that carries out the required steps for the process triggered by the workflow. The result of the completion of the workflow in response to the request message can be a synchronous or asynchronous response message returned to the requestor (or forwarded to another recipient as configured/defined/specified). For example, an application or functional acknowledgement can be returned in response to the request message.

### Plan Management Engine 44

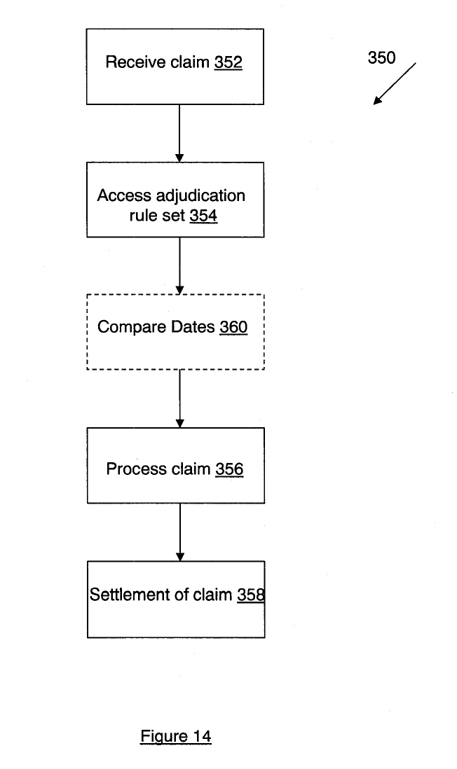

Referring to FIG. 17, shown is an example deployment process 420 for implementation by the plan engine 44, for using the hierarchies 260,360 (e.g. association of defined blocks 226,228,326,328, references 227,229,327,329, rules 100, benefits 130, and links 240) developed by the composer engine 200. The deployment process 420 can be implemented as a Batch/Real-time process for providing the deployed plans 42 to the database 224 for use by the adjudication engine in processing of the received claims 12. Accordingly, newly published/assigned plans 42 or changes/modifications to existing plans 42 are replicated to database 224, so the engine 40 can adjudicate accordingly. As discussed above, the deployed plan can consist of a list of, such as but not limited to: Adjudication Rules 100 (embodied in the hierarchy 260), a list of Service Codes 103 (embodied in the hierarchy 360), a Fee Guide and a set of “fiscal” and other type parameters, for example. For example, the plan 42 defines a set of criteria that need to be checked to determine if a particular service code 103 or package code can be carried out (e.g. on a tooth). An example is that a tooth must exist in order for it to be extracted. The criteria are implemented in the rules 100, such that application of the rules 100 via the hierarchy 260 (i.e. by the adjudication engine 40) are used to determine whether a given service code 103 can be paid by the plan 42, in view of the level of detailed claim information (e.g. claim content) submitted in the claim 12.

It is recognised the role of the composer engine 200 in the environment 10 is to facilitate Adjudication Rules List Creation to define and combine rule 100 into defined rule Blocks 226,228. (e.g. rule hierarchies 260) and Service Code Coverage List Creation to define and combine Service Codes 103 into defined Benefit Blocks 326,328. (e.g. benefit hierarchies 360. The role of the plan engine 44 in the environment 10 is to facilitate the assembly of various blocks 226,228,326,328, rules 100, and benefits 103 from the created hierarchies 260,360 (e.g. used as template hierarchies 260, 360) of the composer engine 200 and then to customize the template hierarchies 260, 360 through modification (e.g. addition, deletion, override, etc.) of the included blocks 226,228,326,328, rules 100, and benefits 103 in the plan hierarchies 260, 360 customized for a specific carrier 231, provider 15, and/or class of recipient 14. This modification can be implemented by a user (e.g. plan administrator) of the plan engine 44 via the specification of parameters and new/changes to the references 227,229,327,329, rules 100, benefits 130, and links 240 of the template hierarchies 260,360 created by the composer engine 200. Once finalized, i.e. the modification of the template hierarchies 260,360 is completed, the plan 42 containing the modified hierarchies 260,360 is stored in the database 224 as the deployed plan 42, for subsequent use by the adjudication engine 40. It is recognised that the functionality and modules of the engines 44, 200 can be as shown, combined, and/or further subdivided other than as shown, as desired. It is also recognised that the engines 44, 200 can be hosted on the same or different computer devices 101. For example, the engines 44, 200 could be hosted on a server device 101 for access over the network 11 by a client device 101 of a user of the functionality of the engines 44, 200.

Further, it is recognised that any impact on Overrides can be determined at the level of the change and lower. For example, for a Member Plan Change—only the overrides at the Member+Recipient level could be impacted. (etc.). The impact on Overrides can be to those override at a lower level that may not include the Plan Assignment. The Level can inherit the Plan Assignment from the level of the Change. For Example: a Plan Assignment change at a Class Level can have an impact on all Member records in the same Class, which do not have a Plan Assignment at the Member Level but do have Plan Overrides Assigned.

It is also recognised that related Overrides are any overrides using a block label that existed in the ‘old’ plan ‘and’ in the ‘new’ plan. Un-related overrides can be any overrides using a block label that existed in the ‘old’ plan and NOT in the ‘new’ plan. Benefit Coverage Overrides may not be identifiable in this process as they are carried over to the New Plan to remain active. The Overrides available for ‘re-open’ can be those that belong to the Old Plan and have the same Expiry Date as the Old Plan Expiry Date.

It is also recognised that the modification to the blocks 226,228,326,328 content, via the references 227,229,327,329 can be dated to have an override effective and/or expiry date. Accordingly, these modifications (e.g. as embodied in the references 227,229,327,329) are considered temporary modifications (e.g. overrides) as the configuration of the hierarchy 260,360 will revert back to the pre-modified state when the chronological date is outside of the override effective and/or expiry date. Further, upon accessing the information details of the existing plan 42 and/or template hierarchies 260,360, the plan engine 44 can provide for a display on the interface 102 all current and/or previous overrides and their associated effective/expiry date(s), where available, to the user of the plan engine 44.

### Parameter Values 52

Carriers 231 that want to include or exclude service codes 103 from a plan 42 (e.g. a plan not yet deployed however is loosely defined using the hierarchies 260,360 created by the composer engine 200) can create lists of inclusions and exclusions for use by the plan engine 44 when creating the final plan 42 for deployment. The inclusions and exclusions can become parameters 52 of the deployed plan 42. This can inhibit the need to create new package identifiers for each Carrier 231. A deployed plan 42 contains a number of “fiscal” parameters 52 that determine how the claim 12 will be adjudicated. Items such as co-insurance, maximum and COB are examples of “fiscal” parameters 52. Parameterized Values 52 can be used to minimize hard-coding and maximize component re-use of the rule and benefit objects created by the composer engine 200. Parameterized values 52 can be defined globally but they can be assigned to plan and/or as override parameters 52 in the hierarchies 260,360. It is recognised that literal values 112, operators 110, and parameter values 114, as shown in FIGS. 5a,5b, are hereafter referred to as parameters 52.

Example override details (e.g. parameters 52) of the template hierarchies 260,360 can be details such as but not limited to: Elig. Prof. $—the amount determined to be eligible after plan coverage and rules, but prior to the application of deductibles, coinsurance and maximum; Lab Elig. $—the amount determined to be eligible after plan coverage and rules, but prior to the application of deductibles, coinsurance and maximum; Exp. Elig. $—the amount determined to be eligible after plan coverage and rules, but prior to the application of deductibles, coinsurance and maximum; Ded. Prof. $—the amount of the deductible applied (professional eligible amount, lab1 eligible amount, and lab2 eligible amount); Coins. %—the percentage at which the claim item was adjudicated; Max $—the out of pocket amount due to a reduction in payment because a plan maximum was reached; Lab Ben. $—the amount payable (after deductible, coinsurance and maximum) for the Lab amount portion of the claimed professional fee; Exp. Ben $—the amount payable (after deductible, coinsurance and maximum) for the Expense amount portion of the claimed professional fee; Benefit Amount—the amount payable (after deductible, coinsurance and maximum) for the Professional amount portion of the of the claimed Professional Benefit amount; Adjudicated Service Code—enables the user to override the adjudicated service code that was used; and the estimated Benefit Amount.

### Member Categories 54

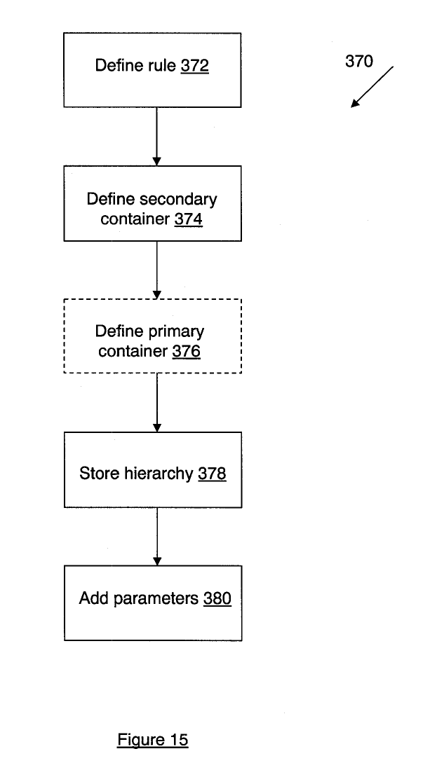

Referring to FIG. 18, shown are example Groups/Divisions/Units or Members for selection by the plan engine 44 in assigning the deployed plans 42 to, as well as modification of some of the Plan Parameters 52 in the deployed plan 42, for the deployment process 404 (see FIG. 16). For example, carriers 231 wish to have Plans 42 set up for groups within a company or an organization. Each group can be made up of members and their dependents. Members are be enrolled with the Carrier 231 before they can be assigned a plan 42, or can be dynamically assigned, as desired, such as upon the delivery of the member's first claim 12 to the adjudication process 18. Typically the plan 42 is assigned/deployed to a group; occasionally the plan 42 is assigned/deployed to a member or dependent.

The member categories 54 include member types such as but not limited to: carrier 231; company; department; unit; subscriber; and recipient 14. It is recognized that the modifications implemented by the plan engine 44 can be associated/assigned to each/any of the member category types 54, as desired. For example, the plan engine 44 can modify the template hierarchies 260,360 in order to make deployed plans 42 specific to different individual recipients 14 (e.g. company president, floor supervisor, shop floor worker), such that the various maximums, minimums, services, products, etc. of the deployed plan 42 have customized parameter values 52 and/or blocks 226,228,326,328, and/or references 227,229,327,329, and/or rules 100, and/or benefits 130, and/or links 240 specific to the individual. It is recognised that this level of customization afforded by use of the template hierarchies 260,360, through modification by the plan engine 44, provides for ease of customization for plan 42 deployment (and redeployment in the case of modifying an existing deployed plan 42). It is also recognised that the use of the containers and references structure of the hierarchies 260,360 provides for reuse of the basic defined rules 100 and benefits 103 through creation of multiple instances and combinations of those instances. Accordingly, the update of rule 100 and/or benefit 103 content/logic is more easily propagated through all of the various deployed plans 42 that use the updated rule 100 and/or benefit 103 (for example done via the composer engine 200 in the event of a government and/or carrier policy change).

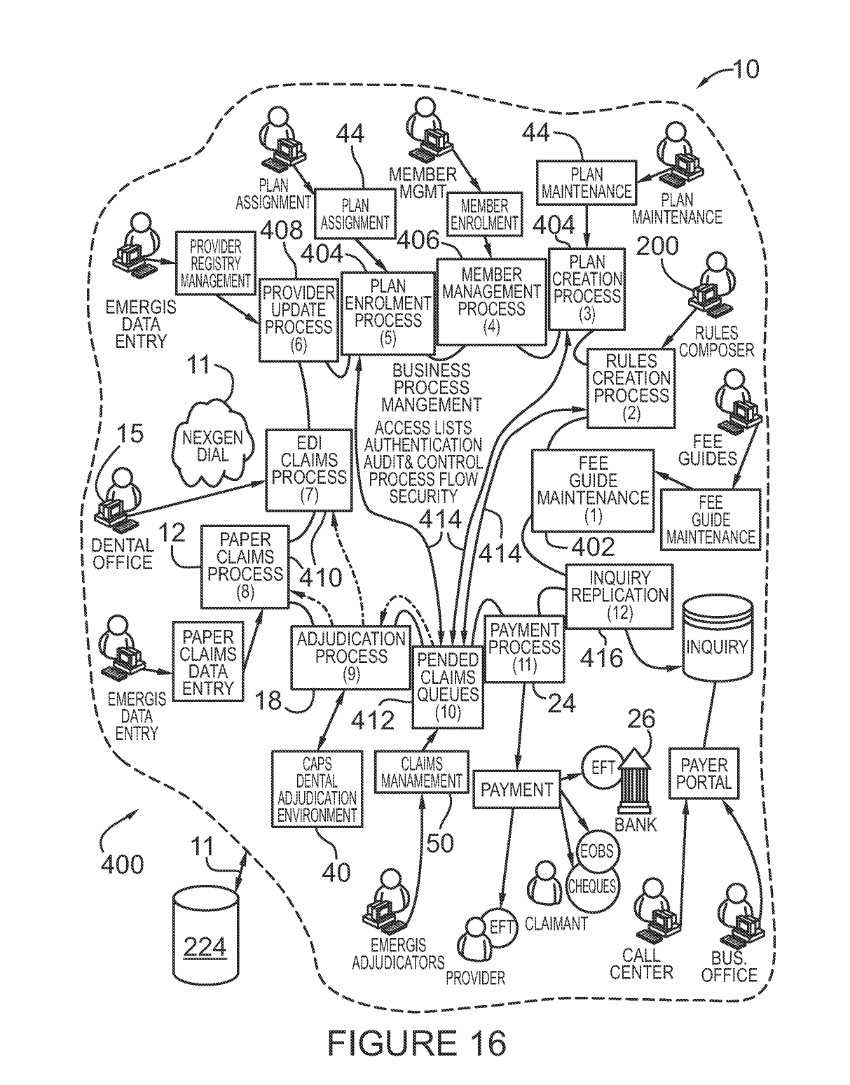

The Plan engine 44 can create, modify, and/or maintain the plan components that the plan 42 is composed of. Referring to FIG. 19, the plan engine 44 can have a number of components to facilitate modification of the hierarchies 260, 360 obtained from the memory 224 (e.g. template hierarchies 260,360 provided by the composer engine 200, a deployed plan having previously configured hierarchies 260,360, etc.). For example, the plan engine 44 has a data module 440 for obtaining the hierarchies 260, 360 (e.g. from the database 224) and for storing them in a local memory 428; a deployment module 438 for deploying the modified hierarchies 260,360 as the deployed plan in the memory 224; a benefit module for accessing the hierarchy 360 and for updating the contents of the associated benefits 103, blocks 326,328 and references 327,329; a rule module 432 for accessing the hierarchy 260 and for updating the contents of the associated rules 100, blocks 226,228 and references 227,229; a parameter module for updating the parameters 52 of the hierarchies 260,360, for example using ranges of predefined parameters 52 stored in a memory 435 (e.g. a series of parameter tables or other data construct associated with various carriers and/or governmental agencies); and an assignment module 430 for assigning the appropriate member categories 54 to elements (e.g. blocks, rules, benefits, etc.) of the hierarchies 260,360. It is shown that the modules 430,432,434 communicate via the module 436 with the contents of the memory 428, however it is recognised that the modules 430,432,434 can communicate directly with the contents of the memory 428, as desired. Once deployed, the plan 42 is available for use by the adjudication engine 40 for processing the received claims 12.

Each of the plan 42 components references potentially many parameterized values 52 with default values that can be overridden by Plan engine 44 in the act of publishing/deploying the plan 42, including potential override by the Plan Assignment module 436 in the act of assigning the to be deployed plan 42 to one or more specific enrolment entities. The components of the plan 42 can include components of the hierarchies 260,360 such as but not limited to: Benefit Super Block 326 for Coverage that can be used to determine if a specific benefit 103 is covered under the plan 42 or not; Benefit Super Block 326 for Adjudication Logic that can be used to restrict the allowable choices for parameterized values 52 of type benefit block 328—adjudication logic, such as those used in predefined interaction rules, where this type of block 326 can be ignored by the adjudication engine 40 and therefore used as a convenience for the Plan Manager and Plan Assignment user interfaces 102 of the plan engine 44 (e.g. if not set, all benefit blocks 326,328 are displayed as plan components for potential modification); Benefit Super Block 326 for Plan that can be used to restrict the allowable choices for parameterized values 52 of type benefit block—plan, such as those used by coinsurances or frequency rules 100, where this type of block 226 can be ignored by the adjudication engine 40 and therefore used as a convenience for the Plan Manager and Plan Assignment user interfaces 102 of the plan engine 44 (if not set, all benefit blocks 326,328 are displayed as plan components for potential modification); Rule Super Block 226 for Adjudication Logic can be used to select the complete adjudication logic built using Rules Composer engine 200; Rule Super Block 226 for Carrier Specific Adjudication Logic that can be used to select the carrier 231 specific adjudication logic built using Rules Composer engine 200, if any is used; and/or other blocks 226,228,326,328 and references 227,229,327,329, as desired.

### Benefit Module 430

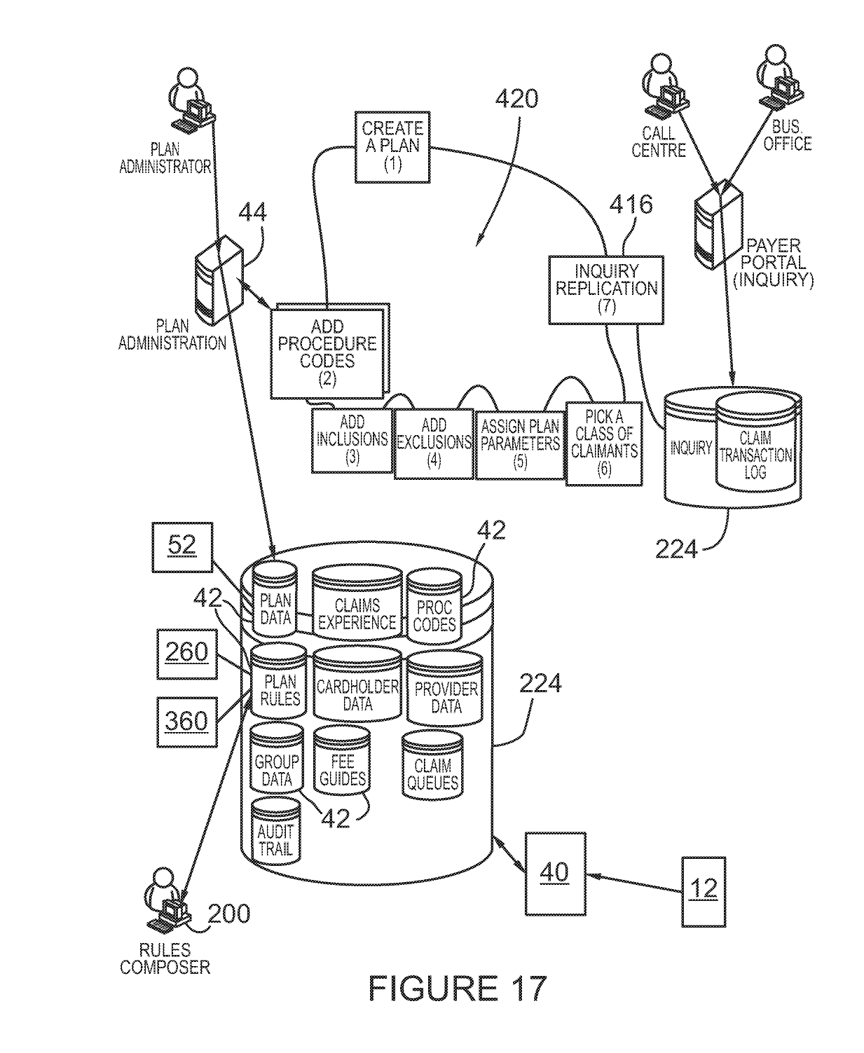

Referring to FIGS. 19 and 20, this sub-component or perspective within the Plan engine 44 is used to add/delete/modify the grouping of the benefits 103 appropriately into the benefit blocks 328. These blocks 328 are then included and/or excluded together to form the top level benefit super block(s) 326. The block(s) 326 for coverage type defines the list of covered benefits 103. The block(s) 326 are used for various purposes depending on its type for coverage, adjudication logic, or plan. The coverage override type defines those benefits 103 that are being included or excluded for the specific benefit override being assigned, e.g. via the Assignment module 436. Each benefit 103 can be added/modified/deleted, if needed, using the functionality and modules of the composer engine 200 (e.g. using a business grammar that is supported by a rule evaluation adjudication engine module within the adjudication engine 40).

For example, using the module 430, the user can gain access to plan details, such as but not limited to: Plan Id—Plan Name—Plan Description; Benefit Super Block—Coverage; Super Benefit Block Id—Benefit Block Name; Benefit Super Block—Plan; Super Benefit Block Id—Benefit Block Name; Benefit Super Block—Adjudication; Super Benefit Block Id—Benefit Block Name; Coverage tab, Provincial Plan information, Consultant Review requirements, and carrier 231 Alternate Coverage information; Pricing information; Year (e.g. effective/expiry dates of the plan 42; Specialty (e.g. dental, vision, drug, etc.); Province or other regional jurisdiction; Adjudication Rules via the super blocks 226; and/or Fiscal information/parameters 52.

It is recognised that for each of the accessed plan details on the user interface 102, the module 430 can display the appropriate Super Block ID & Name; and associated appropriate Rule Block ID & Name. It is also recognised that the modification of the hierarchy 360 information would include changes to the references 327,329 of the benefit objects, including changes such as but not limited to: changes in the effective date of the references 327,329; changes in the expiry date of the references 327,329; changes in the benefit object version associated with the references 327,329; changes to the definition content of the benefit codes 103 and/or the benefit blocks 328; and/or inclusion or exclusion of the references 327,329 in the respective block 326,328, as well as changes to the ordering of the references 327,329 in the respective block 326,328.

For example, the module 430 can be used to modify benefits 103 within the block 328, add/delete Benefit Code(s) 103 to a Block 328, add/delete Blocks 328 to a super block 326, add/remove Benefit Code(s) 103 from a Block 326, set Expiry Date for Benefit(s) in a Block 328, Set Effective Date for Benefits 103 in a Block 328, set Expiry Date for block(s) 328 listed in a Block 326, Set Effective Date for block(s) 328 listed in a Block 326. It is recognised that, as described above, the inclusion of blocks 328 in blocks 326 and the benefits 103 in blocks 328 is coordinated in the hierarchy 360 via the listing of the references 327,329 in the appropriate blocks 326,328.

If finished, then the deployment module 438 can be used to save the modified Plan 42 and then the saved plan 42 is deployed to the database 224.

### Rule Module 432

Referring to FIGS. 19 and 20, this sub-component or perspective within the Plan engine 44 is used to add/modify/delete the rules that implement the actual complex business logic within the adjudication engine 40. These rules 100 are then included and/or excluded together and are grouped (via modifications to the references 227) into the rule blocks 228. These blocks 228 are in turn are then included and/or excluded together and grouped (via modifications to the references 229) into one or more rule super block 226, which can define the complete set of business logic to be evaluated (e.g. including order of execution of the listed blocks 228) when this specific block 226 is selected. Each rule 100 can be added/modified/deleted, if needed, using the functionality and modules of the composer engine 200 (e.g. using a business grammar that is supported by a rule evaluation adjudication engine module within the adjudication engine 40).

For example, using the module 430, the user can gain access to plan details, such as but not limited to: Plan Id—Plan Name—Plan Description; Benefit Super Block—Coverage; Super Benefit Block Id—Benefit Block Name; Benefit Super Block—Plan; Super Benefit Block Id—Benefit Block Name; Benefit Super Block—Adjudication; Super Benefit Block Id—Benefit Block Name; Coverage tab, Provincial Plan information, Consultant Review requirements, and carrier 231 Alternate Coverage information; Pricing information; Year (e.g. effective/expiry dates of the plan 42; Specialty (e.g. dental, vision, drug, etc.); Province or other regional jurisdiction; Adjudication Rules via the super blocks 226; and/or Fiscal information/parameters 52.

It is recognised that for each of the accessed plan details on the user interface 102, the module 430 can display the appropriate Super Block ID & Name; and associated appropriate Rule Block ID & Name. It is also recognised that the modification of the hierarchy 260 information would include changes to the references 227,229 of the benefit objects, including changes such as but not limited to: changes in the effective date of the references 227,229; changes in the expiry date of the references 227,229; changes in the benefit object version associated with the references 227,229; changes to the definition content of the rules 100 and/or the benefit blocks 228 (e.g. selecting specific versions 300 of the rule objects—e.g. rules 100); and/or inclusion or exclusion of the references 227,229 in the respective block 226,228, as well as changes to the ordering of the references 227,229 in the respective block 226,228.

For example, the module 432 can be used to modify rules 100 within the block 228, add/delete rules 100 to a Block 228, add/delete Blocks 228 to a super block 226, add/remove rules 100 from a Block 226, set Expiry Date for rules 100 in a Block 228, Set Effective Date for rules 100 in a Block 228, set Expiry Date for block(s) 228 listed in a Block 226, Set Effective Date for block(s) 228 listed in a Block 226, and add/delete versions 300 of the rule objects in the corresponding blocks 226,228. It is recognised that, as described above, the inclusion of blocks 228 in blocks 226 and the rules 100 in blocks 228 is coordinated in the hierarchy 260 via the listing of the references 227,229 in the appropriate blocks 226,228.

If finished, then the deployment module 438 can be used to save the modified Plan 42 and then the saved plan 42 is deployed to the database 224.

### Parameter Module 434

Referring to FIGS. 19 and 20, this sub-component or perspective within the Plan engine 44 is used to add/delete/modify or otherwise define the parameterized values 52 used within rules 100 and benefits 103, as well as the references 227,229,327,329 where appropriate. This modification of the parameters 52 provides for a generic set of rules 100/benefits 103 to be defined (e.g. the template hierarchies 260,360) and then reused with different specific values 52 that are assigned/associated for plan 42 deployment.

It is recognised that the override of the Effective date of the references 227,229,327,329 may not be prior to the ‘inherited’ Plan 42 Effective Date and may not be after the Plan 42 Expiry Date. Further, the override Expiry Date may not be prior to the ‘inherited’ Plan 42 Effective Date and may not be after the Plan 42 Expiry Date. Accordingly, the created/modified Date Range must be within the Plan 42 Effective and Expiry Date Range.

### Assignment Module 436

Referring to FIGS. 19 and 20, this sub-component or perspective within the Plan engine 44 is used to add/delete/modify (e.g. override values, override references 227,229,327,329, etc.) the member categories 54 that are associated with the plan 42 to be deployed. For example, before the Plan Assignment Process can begin, the User of the plan engine 44 determines at what level the Plan Assignment is to be performed (e.g. Carrier, Group, Division, Unit/Class, Member, Recipient of the categories 54). The User determines which of the existing Base Plans 42 (e.g. template hierarchies 260,360, already deployed plans 42, etc.) are most appropriate to use. The User determines what ‘overrides’ to the Base Plan are desired.

For example, depending on whether or not it is a Single Plan Assignment or a Bulk Plan Assignment will determine what path to Select. For example, for a Single Member-Recipient Assignment, the user can perform a Member Enrolment search until the appropriate record is found. Once the record is selected, the user can request Plan Assignment via the module 436 and be presented with the Plan Assignment screen 102 to enter in the details. For a Single Assignment to a record within the Group Hierarchy (Group/Division/Class), the user can perform a Group Enrolment search until the appropriate record is found. Once the record is selected, the user can request the Plan Assignment via the module 436 and be presented with the Plan Assignment screen 102 to enter in the details. For a Bulk Plan Assignment, the User can input the details of the appropriate level desired via the module 436, e.g. Insurer+Group+Division, Or Insurer+Group+Class. The user can then be presented with a data entry screen 102, which provides for the user to enter the appropriate Division/Class codes via the module 436. Once the keyed list is complete, the user can select the Plan Assignment screen 102 and enter in the details via the module 436.

### Review Engine 50

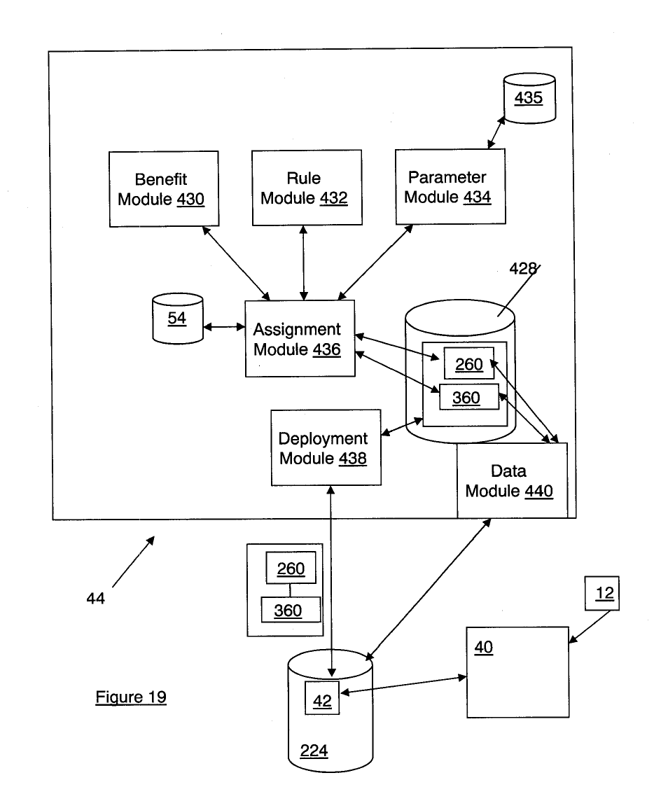

Referring to FIG. 16, shown is an example claims management process 412 for reviewing by a review engine 50 the performance of the adjudication process 18 (e.g. level of received claims 12 that had specified types of error(s) during the adjudication process 18) and for modifying/revising 414 the deployed plan 42 and potentially the rules creation process (i.e. operation of the composer engine 200) via updates/revisions 55 (see FIG. 22) based on the results generated by the review engine 50. It is recognised that based on the potential for revision/reconfiguration of the hierarchies 260,360, via the review engine 50, in view of the analysis of the queued claim 12, it is understood that iterative updates/revisions 55 of the hierarchies 260,360 (e.g. of the plan(s) 42) may provide for increases in auto adjudication levels for the received claims 12, in view of iterative updates/revisions 55 of the hierarchies 260,360 based on claim review (by a claim module 536—see FIG. 24), of the claims 12 submitted to the claims queue 53.

Referring to FIG. 22, shown is an example interaction of system 10 components, including the engines 44,50,200 with one another and with content (e.g. plans 24 and hierarchies 260,360) in the database 224. It is recognised that the review engine 50 coordinates any updates/revisions 55 to deployed plans 42 and/or to the template hierarchies 260,360 (i.e. those created by the composer engine 200) used in the development of the deployed plans 42.

It is recognised that the update/revision information/data 55 can be performed directly by the review engine 50, can be sent to the composer engine 200 to facilitate review/updates performed by the composer engine 200, can be sent to the plan engine 200 to facilitate review/updates performed by the plan engine 200, or a combination thereof. Also, it is recognised that the updates and/or revisions 55 can be performed on a claim 12 by claim 12 basis (e.g. using manual overrides specific only to that claim 12 instance), can be performed on the plan 42 itself that is associated with the reviewed claim (e.g. the plan data—including the plan hierarchies 260,360), and/or can be performed on the template hierarchies 260,360 (e.g. those hierarchies 260,360 used to develop the plan 42 under review).

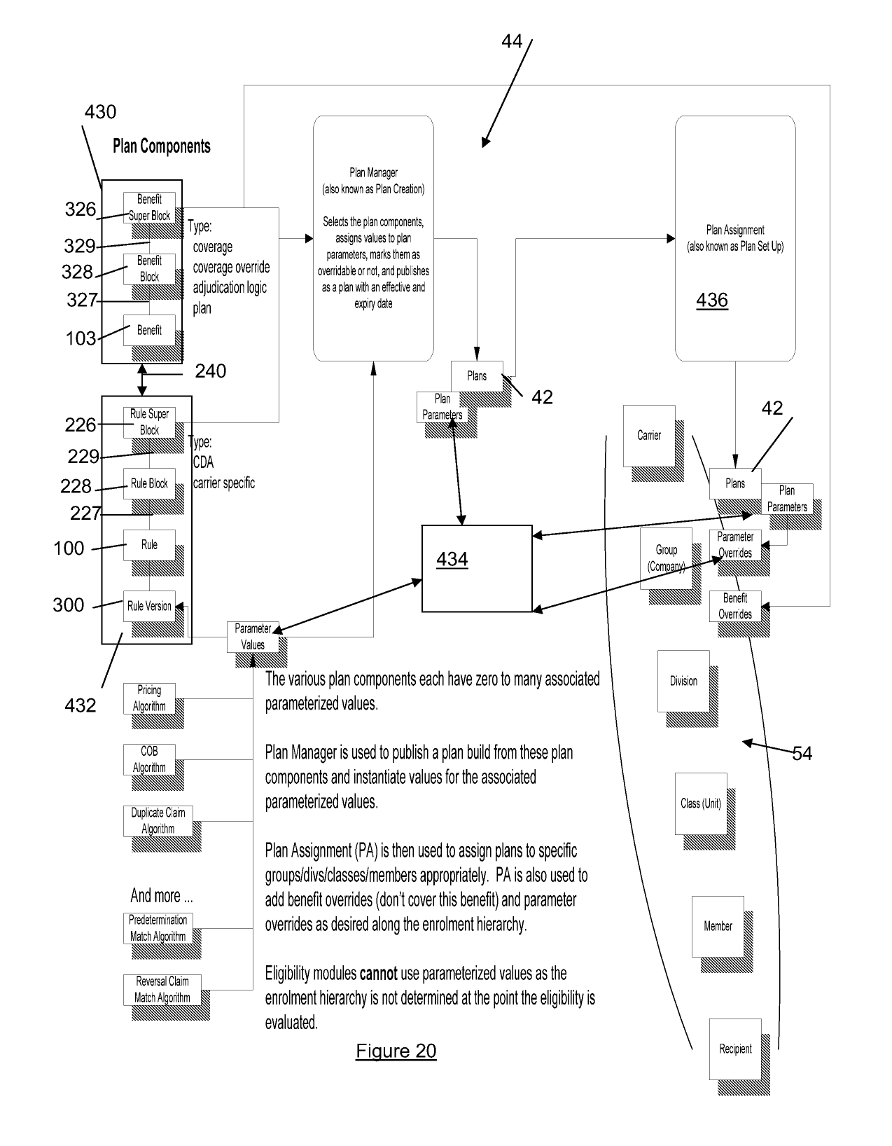

Referring to FIG. 23, shown are example processes 412,414 for implementation by the review engine 50, for facilitating the revision 55 of the hierarchies 260,360/plan 42 (e.g. association of defined blocks 226,228,326,328, references 227,229,327,329, rules 100, benefits 130, and links 240—see FIG. 10) developed by the composer engine 200 and/or plan engine 44, in response to analysis of claims 12 forwarded to a claims queue 53 by the adjudication engine 40 (for currently pended claims 12) and/or an administration entity (not shown) that is responsible for quality control/audit procedures of already transacted claims 12 (e.g. no longer in the adjudication process 18). The processes 412,414 can be implemented as Batch or Real-time processes for providing the revised/updated plans 42 and/or template/generic hierarchies 260,360 to the database 224, for use by the adjudication engine 40 in processing of the subsequently received claims 12, for use by the plan engine 44 for making changes (e.g. in the assignment of) the revised plan 42, and/or for use by the composer engine 200 for making changes to the template hierarchies 260,360.

Accordingly, changes/modifications to existing plans 42 and/or the template hierarchies 260,360 are replicated to database 224, so the engine 40 can adjudicate accordingly with the revised plan 42. As discussed, the revised plan 42 can consist of revised items, such as but not limited to: Adjudication Rules 100 (embodied in the hierarchy 260), a list of Service Codes 103 (embodied in the hierarchy 360), a Fee Guide and a set of “fiscal” and other type parameters, for example. For example, the revised plan 42 defines a set of criteria that need to be checked to determine if a particular service code 103 or package code can be carried out (e.g. on a tooth). An example is that a tooth must exist in order for it to be extracted. The criteria are implemented in the rules 100, such that application of the rules 100 via the hierarchy 260 (i.e. by the adjudication engine 40) are used to determine whether a given service code 103 (as defined in the hierarchy 360) can be paid by the revised plan 42, in view of the reviewed level of detailed claim information (e.g. claim content) in the reviewed claim 12 or claims 12.

It is recognised the role of the composer engine 200 in the environment 10 is to facilitate Adjudication Rules List Creation to define and combine rule 100 into defined rule Blocks 226,228. (e.g. rule hierarchies 260) and Service Code Coverage List Creation to define and combine Service Codes 103 into defined Benefit Blocks 326,328. (e.g. benefit hierarchies 360, for example for use as template hierarchies 260,360 for use in plan 42 customization and deployment, as described above. Further, the role of the plan engine 44 in the environment 10 is to facilitate the assembly of various blocks 226,228,326,328, rules 100, and benefits 103 from the created hierarchies 260,360 (e.g. used as template hierarchies 260, 360) of the composer engine 200 and then to customize the template hierarchies 260, 360 through modification (e.g. addition, deletion, override, etc.) of the included blocks 226,228,326,328, rules 100, and benefits 103 in the plan hierarchies 260, 360 customized for a specific carrier 231, provider 15, and/or class of recipient 14. This modification can be implemented by a user (e.g. plan administrator) of the plan engine 44 via the specification of parameters and new/changes to the references 227,229,327,329, rules 100, benefits 130, and links 240 of the template hierarchies 260,360 created by the composer engine 200. Once finalized, i.e. the modification of the template hierarchies 260,360 is completed, the plan 42 containing the modified hierarchies 260,360 is stored in the database 224 as the deployed plan 42, for subsequent use by the adjudication engine 40. It is recognised that the functionality and modules of the engines 44, 50,200 can be as shown, combined, and/or further subdivided other than as shown, as desired. It is also recognised that the engines 44, 50, 200 can be hosted on the same or different computer devices 101. For example, the engines 44, 50, 200 could be hosted on a server device 101 for access over the network 11 by a client device 101 of a user of the functionality of the engines 44, 50, 200.

Further, the role of the review engine 50 in the environment 10 is to facilitate the revision 55 of various blocks 226,228,326,328, rules 100, and benefits 103 from the created hierarchies 260,360 (e.g. used as template hierarchies 260, 360, parameterized and deployed in the plan 42 under revision) and then to revise the hierarchies 260, 360 through revision 55 (e.g. addition, deletion, modification, override, etc.) of the included blocks 226,228,326,328, rules 100, and benefits 103 in the plan hierarchies 260, 360 customized for a specific carrier 231, provider 15, and/or class of recipient 14. This revision 55 of the hierarchies 260,360 is done in view of errors or other deficiencies recognised/identified in claims 12 obtained from the claims queue 53, and can be implemented by a user (e.g. plan/claim administrator) of the review engine 50 via the revision 55 of parameters 52 and revisions/changes 55 to the references 227,229,327,329, rules 100, benefits 130, and links 240 of the hierarchies 260,360 of the plan 42 under review.

Once finalized, i.e. the revision 55 of the hierarchies 260,360 is completed, the revised plan 42 containing the modified hierarchies 260,360 is stored in the database 224 as the revised deployed plan 42, for subsequent use by the adjudication engine 40. It is recognised that the functionality and modules of the engines 44, 50, 200 can be as shown, combined, and/or further subdivided other than as shown, as desired. It is also recognised that the engines 44, 50, 200 can be hosted on the same or different computer devices 101. For example, the engines 44, 50, 200 could be hosted on a server device 101 for access over the network 11 by a client device 101 of a user of the functionality of the engines 44, 50, 200.

### Queues 53

The claims 12 for review can be forwarded to the claims queue 53 by the adjudication engine 40 (for currently pended claims 12) and/or an administration entity (not shown) that is responsible for quality control/audit procedures of already transacted claims 12 (e.g. no longer in the adjudication process 18). There can be 2 types of workflow queues, personal and group (of adjudicator) based queues. When claims 12 are pended by the adjudication engine 40, they are put into group based queues 53. People can be assigned group based queues 53 and can use ‘the engine 50 functionality to pull the claim 12 off the general queue 53 for subsequent review. It is also recognised that the engine 50 can be automated to pull any claims 12 off the queue 53 for subsequent analysis/review by the modules of the engine 50, e.g. a personal review.

The queue 53 can also contain claims 12 submitted due to potential fraud considerations, as identified by the engine 40 and/or other third party entities (not shown) of the environment 10. As further described below, anti-Fraud determination of claims 12 in the queue 53 can be managed by a screen(s) 102 in the review engine 50. This can be a table driven feature with a custom module in the engine 50 to execute the logic for review and possible revision/reconfiguration of the claim 12 and/or the hierarchies 260,360 associated with the claim 12 (e.g. through the modules 536,530,532,534, for example). The table data can be updated in real-time, and it is understood that Anti-Fraud can sometimes make mistakes and either miss, or catch too many claims 12, at least initially. However, based on the potential for revision/reconfiguration of the hierarchies 260,360, via the review engine 50, in view of the analysis of the queued claim 12, it is understood that iterative updates/revisions 55 of the hierarchies 260,360 (e.g. of the plan(s) 42) may provide for increases in auto adjudication levels for the received claims 12, in view of iterative updates/revisions 55 of the hierarchies 260,360 based on claim review (by a claim module 536—see FIG. 24) of the claims 12 submitted to the claims queue 53.

Further, the contents of the claims queue 53 can also be based on claims 12 submitted to the queue 53 for Quality Control purposes. For example, the environment 10 could be configured to see a certain % of claims 12 touched by each adjudicator and/or the adjudication engine 40. The actual number of claims 12 chosen for submission to the claims queue 53 due to QC can be based on some time period.

It is recognised that the contents of the claim queue 53 can be submitted based on an automated, semi-automated, and/or manual claim selection process. In the case of an automated process, the adjudication engine 40 submits claims 12 to the claims queue 53 based on the mismatch of the claim 12 content processing with the plan 42 content associated with the claim 12. In the case of manual or semi-automated, the workflow of claims submitted to the queue 53 can be managed by an administrator type role (not shown). It is recognised that, based on the potential for revision/reconfiguration of the hierarchies 260,360, via the review engine 50, in view of the analysis of the queued claim 12, it is understood that iterative updates/revisions 55 of the hierarchies 260,360 (e.g. of the plan(s) 42) may provide for increases in auto adjudication levels for the received claims 12, in view of periodic (e.g. as a result of the review of the claims 12 over time from the queue 53) iterative updates/revisions 55 of the hierarchies 260,360 based on claim review (by a claim module 536—see FIG. 24) of the claims 12 submitted to the claims queue 53.

### Engine 50 Modules

The engine 50 can revise/reconfigure (e.g. create, modify, and/or maintain) the plan components that the plan 42 is composed of, in view of the review results of the claims 12 obtained from the claim queue 53. Referring to FIG. 24, the engine 50 can have a number of components to facilitate revision of the hierarchies 260, 360 obtained from the memory 224 (e.g. template hierarchies 260,360 provided by the composer engine 200, a deployed plan having previously configured hierarchies 260,360, etc.). For example, the engine 50 has a claim module 536 for obtaining the claims 12 from the claim queue 53 and for analysing any errors identified in the obtained claims 12. For example, the errors identified in the obtained claims 12 can be one or more error categories such as but not limited to: claims adjudication—review claims 12 pended from the engine 40; quality control—verify accuracy of transacted claims 12 touched by claims adjudicators and/or the engine 40; and/or anti-fraud—review claims flagged as (possibly) fraudulent. The engine 50 can also have a validation module 538 for facilitating validation of the revisions/reconfigurations 55 of the hierarchies 260,360 associated with the claims 12 received from the queue 53. Further, the engine 50 can have a data module 540 for obtaining the hierarchies 260, 360 (e.g. from the database 224) and for storing them in a local memory 528 (for example) for subsequent revision/reconfiguration using the updates 55.

Further, the engine 50 can have a deployment module 538 for deploying the modified hierarchies 260,360 as the deployed plan in the memory 224, a benefit module 530 for accessing the hierarchy 360 and for updating the contents of the associated benefits 103, blocks 326,328 and references 327,329 based on the generated revisions/reconfigurations 55 of the claims module 536 in view of the analysis of the claims 12 obtained from the queue 53. Further, the engine 50 can have a rule module 532 for accessing the hierarchy 260 and for updating the contents of the associated rules 100, blocks 226,228 and references 227,229 based on the generated revisions/reconfigurations 55 of the claims module 536 in view of the analysis of the claims 12 obtained from the queue 53. Further, the engine 50 can have a parameter module 534 for updating the parameters 52 of the hierarchies 260,360, for example using ranges of predefined parameters 52 stored in a memory 535 (e.g. a series of parameter tables or other data construct associated with various carriers and/or governmental agencies) based on the generated revisions/reconfigurations 55 of the claims module 536 in view of the analysis of the claims 12 obtained from the queue 53. It is shown that the modules 530,532,534 communicate via the module 538 with the contents of the memory 528, however it is recognised that the modules 530,532,534 can communicate directly with the contents of the memory 528, as desired. Once deployed, the revised plan 42 is available for use by the adjudication engine 40 for processing the received claims 12 and/or for reprocessing the appropriate claims 12 from the queue 53.

It is recognised that the modules 530,532,534 can be referred to collectively as reconfiguration modules.

Each of the plan 42 components references potentially many parameterized values 52 with default values that can be revised by engine 50 in the act of reconfiguring and deploying the revised plan 42. The components of the plan 42 can include components of the hierarchies 260,360 such as but not limited to: Benefit Super Block 326 for Coverage that can be used to determine if a specific benefit 103 is covered under the plan 42 or not; Benefit Super Block 326 for Adjudication Logic that can be used to restrict the allowable choices for parameterized values 52 of type benefit block 328—adjudication logic, such as those used in predefined interaction rules, where this type of block 326 can be ignored by the adjudication engine 40 and therefore used as a convenience for the Plan Manager and Plan Assignment user interfaces 102 of the engine 50 (e.g. if not set, all benefit blocks 326,328 are displayed as plan components for potential revision); Benefit Super Block 326 for Plan that can be used to restrict the allowable revision choices for parameterized values 52 of type benefit block—plan, such as those used by coinsurances or frequency rules 100, where this type of block 226 can be ignored by the adjudication engine 40 and therefore used as a convenience for the Plan Manager and Plan Assignment user interfaces 102 of the engine 50 (if not set, all benefit blocks 326,328 are displayed as plan components for potential revision); Rule Super Block 226 for Adjudication Logic can be used to select the complete adjudication logic built using Rules Composer engine 200; Rule Super Block 226 for Carrier Specific Adjudication Logic that can be used to select the carrier 231 specific adjudication logic built using Rules Composer engine 200, if any is used; and/or other blocks 226,228,326,328 and references 227,229,327,329, as desired.

It is recognised that the modules 530, 532, 534 can be hosted independently by the review engine 50 and/or can be hosted by the other engine(s) 44, 200 and therefore called by the engine 50, when needed. For example, the review engine 50 can use the functionality of the composer engine 200, when updates/revisions 55 are applied to the rules 100, benefits 103, blocks 227,228,327,328, and/or the references 227,229,327,329, as desired.

### Claim Module 536

The claim module 536 is configured for obtaining the claims 12 from the claim queue 55 and for analysing any errors identified in the obtained claims 12. For example, the errors identified in the obtained claims 12 can be one or more error categories such as but not limited to: claims adjudication—review claims 12 pended from the engine 40; quality control—verify accuracy of transacted claims 12 touched by claims adjudicators and/or the engine 40; and/or anti-fraud—review claims flagged as (possibly) fraudulent. Further, error levels can be communicated to the user via the user interface 102 that describes if there are any problems with the claim 12 (e.g. identified by the adjudication engine 40). Based on the error level of the response (>0) various revision/reconfiguration actions can be taken by the claim module 536.

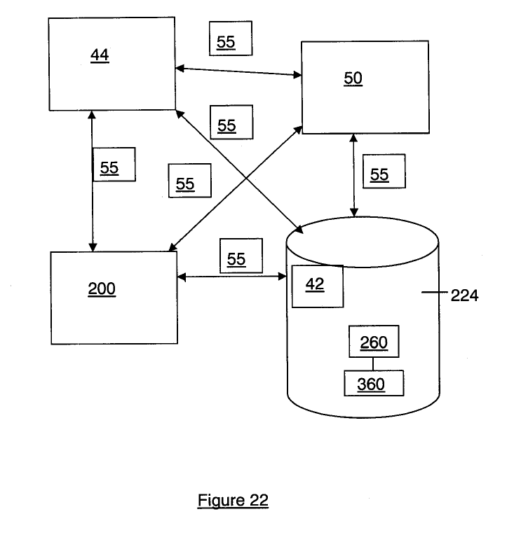

Referring to FIG. 25, the claim module 536 provides the details of the claims 12 (e.g. pended) to the user interface 102. the use of the engine 50 can, for example, review the claim information 550, procedure information 552, associated parameter 52 information 554, as well as any rule 100 and/or benefit 103 information 556 (e.g. any aspect of the hierarchies 260,360 content that is related to the particular information 550,552,554 being reviewed in association with the identified error and/or quality control/anti-fraud reason for the claim 12 being submitted to the claim queue 53.

For example, view and potential edit ability the following Procedure List 552 can be performed by the user in consultation with the user interface 102, namely: Actions; Engine Messages—Exemptions; EOB Correspondence; View Eligibility; View Transaction Details; and/or View Claim Experience. For example, the screen 102 can also display the change list as a summary of the revisions 55, including such as but not limited to; User—identifies who made the data change; Date—identifies what date the change was made; Field—identifies the field of the data change; Old Value 52 or rule 100 or benefit 103 or reference 227,229,327,329 or link 240—identifies what the Value 52 or rule 100 or benefit 103 or reference 227,229,327,329 or link 240 was before the change; and new Value 52 or rule 100 or benefit 103 or reference 227,229,327,329 or link 240—identifies what the Value 52 or rule 100 or benefit 103 or reference 227,229,327,329 or link 240 was after the change.

A claim Actions tab 558, see FIG. 25, provides for users of the engine 50 to perform various functions against the current claim 12 under review, as obtained from the queue 53. The available actions 558 can depend on the current user's role and the claim's 12 current state. Saving information on the Actions tab can automatically save changes to the hierarchies 260,360 associated with the reviewed claim 12 (e.g. data concerning Eligibility, Member Eligibility, Pre-determination, and Claim Details, for example). To perform an action on the reviewed claim 12, the user, for example: under services, clicks to select claim 12; opens the claim 12 on which one wants to perform the action (e.g. revisions/reconfigurations 55; selects the Actions tab, where the current user's role and the claim's current state can dictate the available actions (e.g. the degree and what ability to implement changes to the claim 12 and/or the associated hierarchies 260,360); clicks to select the appropriate action, and enters/selects any necessary changes (e.g. parameter 52, references 227,229,327,329, etc.); and clicks Save to save the changes as the updates/revisions 55.

Other revisions/reconfigurations 55 possible are for Merge/Unmerge of Patients 14 in the plan 42. For example, The engine 50 can have a screen dedicated to Merging and Unmerging patients, where: Merge two (or more) patient records are found to actually be the same patient, where merging patients is a matter of choosing one record to use on a go forward basis, expire duplicate records and link back to chosen record accordingly (note, one may need to evaluate and decide if any claims 12 need to be re-processed because of revisions/reconfigurations 55 related to the patient merge/unmerge); and Unmerge where it is found that a previously performed merge was in fact performed in error and the records need to be set back to their original state, involving the steps of update 55 patient record to make it active and unlink merge field and update 55 so that it accurately reflects the products and services performed for that patient (note—identify any claims 12 that may have to be re-adjudicated because of this error situation).

### Validation Module 538

This validation module 538 functionality allows the user to collect the revised/reconfigured claim 12 and/or associated hierarchy 260,360 details and submit them to the adjudication engine 40, for example. The adjudication results 13 are presented back to the user to determine if the changes 55 made resulted in the desired adjudication results.

The validation module 538 facilitates validation of the revisions/reconfigurations 55 of the hierarchies 260,360 associated with the claims 12 received from the queue 53. For example, the user can save the revisions/reconfigurations 55 done via the modules 530,532,534 and then send the claims 12 for re-adjudication to the engine 40, using the revised plan 42 incorporating the revisions/reconfigurations 55. The user can then verify or otherwise validate that the re-adjudication claim 12 results are desirable and therefore mark or otherwise flag (e.g. release) the associated revisions/reconfigurations 55 as deployed for subsequent adjudication of other claims 12 (those not in the queue 53), as desired, or can mark or otherwise flag (e.g. release) the revisions/reconfigurations 55 only for use in re-adjudication of the claims 12 obtained from the queue 53. The adjudication engine 40 will implement the revised plan 42 for the claims 12, as dictated by the marking of the revisions/reconfigurations 55.

### Benefit Module 530

Referring to FIG. 24, this sub-component or perspective within the engine 50, for example, is used to add/delete/modify the grouping of the benefits 103 appropriately into the benefit blocks 328. These blocks 328 are then included and/or excluded together to form the top level benefit super block(s) 326. The block(s) 326 for coverage type defines the list of covered benefits 103. The block(s) 326 are used for various purposes depending on its type for coverage, adjudication logic, or plan. The coverage revision type defines those benefits 103 that are being included or excluded for the specific benefit revision being validated, e.g. via the validation module 538. Each benefit 103 can be added/modified/deleted, if needed, using the functionality and modules of the engine 50 (e.g. using a business grammar that is supported by a rule evaluation adjudication engine module within the adjudication engine 40).

For example, using the module 530, the user can gain access to and revise plan details, such as but not limited to: Plan Id—Plan Name—Plan Description; Benefit Super Block—Coverage; Super Benefit Block Id—Benefit Block Name; Benefit Super Block—Plan; Super Benefit Block Id—Benefit Block Name; Benefit Super Block—Adjudication; Super Benefit Block Id—Benefit Block Name; Coverage tab, Provincial Plan information, Consultant Review requirements, and carrier 231 Alternate Coverage information; Pricing information; Year (e.g. effective/expiry dates of the plan 42; Specialty (e.g. dental, vision, drug, etc.); Province or other regional jurisdiction; Adjudication Rules via the super blocks 226; and/or Fiscal information/parameters 52.

It is recognised that for each of the accessed/revised plan details on the user interface 102, the module 530 can display the appropriate Super Block ID & Name; and associated appropriate Rule Block ID & Name. It is also recognised that the modification of the hierarchy 360 information would include changes/revisions to the references 327,329 of the benefit objects, including changes/revisions such as but not limited to: changes in the effective date of the references 327,329; changes in the expiry date of the references 327,329; changes in the benefit object version associated with the references 327,329; changes to the definition content of the benefit codes 103 and/or the benefit blocks 328; and/or inclusion or exclusion of the references 327,329 in the respective block 326,328, as well as changes to the ordering of the references 327,329 in the respective block 326,328.

For example, the module 530 can be used to revise benefits 103 within the block 328, add/delete Benefit Code(s) 103 to a Block 328, add/delete Blocks 328 to a super block 326, add/remove Benefit Code(s) 103 from a Block 326, set Expiry Date for Benefit(s) in a Block 328, Set Effective Date for Benefits 103 in a Block 328, set Expiry Date for block(s) 328 listed in a Block 326, Set Effective Date for block(s) 328 listed in a Block 326. It is recognised that, as described above, the inclusion of blocks 328 in blocks 326 and the benefits 103 in blocks 328 is coordinated in the hierarchy 360 via the listing of the references 327,329 in the appropriate blocks 326,328.

If finished, then the deployment module 538 can be used to save the modified Plan 42 and then the revised plan 42 is deployed to the database 224.

Overrides (e.g. updates/revisions 55) of references 227,229,327,329 content and other content of the hierarchies 260,360, as well as specific rules 100 and/or benefits 103 can be manual (i.e. specific only to the claim 12 or set of claims 12 being reviewed from the queue 53), can be applied to revise the deployed plan 42 so that other claims 12 other than the reviewed claims 12 of the queue 53 will be affected (i.e. their adjudication by the engine 40 will take into account any changes to the hierarchies 260,360 relevant to the other claims 12), and/or can be applied to revise the template hierarchies 260,360 used to develop the plan 42 under review (i.e. the plan 42 associated with the claim 12 or set of claims 12 being reviewed from the queue 53) so that other plans 42 other than the reviewed plan 42 will be affected (i.e. claim 12 adjudication by the engine 40 will take into account any changes to the hierarchies 260,360 of the other plans 42).

It is also recognised that related revisions 55 can be any revisions 55 using a block label that existed in the ‘old’ plan ‘and’ in the ‘revised’ plan. Un-related revisions 55 can be any revisions 55 using a block label that existed in the ‘old’ plan and NOT in the ‘revised’ plan. Benefit Coverage revisions 55 may not be identifiable in this process as they are carried over to the New Plan to remain active. The revisions 55 available for ‘re-open’ can be those that belong to the Old Plan and have the same Expiry Date as the Old Plan Expiry Date.

It is also recognised that the revisions 55 to the blocks 226,228,326,328 content, via the references 227,229,327,329 can be dated to have an revision effective and/or expiry date. Accordingly, these revisions 55 (e.g. as embodied in the references 227,229,327,329) can be considered temporary revisions 55 (e.g. overrides) as the configuration of the hierarchy 260,360 will revert back to the pre-revision 55 state when the chronological date is outside of the revision effective and/or expiry date. Further, upon accessing the information details of the reviewed plan 42 and/or template hierarchies 260,360, the engine 50 can provide for a display on the interface 102 all current and/or previous revisions 55 and their associated effective/expiry date(s), where available, to the user of the engine 50.

### Rule Module 532

It is recognised that the engine 50 may display Rule/benefit details relevant to the claim 12 obtained from the queue 53. Referring to FIG. 24, this sub-component or perspective within the engine 50, for example, is used to revise (e.g. add/modify/delete) the rules 100 that implement the actual complex business logic within the adjudication engine 40. These rules 100 are then included and/or excluded together and are grouped (via revisions 55 to the references 227) into the rule blocks 228. These blocks 228 are in turn are then included and/or excluded together and grouped (via revisions 55 to the references 229) into one or more rule super block 226, which can define the complete set of business logic to be evaluated (e.g. including order of execution of the listed blocks 228) when this specific block 226 is selected. Each rule 100 can be revise (e.g. add/modify/delete), if needed, using the functionality and modules of the engine 50 (e.g. using a business grammar that is supported by a rule evaluation adjudication engine module within the adjudication engine 40).

For example, using the module 530, the user can gain access to and revise plan details, such as but not limited to: Plan Id—Plan Name—Plan Description; Benefit Super Block—Coverage; Super Benefit Block Id—Benefit Block Name; Benefit Super Block—Plan; Super Benefit Block Id—Benefit Block Name; Benefit Super Block—Adjudication; Super Benefit Block Id—Benefit Block Name; Coverage tab, Provincial Plan information, Consultant Review requirements, and carrier 231 Alternate Coverage information; Pricing information; Year (e.g. effective/expiry dates of the plan 42; Specialty (e.g. dental, vision, drug, etc.); Province or other regional jurisdiction; Adjudication Rules via the super blocks 226; and/or Fiscal information/parameters 52.

It is recognised that for each of the accessed and revised plan details on the user interface 102, the module 530 can display the appropriate Super Block ID & Name; and associated appropriate Rule Block ID & Name. It is also recognised that the modification of the hierarchy 260 information would include changes to the references 227,229 of the benefit objects, including changes/revisions such as but not limited to: changes in the effective date of the references 227,229; changes in the expiry date of the references 227,229; changes in the benefit object version associated with the references 227,229; changes to the definition content of the rules 100 and/or the benefit blocks 228 (e.g. selecting specific versions 300 of the rule objects—e.g. rules 100); and/or inclusion or exclusion of the references 227,229 in the respective block 226,228, as well as changes to the ordering of the references 227,229 in the respective block 226,228.

For example, the module 532 can be used to revise rules 100 within the block 228, add/delete rules 100 to a Block 228, add/delete Blocks 228 to a super block 226, add/remove rules 100 from a Block 226, set Expiry Date for rules 100 in a Block 228, Set Effective Date for rules 100 in a Block 228, set Expiry Date for block(s) 228 listed in a Block 226, Set Effective Date for block(s) 228 listed in a Block 226, and add/delete versions 300 of the rule objects in the corresponding blocks 226,228. It is recognised that, as described above, the inclusion of blocks 228 in blocks 226 and the rules 100 in blocks 228 is coordinated in the hierarchy 260 via the listing of the references 227,229 in the appropriate blocks 226,228.

If finished, then the deployment module 438 can be used to save the modified Plan 42 and then the saved plan 42 is deployed to the database 224.

### Parameter Module 534

Referring to FIG. 24, this sub-component or perspective within the engine 50, for example, is used to revise (e.g. add/delete/modify) or otherwise redefine the parameterized values 52 used within rules 100 and benefits 103, as well as the references 227,229,327,329 where appropriate. This revision 55 of the parameters 52 provides for a generic set of rules 100/benefits 103 to be defined (e.g. the template hierarchies 260,360) and then reused with different specific values 52 that are assigned/associated for plan 42 revision, in view of claims 12 obtained from the queue 53.

### Example Revisions 55 to Plan 42 Content

The engine 50 will display on the user interface 102 details of (e.g. parameters 52, claim data, and/or related portions of the hierarchies 260,360): Date of Service; Tooth Code; Submitted Procedure Code; Tooth Surfaces; Professional Fee Claimed Amount; Professional Lab1 Claimed Amount; Professional Lab 2 Claimed Amount; Eligible Fee Claimed Amount; Eligible Lab1 Claimed Amount; Eligible Lab 2 Claimed Amount; Deductible; Coinsurance; Benefit Fee Claimed Amount; Benefit Lab1 Claimed Amount; Benefit Lab 2 Claimed Amount; Adjudicated Procedure Code; Pay as Procedure Code; Claimed Units; Paid Units; COB$?; and Proc Type.

As discussed above in relation to the modules 530,532,534, the engine 50 can facilitate revision/reconfiguration 55 to the following example fields (e.g. associated parameters and structured of the hierarchies 260,360); Date of Service; anatomy/product (e.g. tooth) Code; Submitted product/Procedure Code; Paid product/Procedure Code; Professional Fee Claimed Amount; Professional Lab1 Claimed Amount; Professional Lab 2 Claimed Amount;

### Electronic Device 101

Referring to FIG. 13, a generic electronic device 101 can include input devices 102, such as a keyboard, microphone, mouse and/or touch screen by which the user interacts with the visual interface 102. It will also be appreciated that the engine 40, 44, 50, 200 resides on an electronic device 101, for example as separate devices 101 for the engine 40 and the engine 200, and/or the engine 44, for example. A processor 150 can co-ordinate through applicable software (e.g. the engines 40, 44, 50, 200) the entry of data and requests into the memory 124,224, 528 and then display the results on a screen 152. A storage medium 46 can also be connected to device 101, wherein software instructions and/or member data is stored for use by the engine 40, 44, 5, 200. As shown, the device 101 also includes a network connection interface 154 for communicating over the network 11 with other components of the environment 10 (see FIG. 1), e.g. the engine 200 can communicate to the database 224, the engine 40 can communicate with the database 224, the engine 50 can communicate with the database 224, the engine 44 can communicate with the database 224, and the engines 40, 44, 50, 200 can communicate with one another.

The stored instructions on the memory 124 (for example the modules of the respective engine 40, 44, 50, 200) can comprise code and/or machine readable instructions for implementing predetermined functions/operations including those of an operating system, the engine 40, 44, 50, 200 configuration, or other information processing system, for example, in response to commands or inputs provided by a user of the engine 40, 44, 50, 200. The processor 150 (also referred to as module(s) for specific components of the engines 40, 44, 50, 200) as used herein is a configured device and/or set of machine-readable instructions for performing operations as described by example above.

As used herein, the processor/modules in general may comprise any one or combination of, hardware, firmware, and/or software. The processor/modules act upon information by manipulating, analyzing, modifying, converting or transmitting information for use by an executable procedure or an information device, and/or by routing the information with respect to an output device. The processor/modules may use or comprise the capabilities of a controller or microprocessor, for example. Accordingly, any of the functionality provided by the systems and processes of FIGS. 1-26 may be implemented in hardware, software or a combination of both. Accordingly, the use of a processor/modules as a device and/or as a set of machine readable instructions is hereafter referred to generically as a processor/module for sake of simplicity.

It will be understood by a person skilled in the art that the memory 124,224,528 storage described herein is the place where data is held in an electromagnetic or optical form for access by a computer processor. In one embodiment, storage 124,224,528 means the devices and data connected to the computer through input/output operations such as hard disk and tape systems and other forms of storage not including computer memory and other in-computer storage. In a second embodiment, in a more formal usage, storage 124,224,528 is divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be much faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

Referring to FIG. 13, the engines 40, 44, 50, 200 reside on and are implemented by one or more generic electronic devices 101. Generic device 101 may be a server that makes available the engine 40, 44, 50, 200 to the user over the network 11. As known, device 101 may include input devices 102, such as a keyboard, microphone, mouse and/or touch screen by which the user of the engine 40, 44, 50, 200 interacts with the engine 40, 44, 50, 200 via the visual interface 102. A processor 152 can co-ordinate through applicable software the entry of data and requests into the memory 124,224 and then display/present the results on a screen as visual representation 102,152. Further, it is recognised that the visual representation 102,152 (e.g. the hierarchies 260,360) can be presented (as a result of operation of the engine 40, 44, 50, 200) to the user on their client (e.g. of the engine 40, 44, 50, 200 implemented on a networked server) electronic device 101 via the network 11. A storage medium 46 can also be connected to device 101, wherein software instructions, applications 14, member data, and other data is stored for use by the engine 40, 44, 50, 200, for execution by the respective processor(s) 150.

The software instructions may comprise code and/or machine readable instructions for implementing predetermined functions/operations including those of an operating system, the engine 40, 44, 50, 200, or other information processing system, for example, in response to commands or inputs provided by a user and/or the provider of the engine 40, 44, 50, 200. The processor 150 (also referred to as module(s) for specific components of the engine 40,44,200) as used herein is a configured device and/or set of machine-readable instructions for performing operations as described by example above. Some or all of the modules of the engine 40, 44, 50, 200 may be distributed across a network as applications or reside on the electronic device 101. As is understood, some or all of the modules of the engine 40, 44, 50, 200 may also be downloadable to the electronic device 101.

As used throughout, the processor/modules on the device 101 of the engine 40, 44, 50, 200 in general may comprise any one or combination of, hardware, firmware, and/or software. The processor/modules act upon information by manipulating, analyzing, modifying, converting or transmitting information for use by an executable procedure or an information device, and/or by routing the information with respect to an output device. The processor/modules may use or comprise the capabilities of a controller or microprocessor, for example. Accordingly, any of the functionality provided by the systems and processes of FIGS. 1-26 may be implemented in hardware, software or a combination of both. Accordingly, the use of a processor/modules as a device and/or as a set of machine readable instructions is referred to generically as a processor/module for sake of simplicity.

### Database 224

A database or tables 224 is a further embodiment of memory as a collection of information that is organized so that it can easily be accessed, managed, and updated. In one view, databases can be classified according to types of content: bibliographic, full-text, numeric, and images. In computing, databases are sometimes classified according to their organizational approach. As well, a relational database is a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Computer databases 224 typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory storage is the electronic holding place for instructions and data that the computer's microprocessor 150 can reach. When the computer 101 is in normal operation, its memory 124,224 usually contains the main parts of the operating system and some or all of the application programs and related data that are being used. Memory is often used as a shorter synonym for random access memory (RAM). This kind of memory is located on one or more microchips that are physically close to the microprocessor in the computer.

### Example Operation of the Adjudication Engine 40

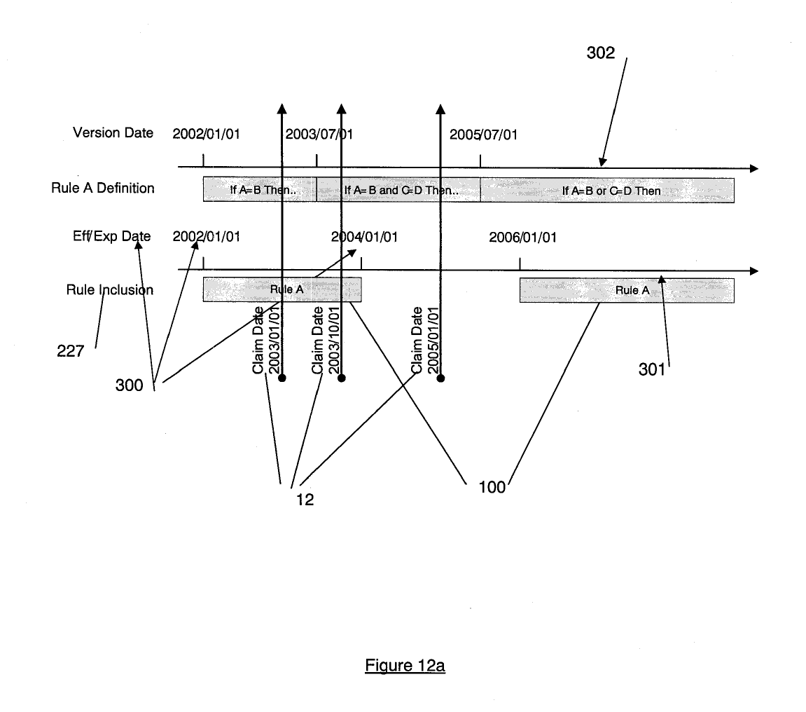

Referring to FIG. 14, shown is an example operation 350 of the adjudication engine 40 for processing insurance claims 12 using a set of adjudication rules. At step 352, the adjudication engine 40 receives the claim 12 for processing, the received claim 12 having claim content including a claim date. At step 354, the adjudication engine accesses the set of adjudication rules in the database 224 appropriate to the content of the received claim 12. The set of adjudication rules is structured in a plurality of containers including a primary rule container 226 and a plurality of secondary rule containers 228, each of the plurality of secondary rule containers 228 being coupled to the primary rule container 226 by a respective container reference 229. Each of the plurality of secondary rule containers 228 contains one or more adjudication rules 100 adapted for processing the claim content of the received claim 12, such that each of the one or more adjudication rules 100 is coupled to their respective secondary container 228 by their respective rule reference 227, wherein the set of adjudication rules defines the rule hierarchy 260. At step 356, the adjudication engine 40 processes the content of the received claim 12 with the one or more adjudication rules 100 facilitated by an execution order defined by the ordering of the container references 229 in the primary rule container 226. At step 358, the result of the processed claim is used to determine subsequent settlement of the received claim 12.

It is recognised in step 356, the processing of the claim content can include accessing a set of benefit codes 103 appropriate to the received claim 12, such that the set of benefit codes 103n is structured in a plurality of benefit containers including a primary benefit container 326 and a plurality of secondary benefit containers 328. Each of the plurality of secondary benefit containers 328 is coupled to the primary benefit container 326 by their respective benefit container reference 329. Each of the plurality of secondary benefit containers 328 contains one or more benefit codes 103 adapted for processing the claim content of the received claim 12, such that each of the one or more benefit codes 103 is coupled to their respective secondary benefit container 328 by their respective benefit reference 327, wherein the set of benefit codes 103 defines the benefit hierarchy 360.

It is also recognised that an optional step is 360 is comparing the claim date to the effective date(s) and/or expiry date(s) of the container references 227,229,327,329, in order to determine if the respective secondary rule containers 228 are part of the set of adjudication rules for use in processing the received claim 12, such that the non-matching dates exclude the respective secondary rule container 228 from being included in the execution order. As well, part of the optional step can include comparing the claim date to the effective date(s) and/or expiry date(s) of the container references 227,229,327,329, in order to determine if the respective rules 100 are part of the set of adjudication rules for use in processing the received claim 12, such that the non-matching dates exclude the respective rules 228 from being included in the execution order of their secondary containers 228. It is recognised that similar comparisons can be done for the inclusion/exclusion decision making for the benefit codes 103 and the secondary benefit containers 328, as desired.

### Example Operation of the Composer Engine 200

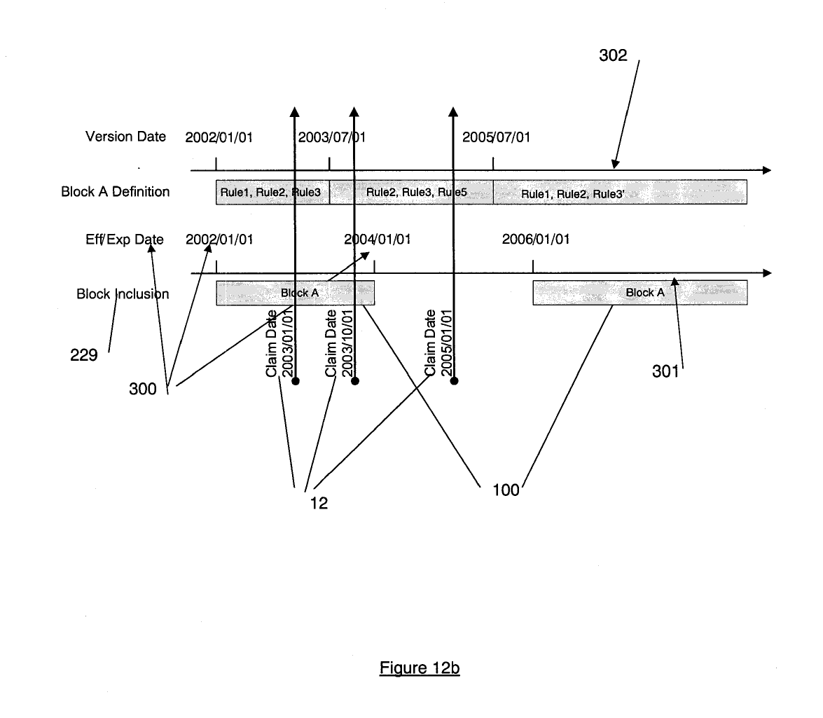

Referring to FIG. 15, shown is an example operation 370 of the composer engine 200 for generating a set of adjudication rules for use in processing an insurance claim, the set of adjudication rules representing the hierarchy 260. At step 372, defining adjudication rule(s) 100. At step 374, defining a secondary rule container 228 and coupling the adjudication rule 100 to the secondary rule container 228 by a rule reference 227 associated with the content of the secondary rule container 228. At step 376, defining a primary rule container 226 and coupling the secondary rule container 228 to the primary rule container 226 by a container reference 229 associated with the content of the primary rule container 226, such that the adjudication rule 100, the containers 226,228, and the rule and container references 227,229 defining the rule hierarchy 260 for representing the set of adjudication rules. At step 378, storing the set of adjudication rules in the memory 124,224; wherein the set of adjudication rules is configured to facilitate the processing of content of the insurance claim 12 with the adjudication rule by an execution order defined by the ordering of the container reference 229 in the primary rule container 226. At step 380, adding parameter values to the adjudication rules. It is recognised that similar steps can be done to the above, in order to include benefit codes in a benefit hierarchy 360 linked 240 to the rules 100, as described by example above.

### Example Operation of the Plan Engine 44

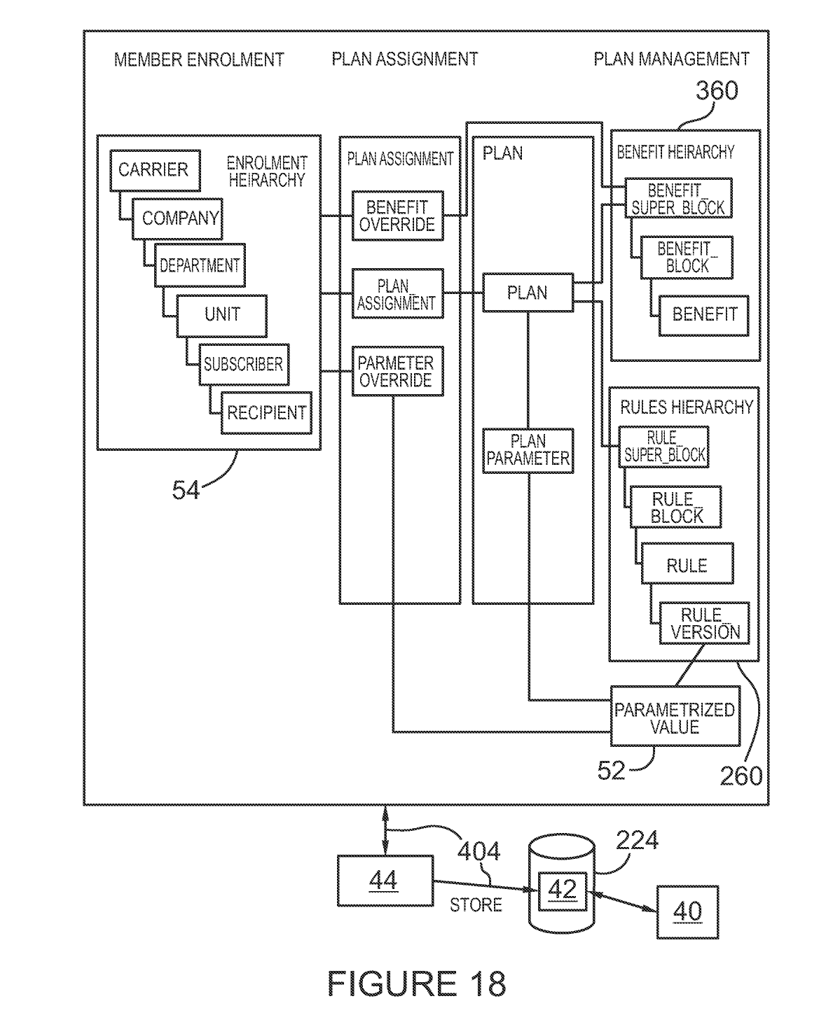

Referring to FIG. 21, operation 361 of the plan engine 44 is shown, for modifying benefit coverage including a plurality of benefit codes 103 of an insurance plan 42, such that the insurance plan 42 is for use in adjudicating one or more insurance claims 12 by the adjudication engine 40. At step 362, the engine 44 accesses a set of benefit codes 103 structured in a plurality of benefit containers 326,328 including a primary benefit container 326 and a plurality of secondary benefit containers 328, each of the plurality of secondary benefit containers 328 being coupled to the primary benefit container 326 by a respective benefit container reference 329, each of the plurality of secondary benefit containers 328 containing one or more benefit codes 103 adapted for processing a claim content of the one or more insurance claims 12, each of the one or more benefit codes 103 being coupled to their respective secondary benefit container 328 by a respective benefit reference 327, the set of benefit codes 103 defining a benefit hierarchy 360. At step 364, the engine 44 selects the primary benefit container 326 for inclusion in the insurance plan 42. At step 366, the benefit module modifies the benefit hierarchy 360 by performing at least one of adding an additional benefit container reference 329 to the primary benefit container 326, modifying a container benefit parameter 52 of at least one of the benefit container references 329, or deleting at least one of the existing benefit container references 329. At step 368, the deployment module 438 stores the modified insurance plan 42 in the memory 224; wherein the stored modified insurance plan 42 is adapted for subsequent use in adjunction of appropriate insurance claims 12 received by the adjudication system 18.

It is recognised that step 366 can be substituted instead for accessing a set of adjudication rules structured in a plurality of containers including a primary rule container 226 and a plurality of secondary rule containers 228, each of the plurality of secondary rule containers 228 being coupled to the primary rule container 226 by a respective container reference 229, each of the plurality of secondary rule containers 228 containing one or more adjudication rules 100 adapted for processing the claim content of the received claim 12, each of the one or more adjudication rules 100 being coupled to their respective secondary container 228 by a respective rule reference 227, the set of adjudication rules defining the rule hierarchy 260.

It is recognised that step 366 can be substituted instead for selecting the primary rule container 226 for inclusion in the insurance plan 42, modifying the rule hierarchy 260 by performing at least one of adding an additional rule container reference 229 to the primary rule container 226, modifying a rule container parameter 52 of at least one of the rule container references 229, or deleting at least one of the existing rule container references 229.

It is recognised that step 366 can be substituted instead for modifying the benefit hierarchy 360 by performing at least one of adding an additional benefit reference 327 to at least one of the secondary benefit containers 328, modifying a benefit reference parameter 52 of at least one of the benefit references 327, or deleting at least one of the existing benefit references 327.

In view of the above, it is recognised that modification of the plan 42 can include any modifications to any of the references 227,229,327,329 (either existing or added or deleted) in any order (i.e. blocks 228,328 content is modified before blocks 226,326 content is modified, blocks 226,228 content is modified before blocks 326,328 content is modified, blocks 326,328 content is modified before blocks 226,228 content is modified, etc.).

### Example Operation of the Reconfiguration/Review Engine 50

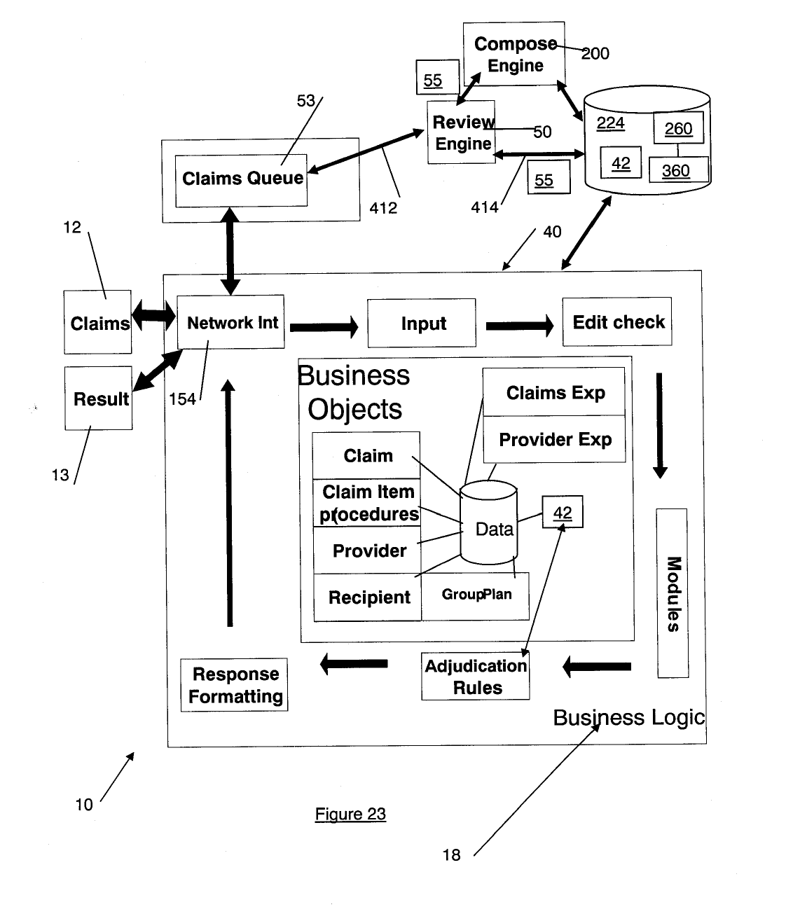

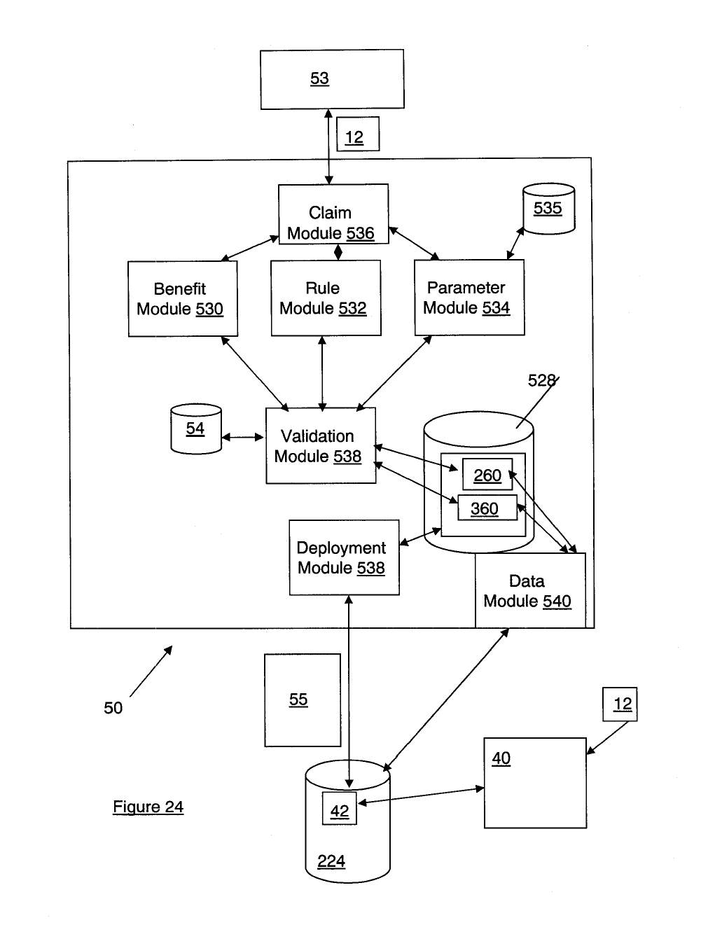

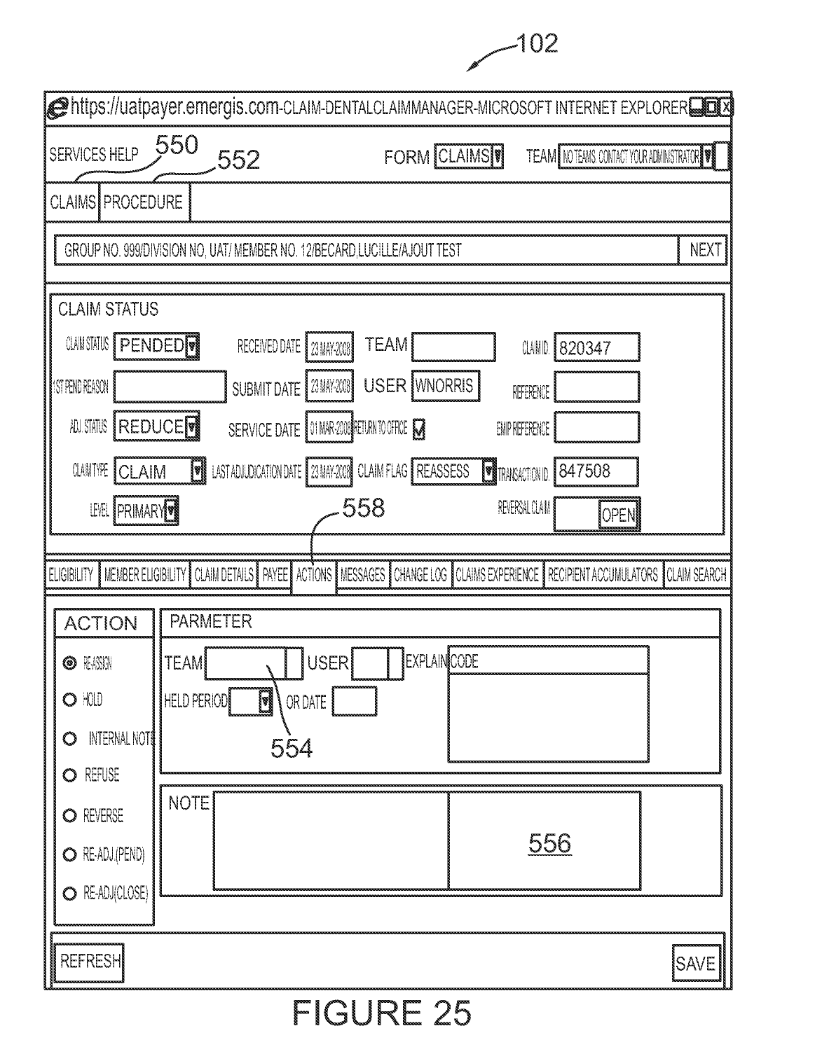

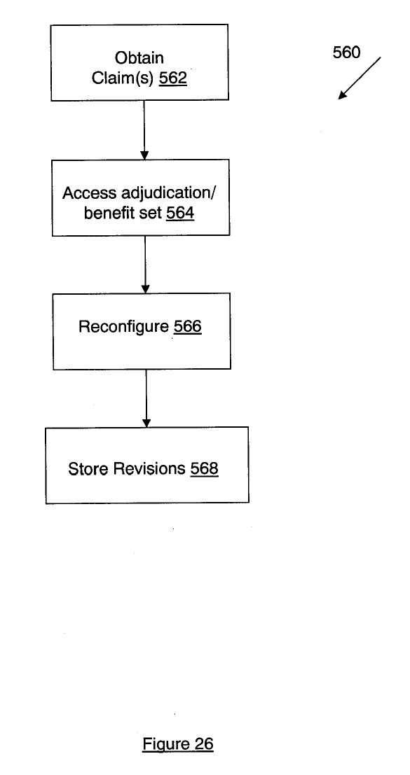

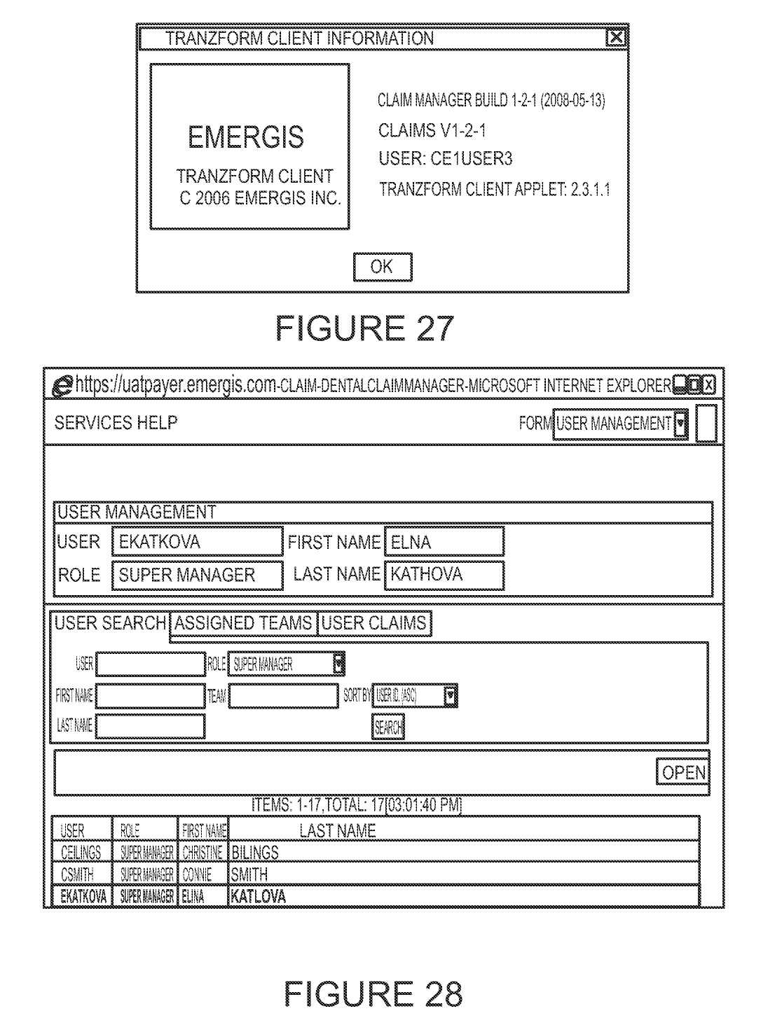

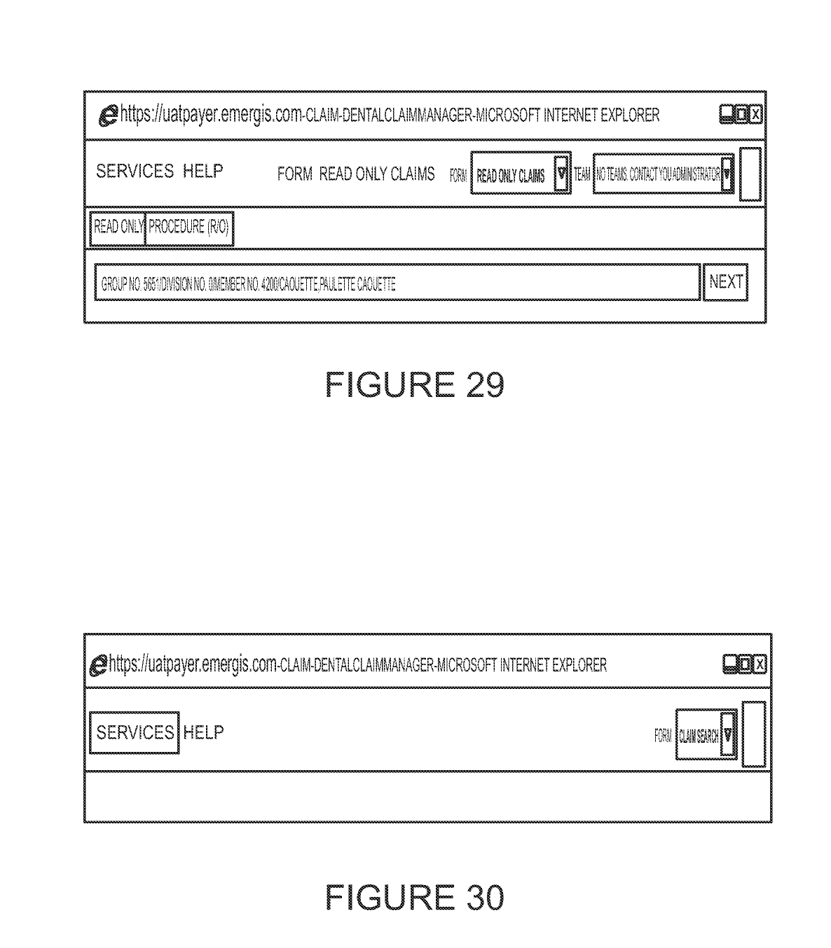

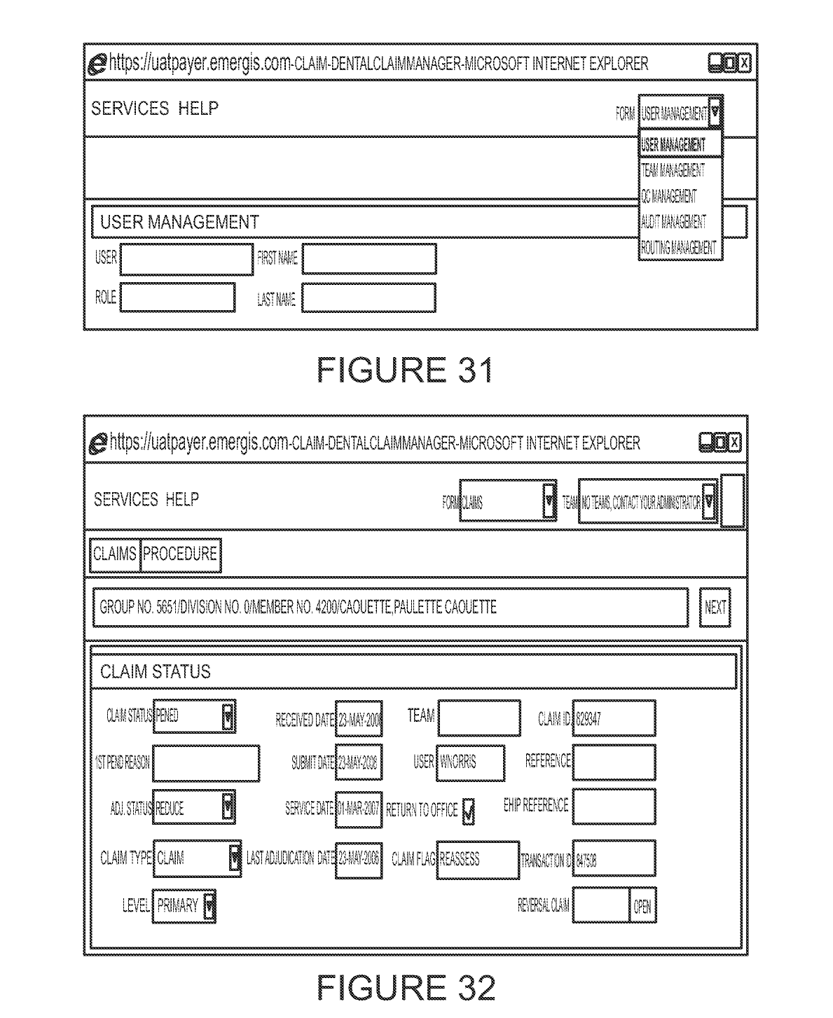

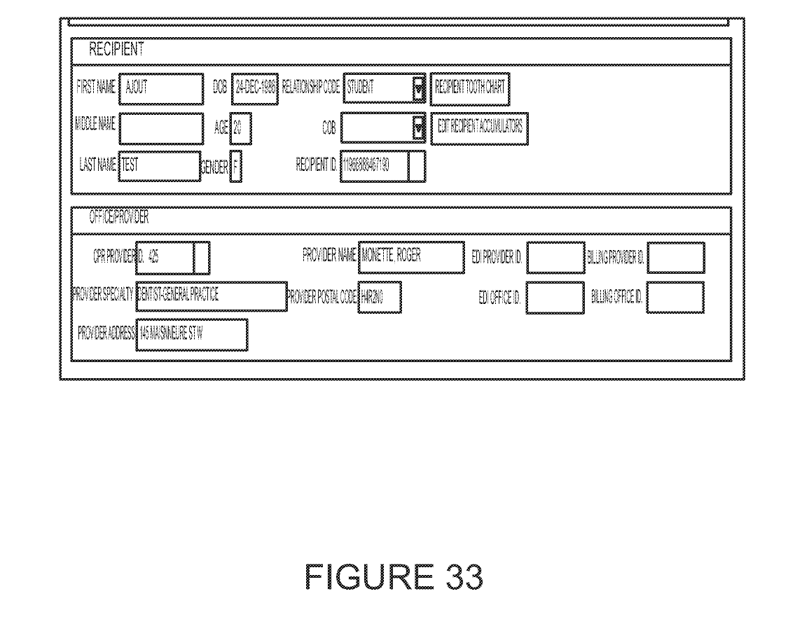

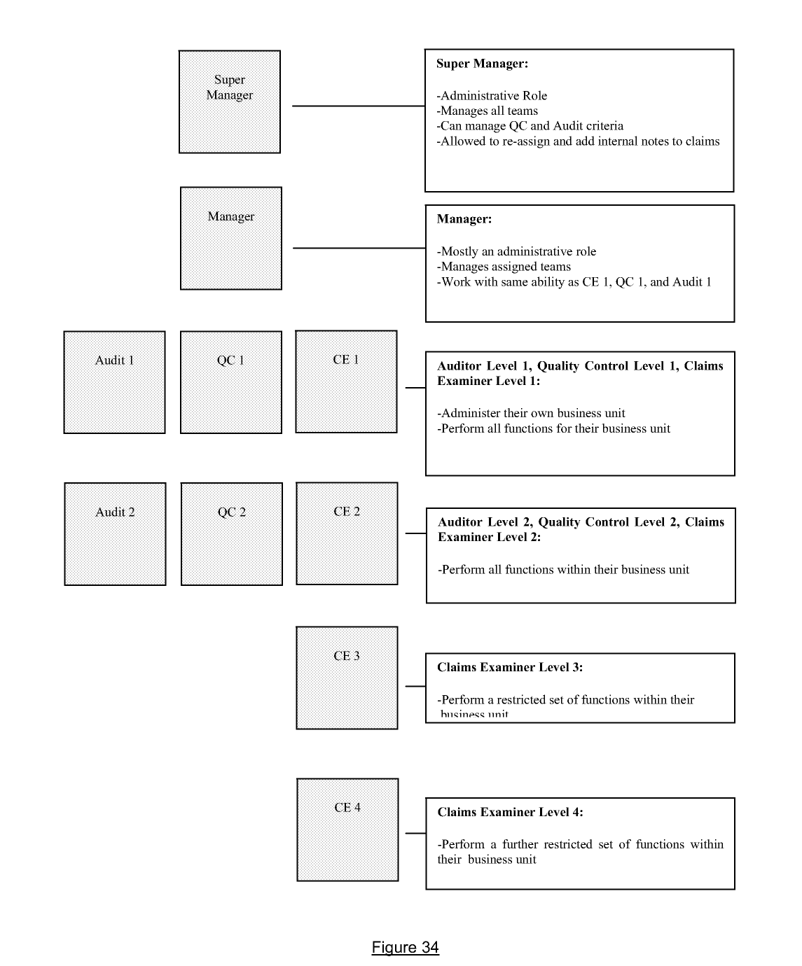

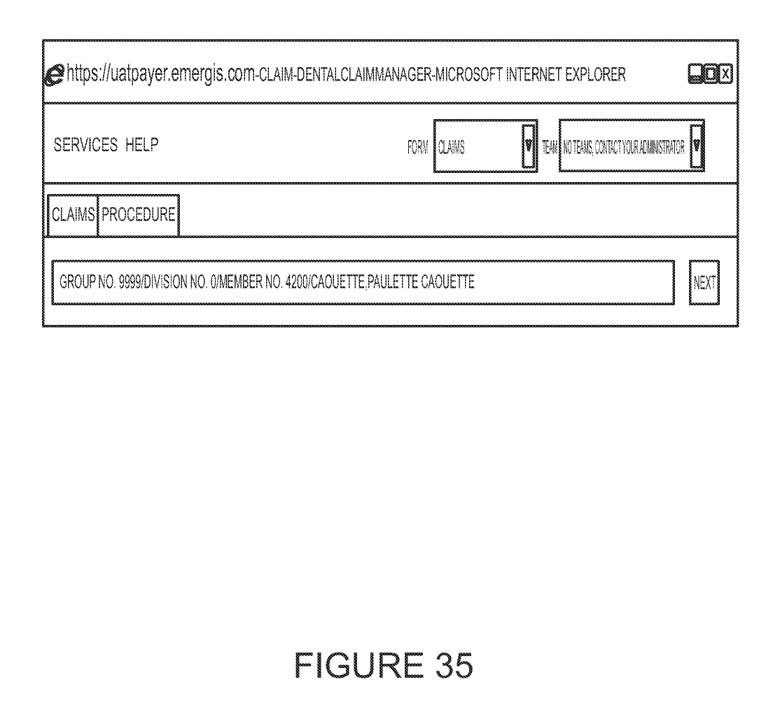

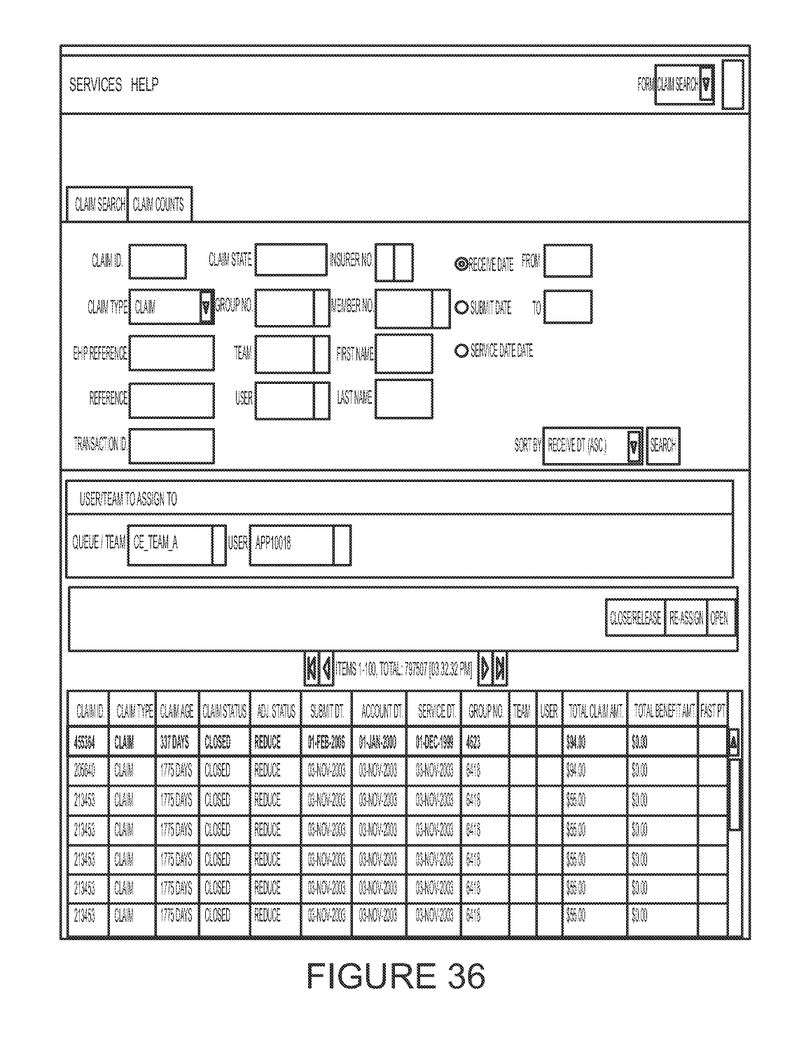

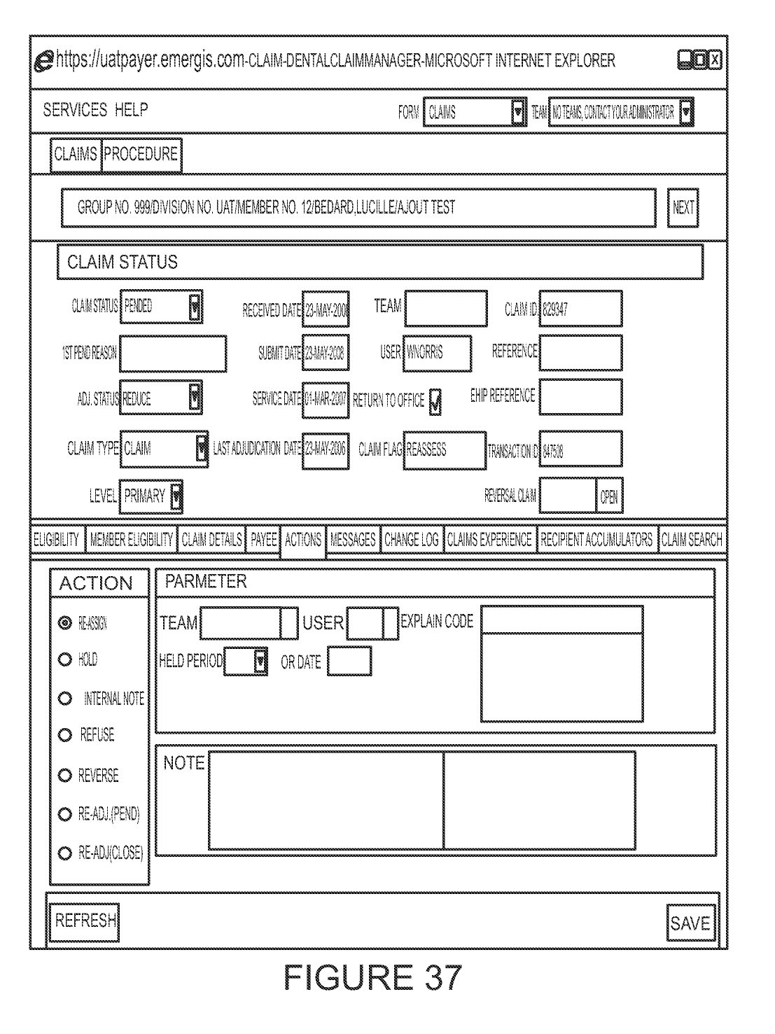

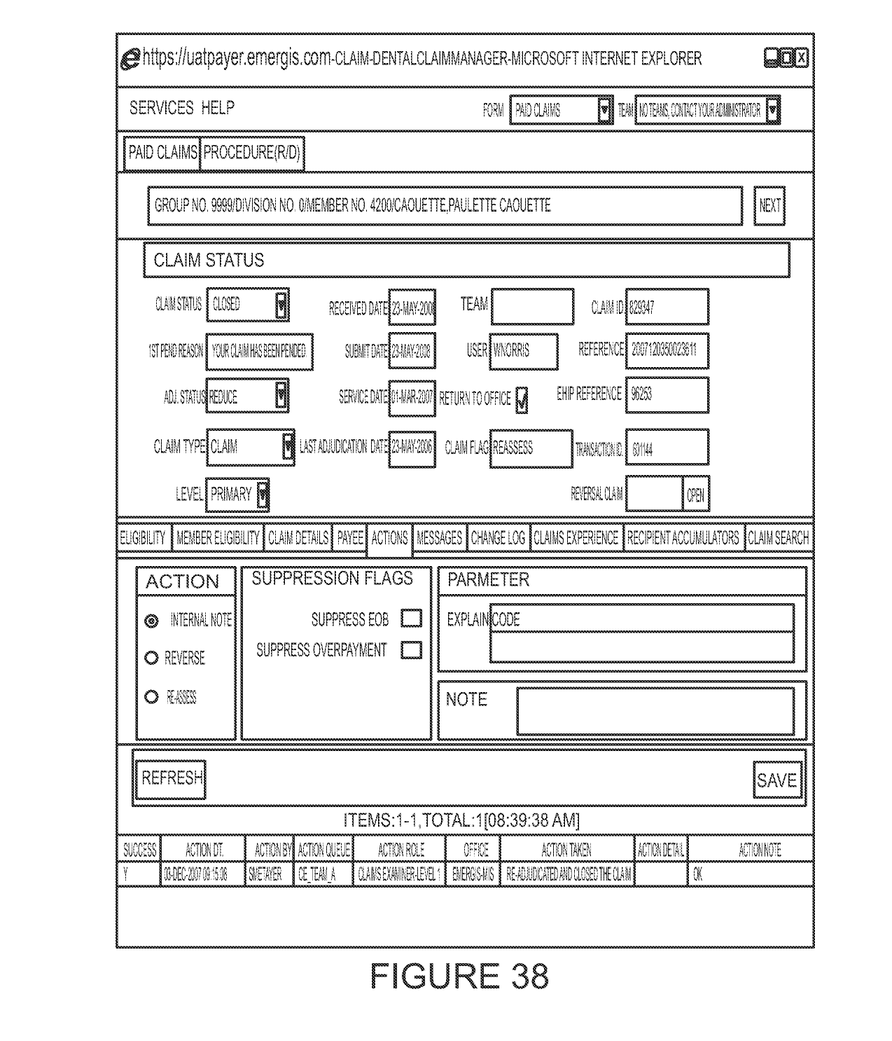

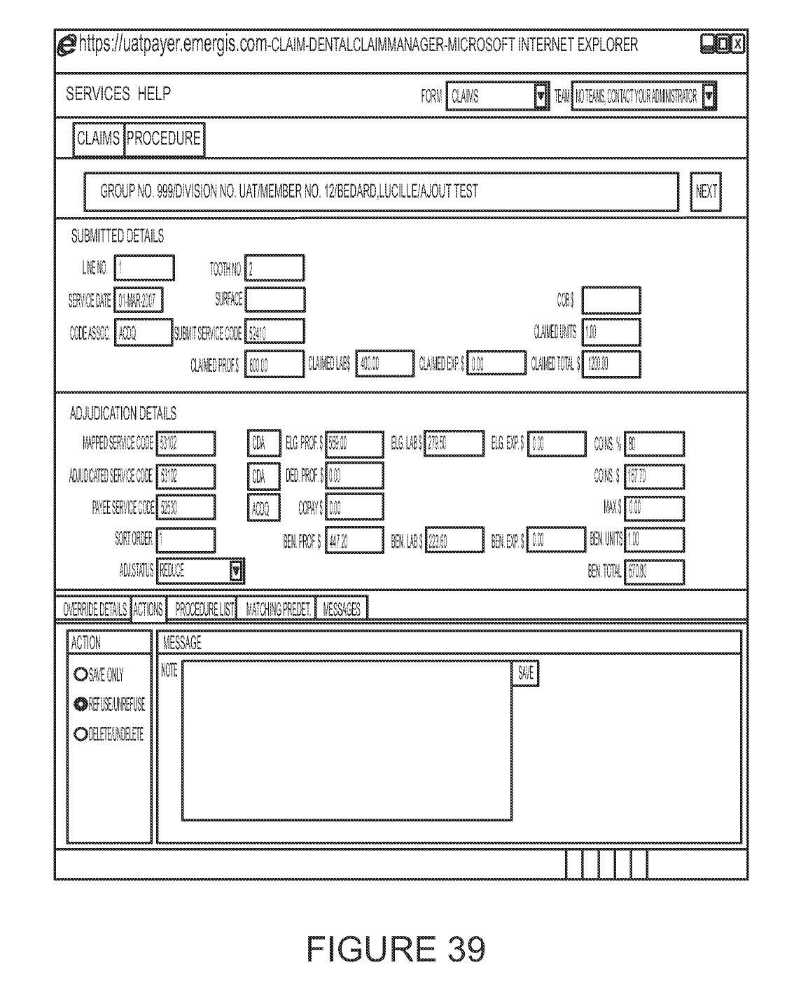

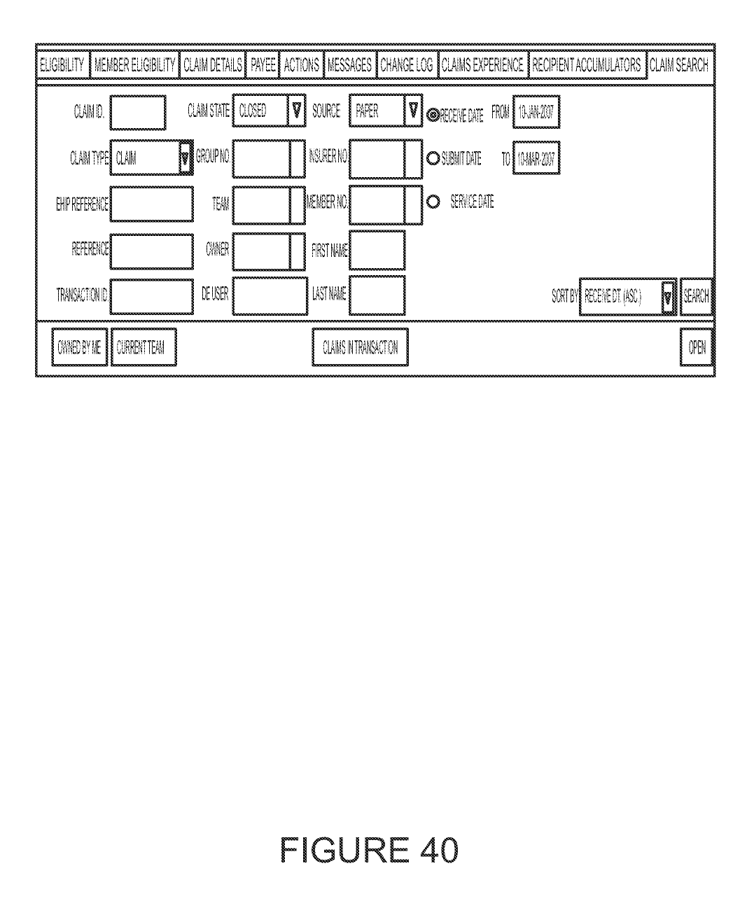

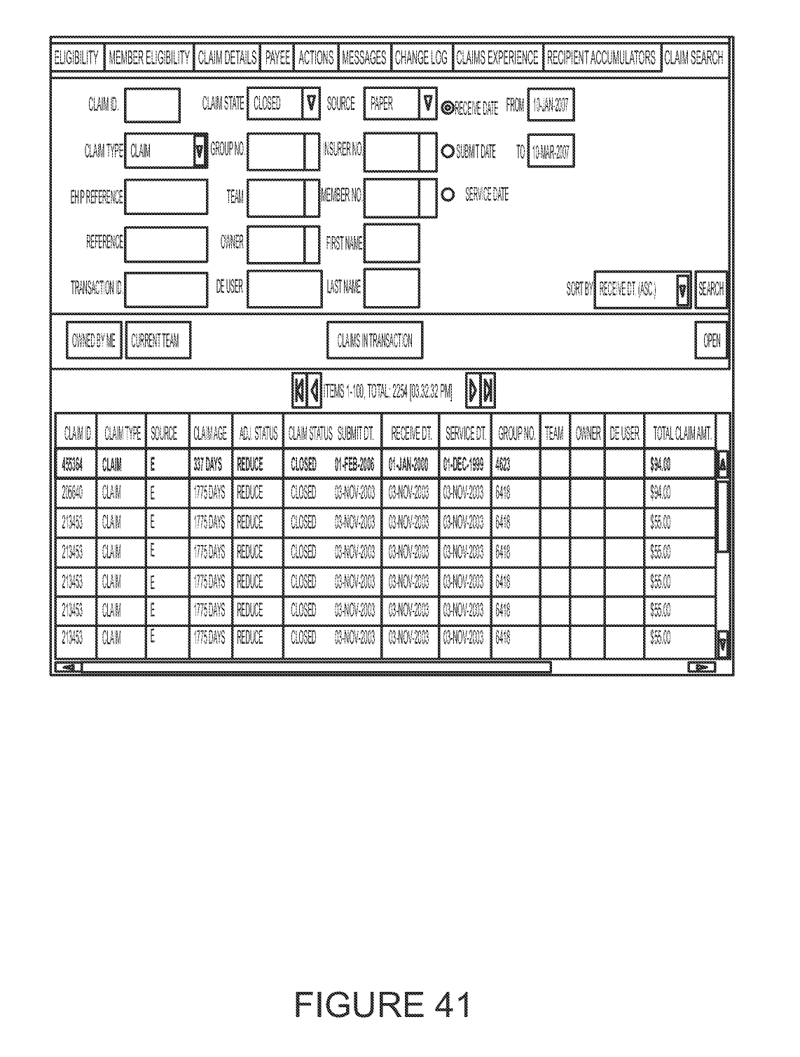

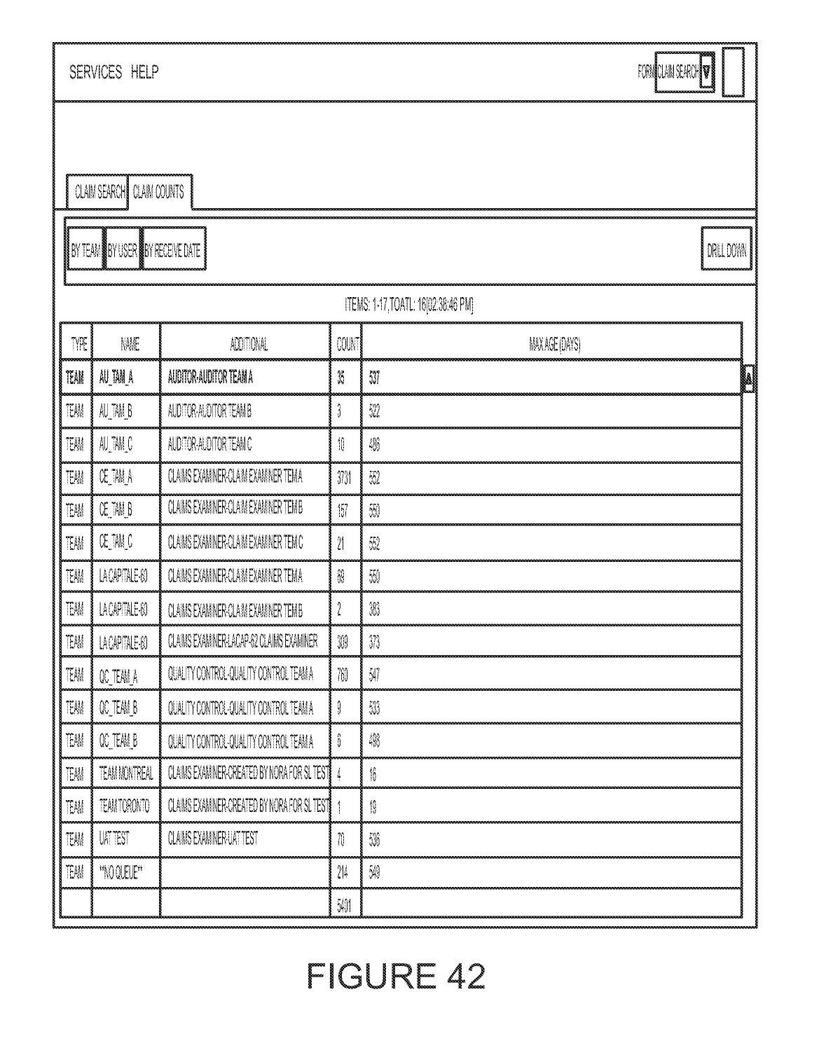

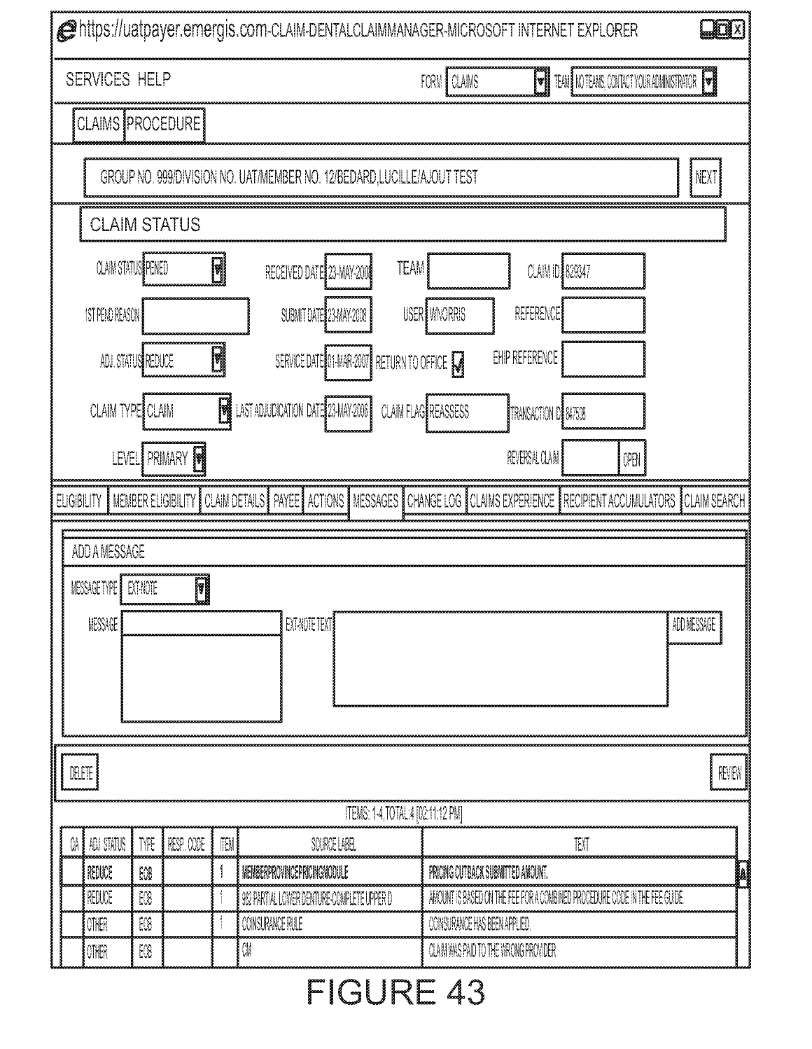

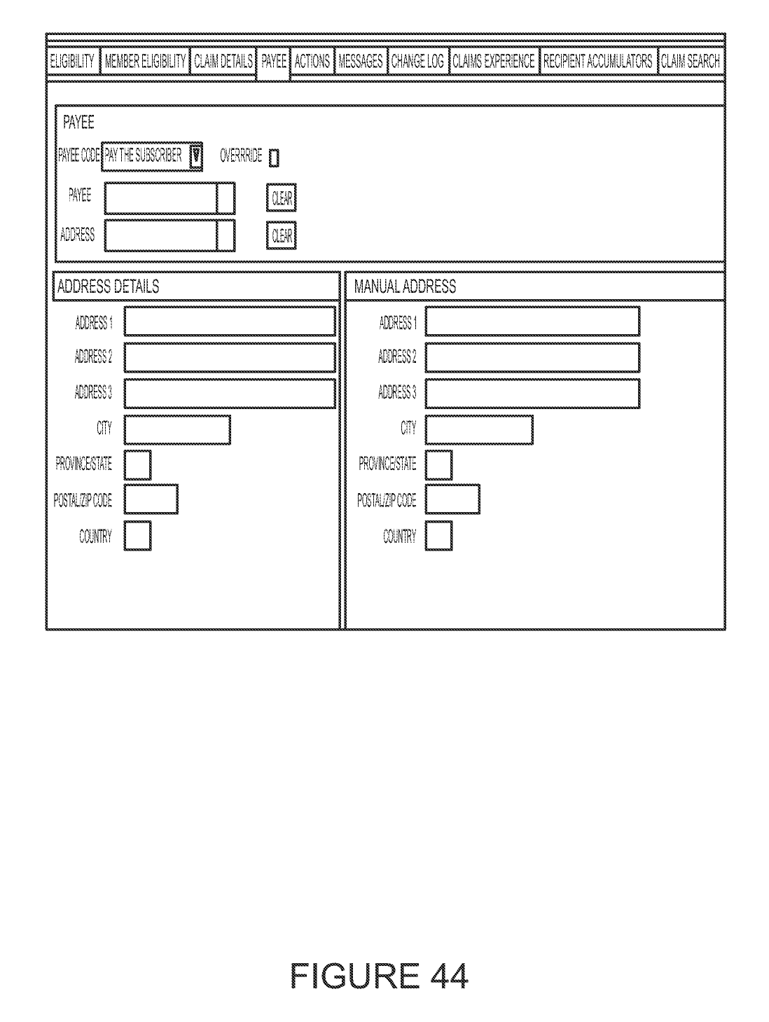

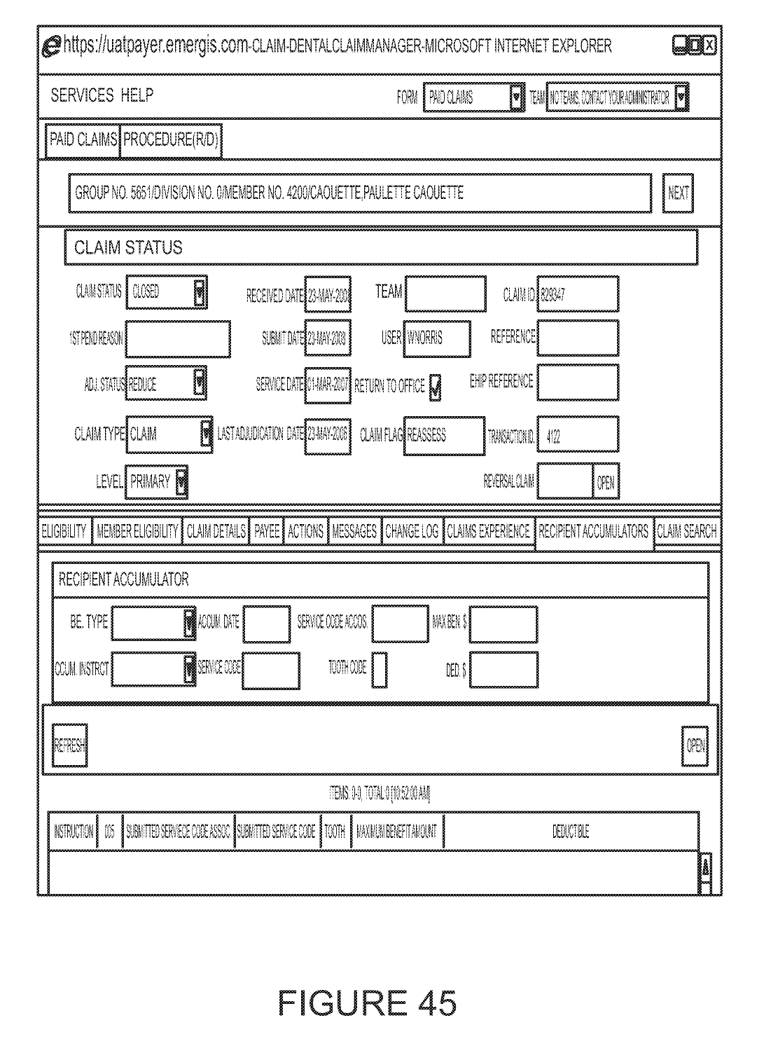

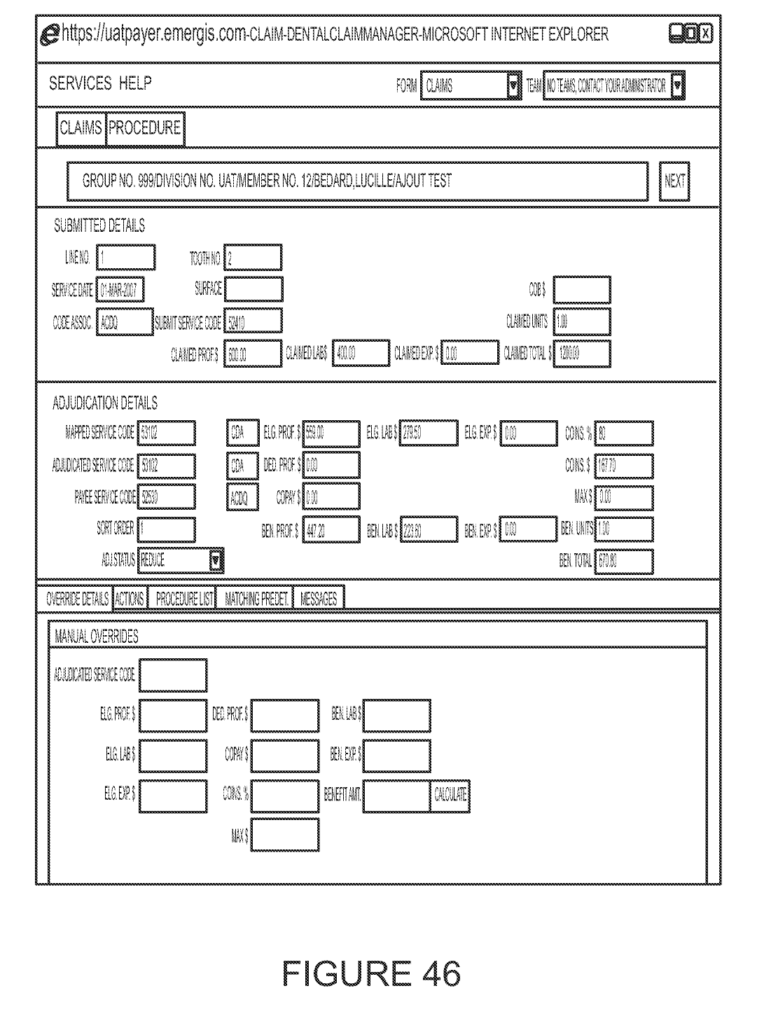

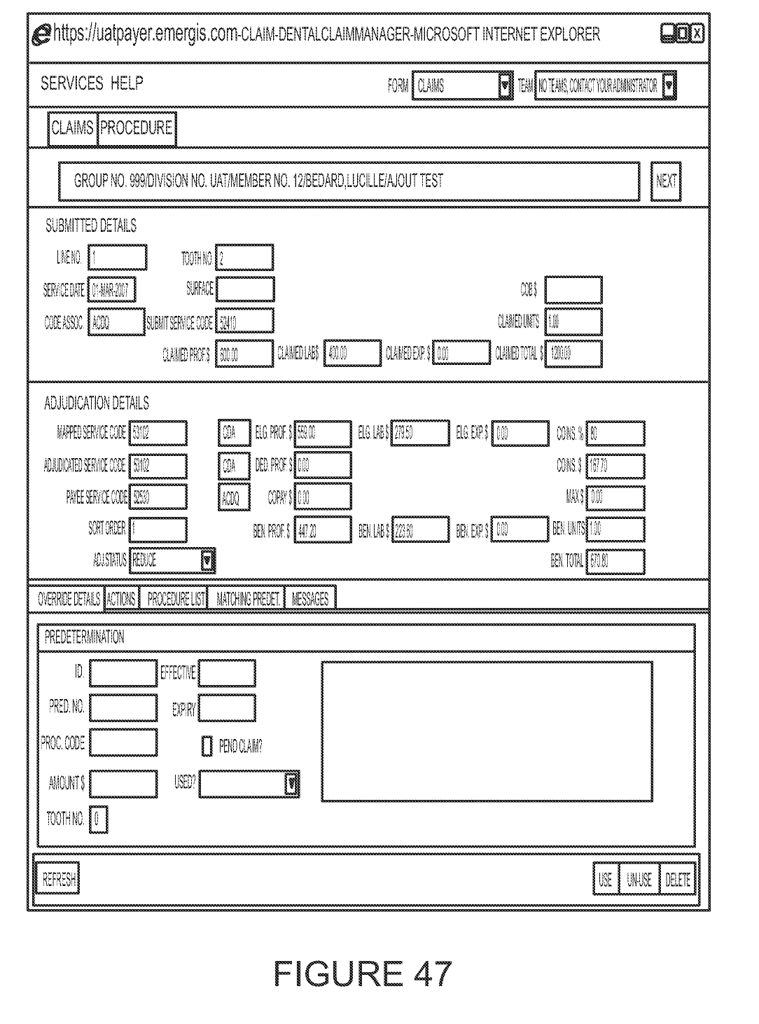

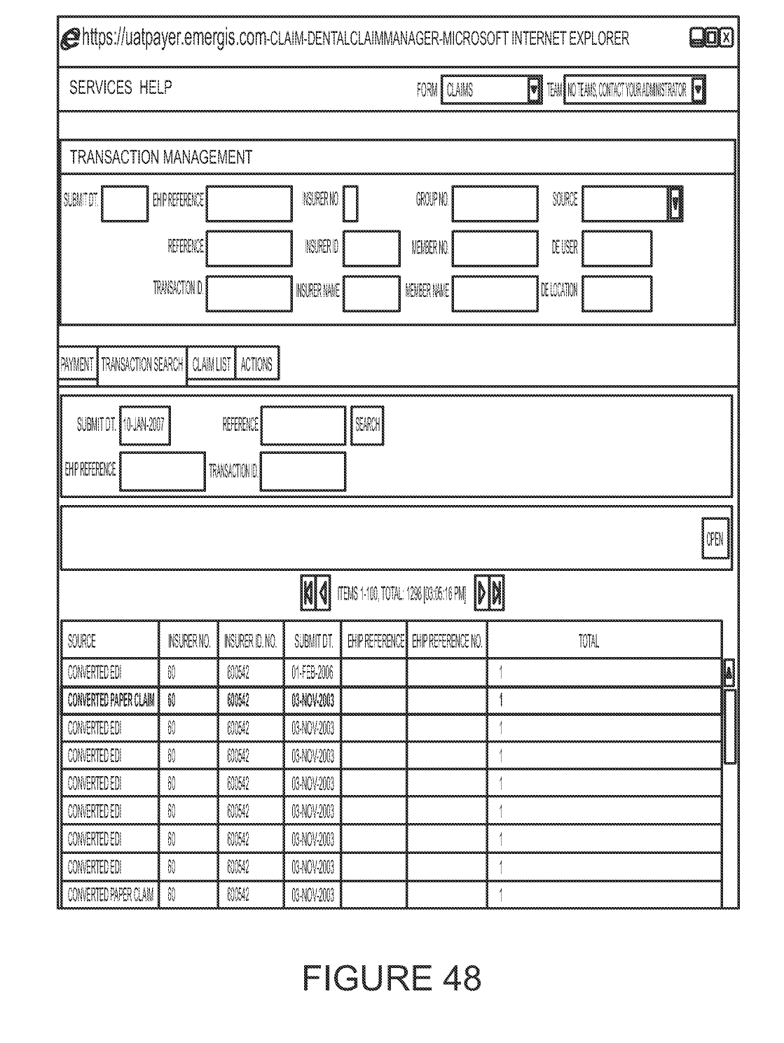

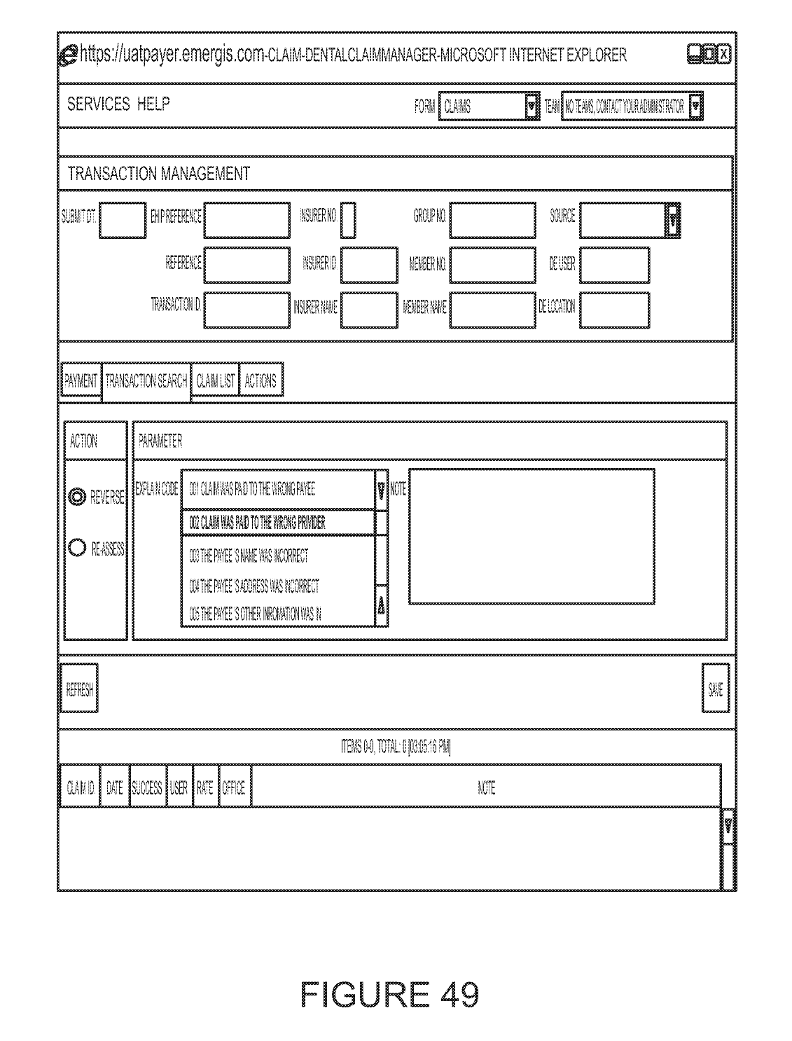

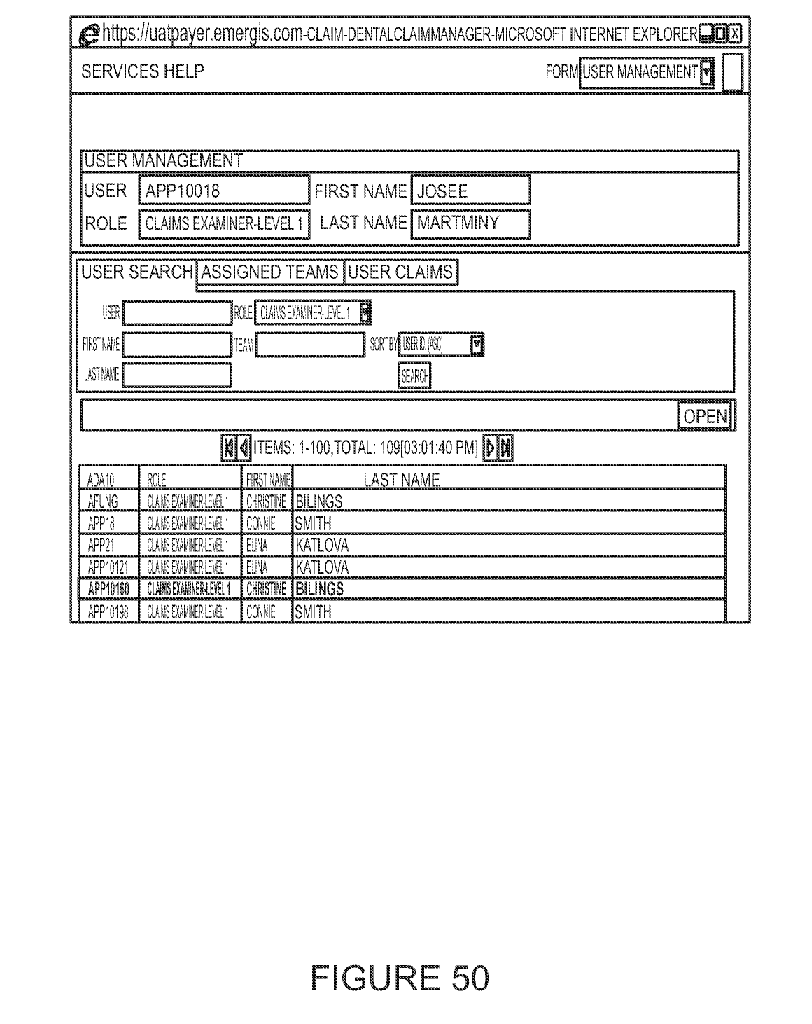

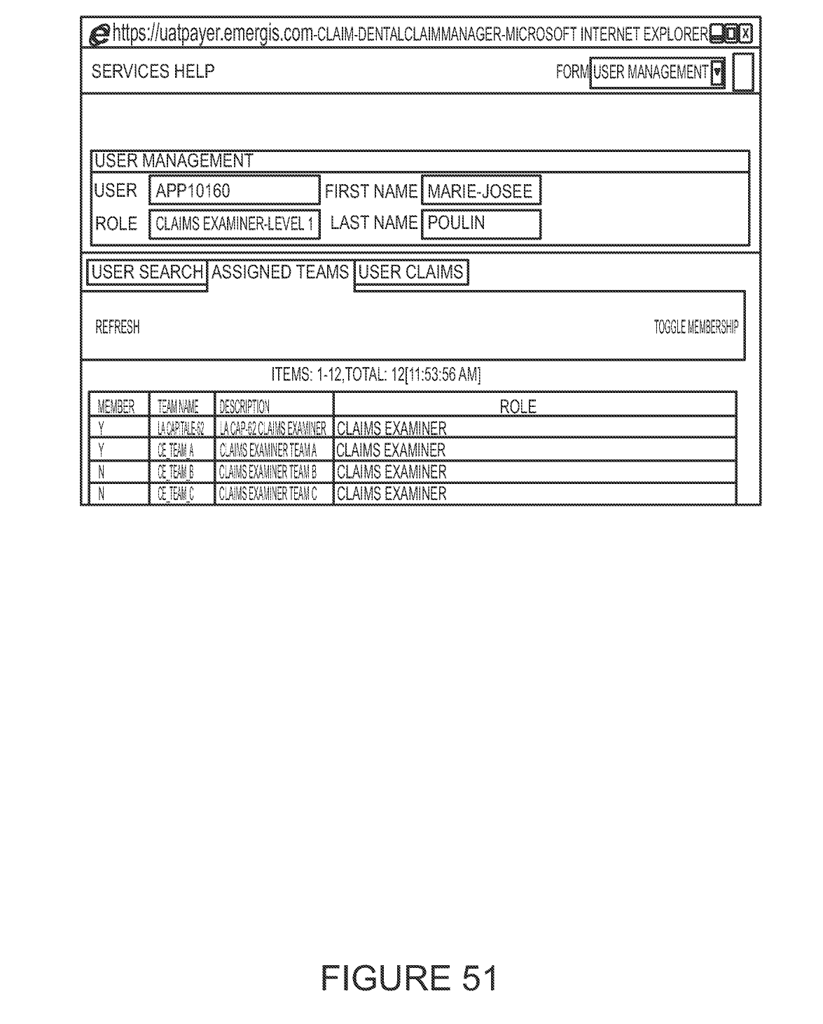

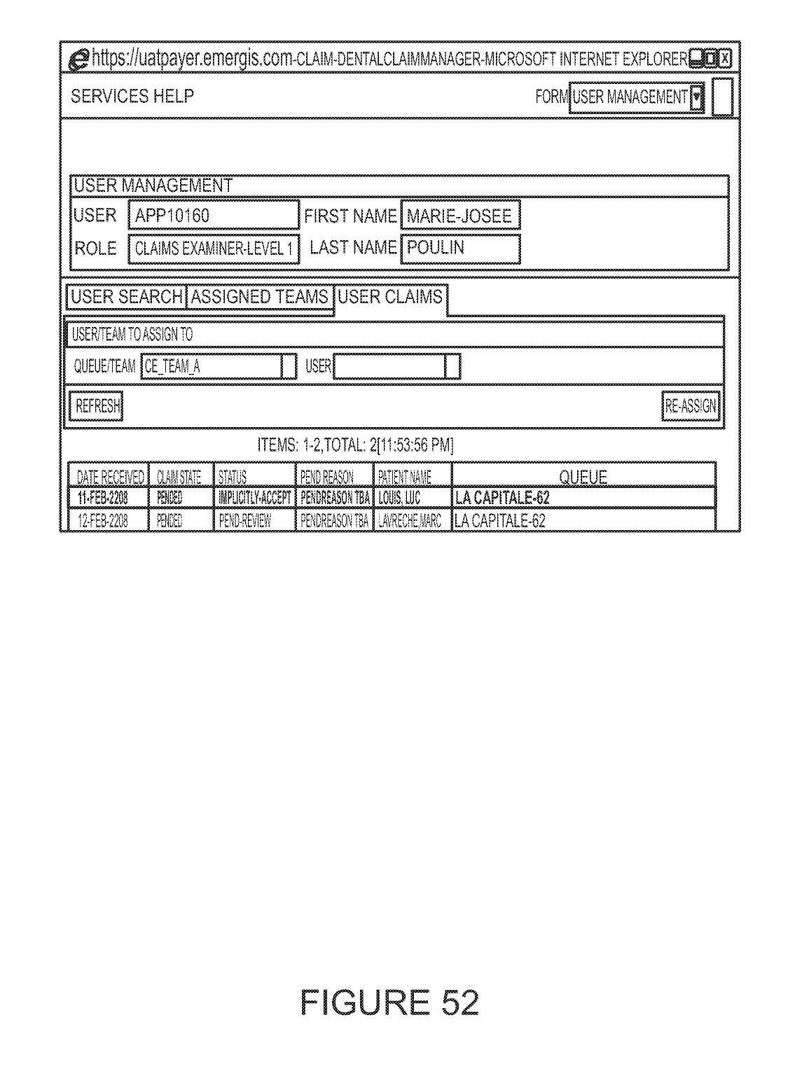

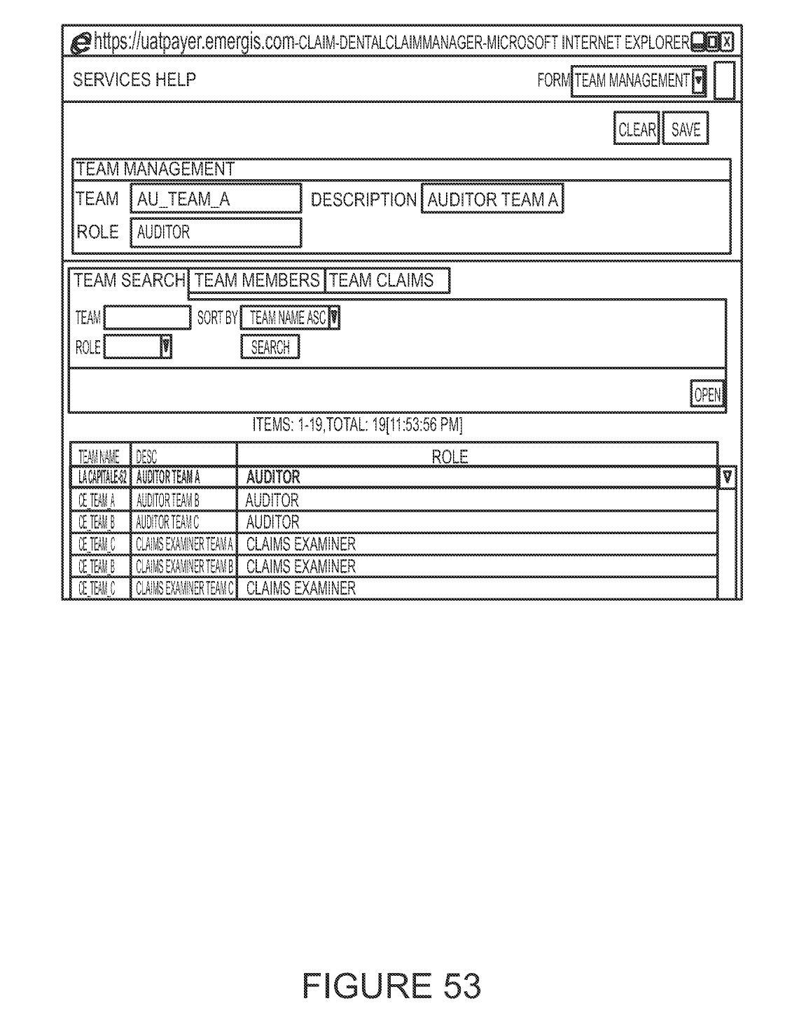

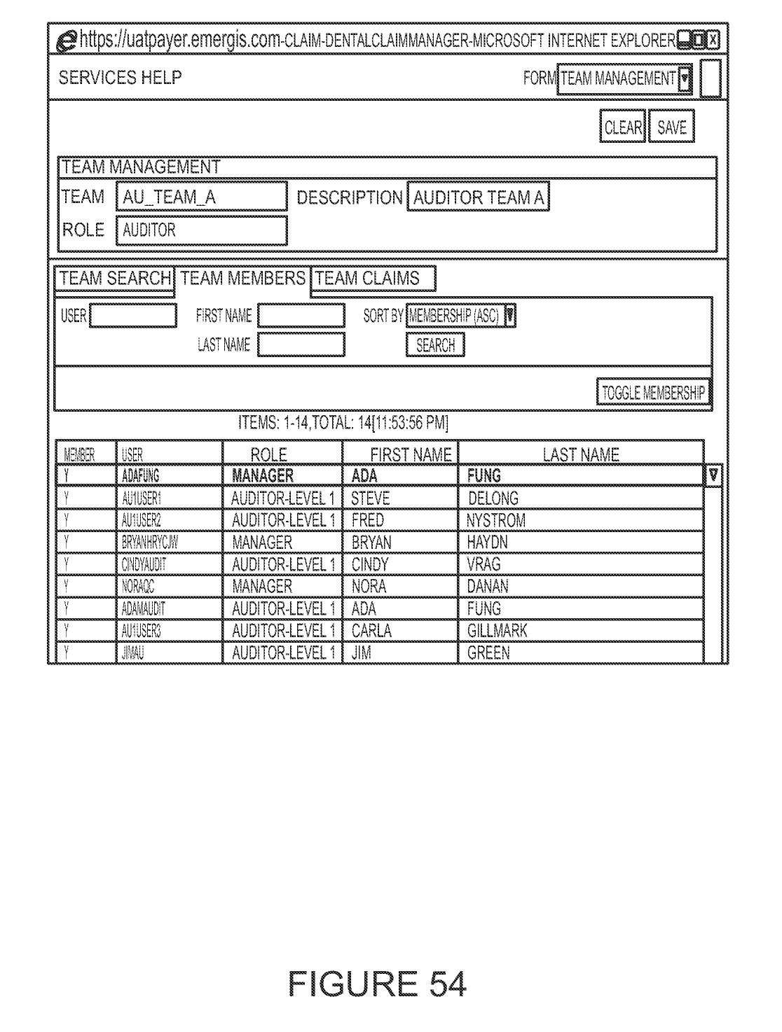

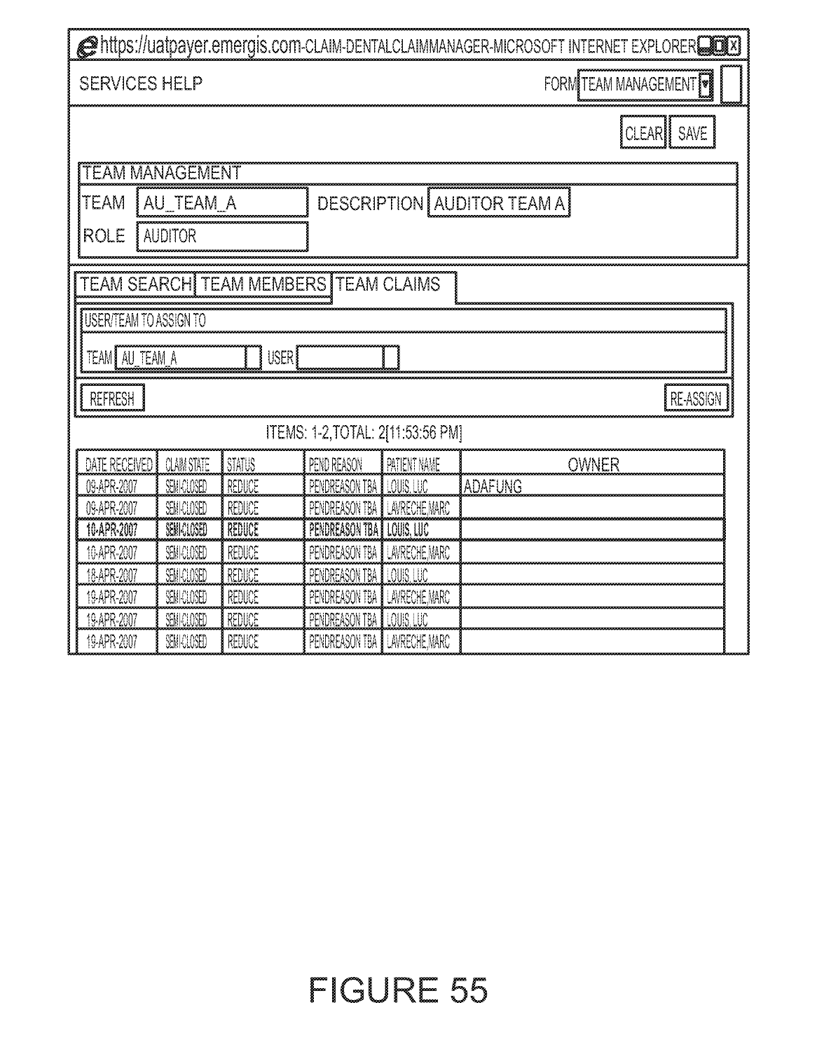

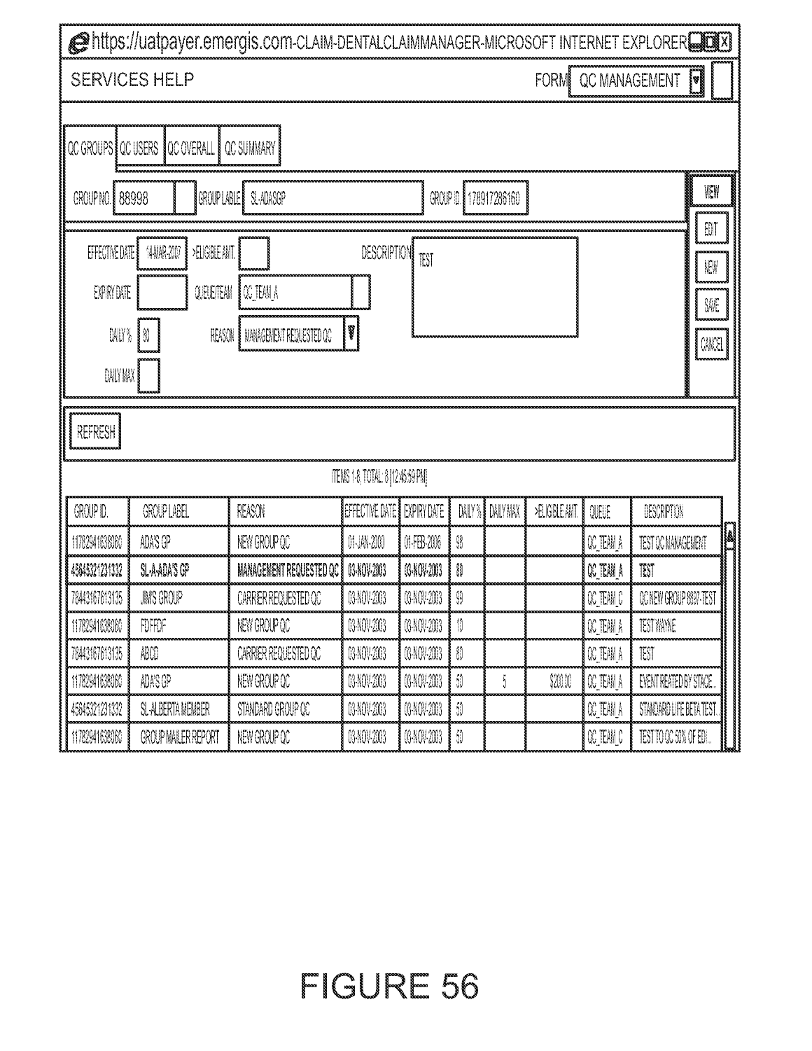

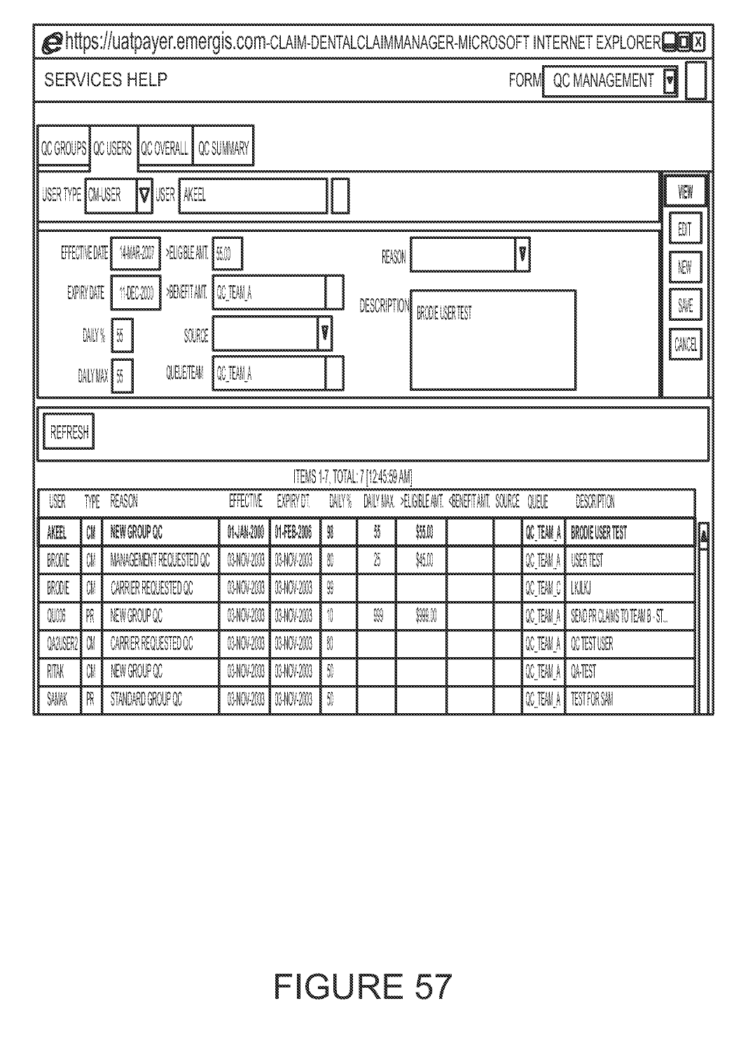

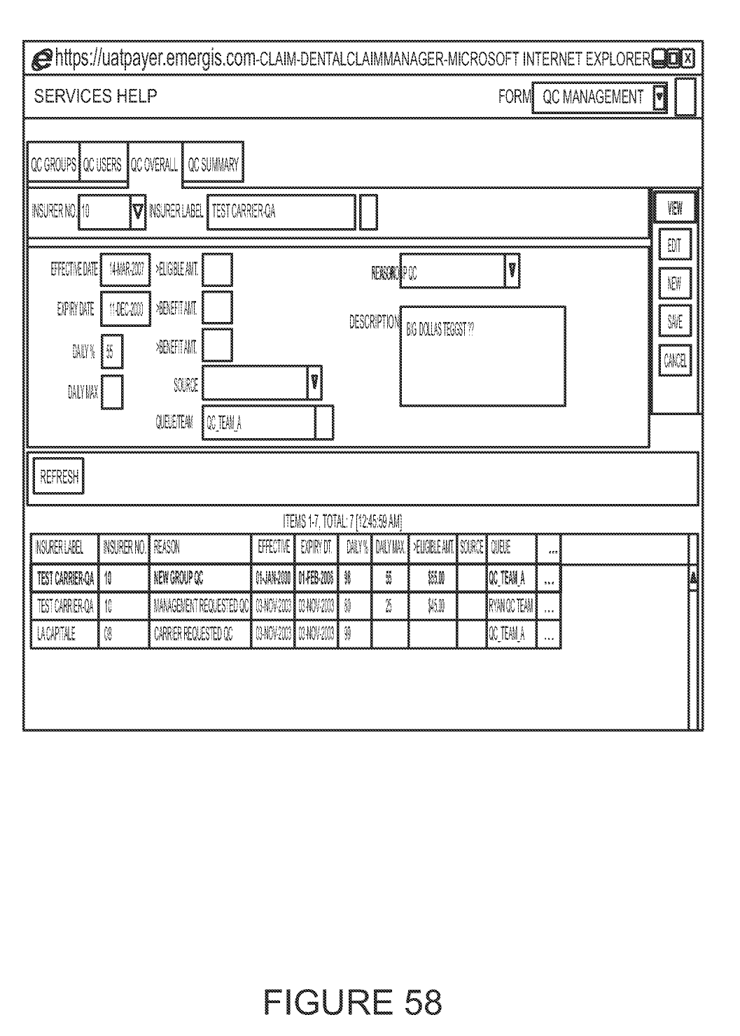

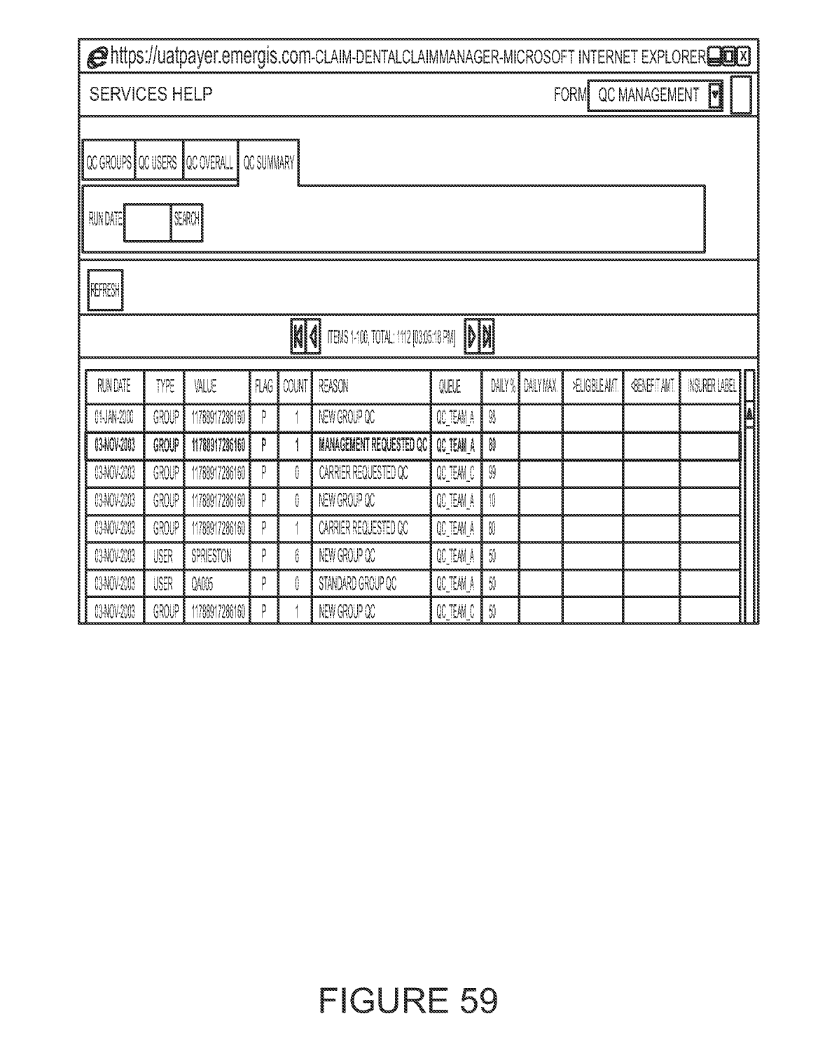

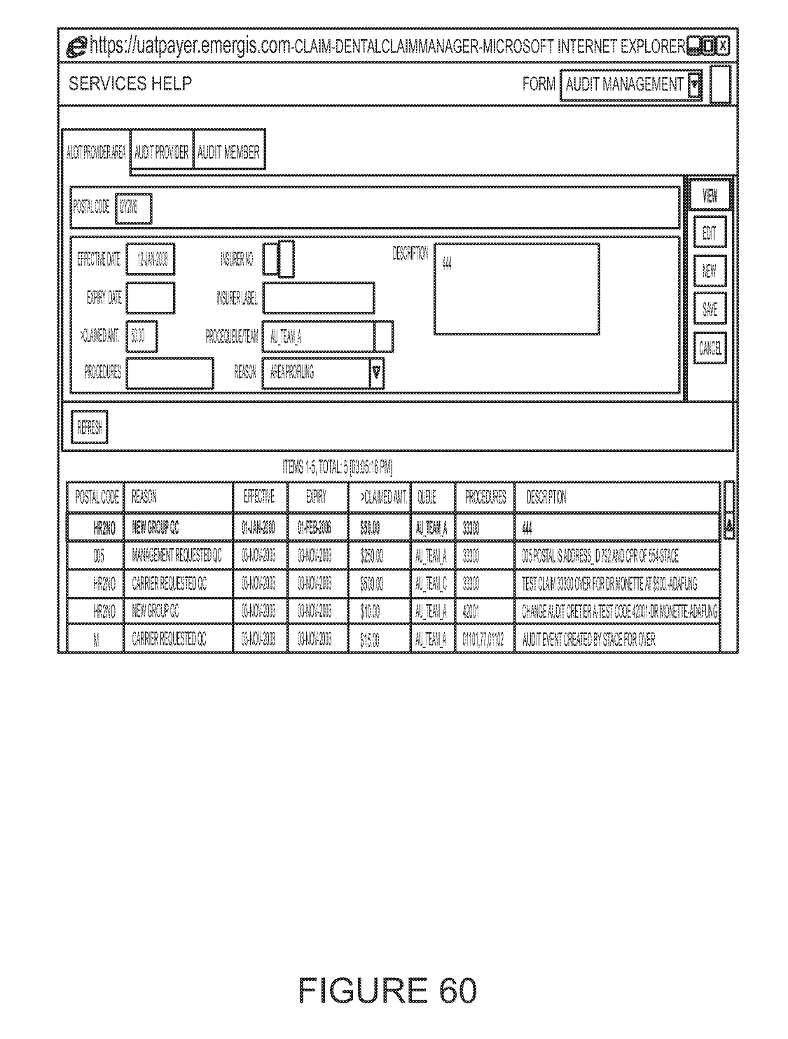

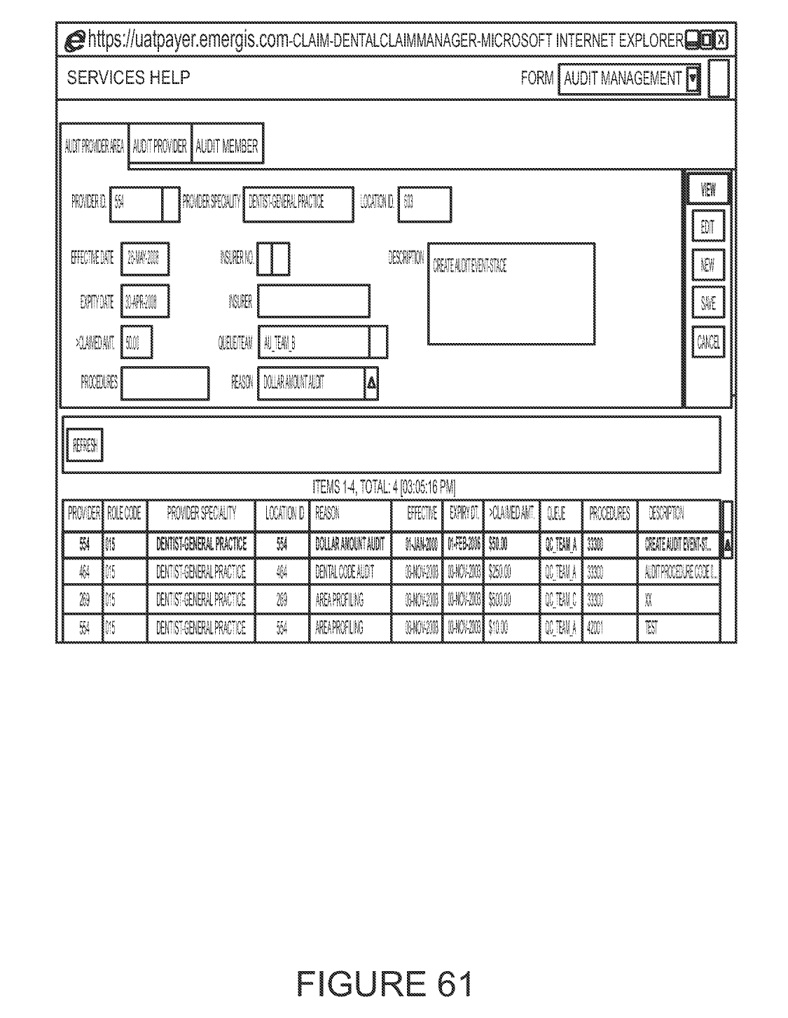

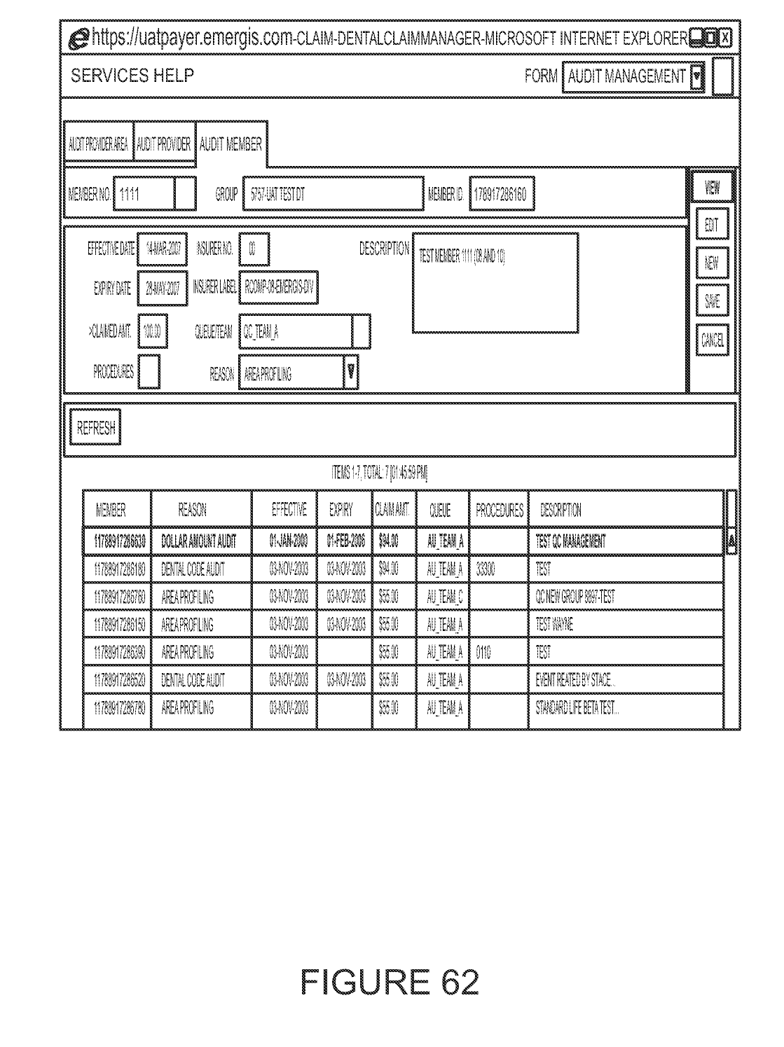

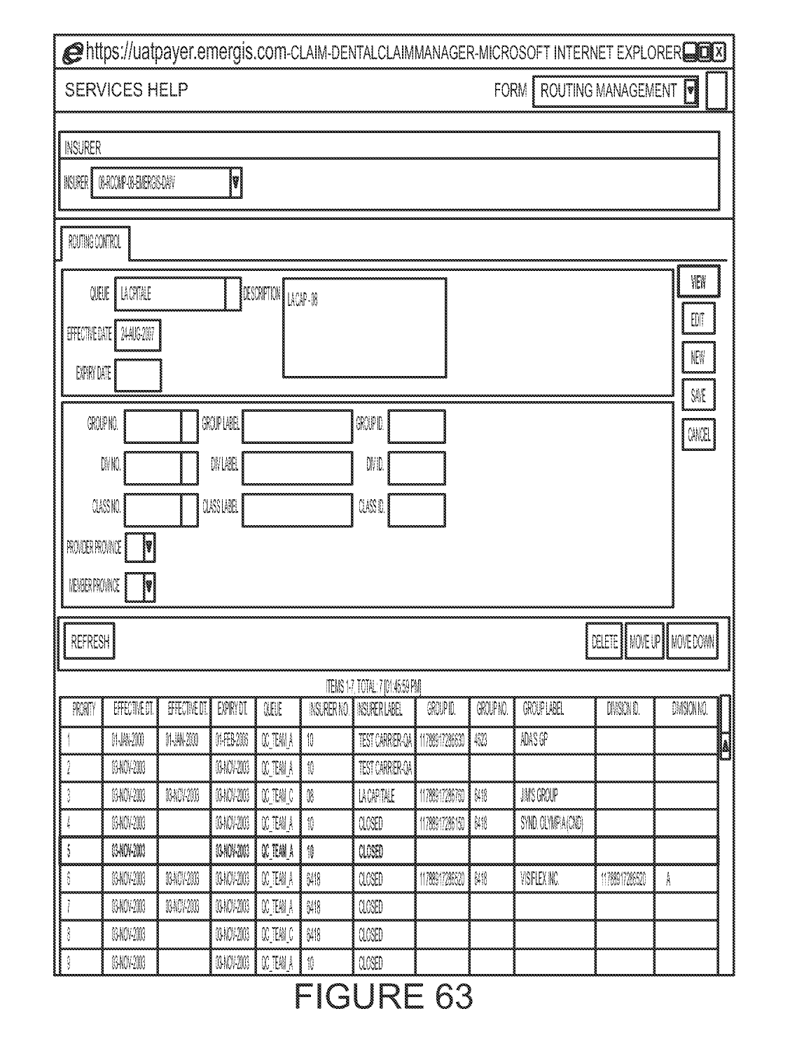

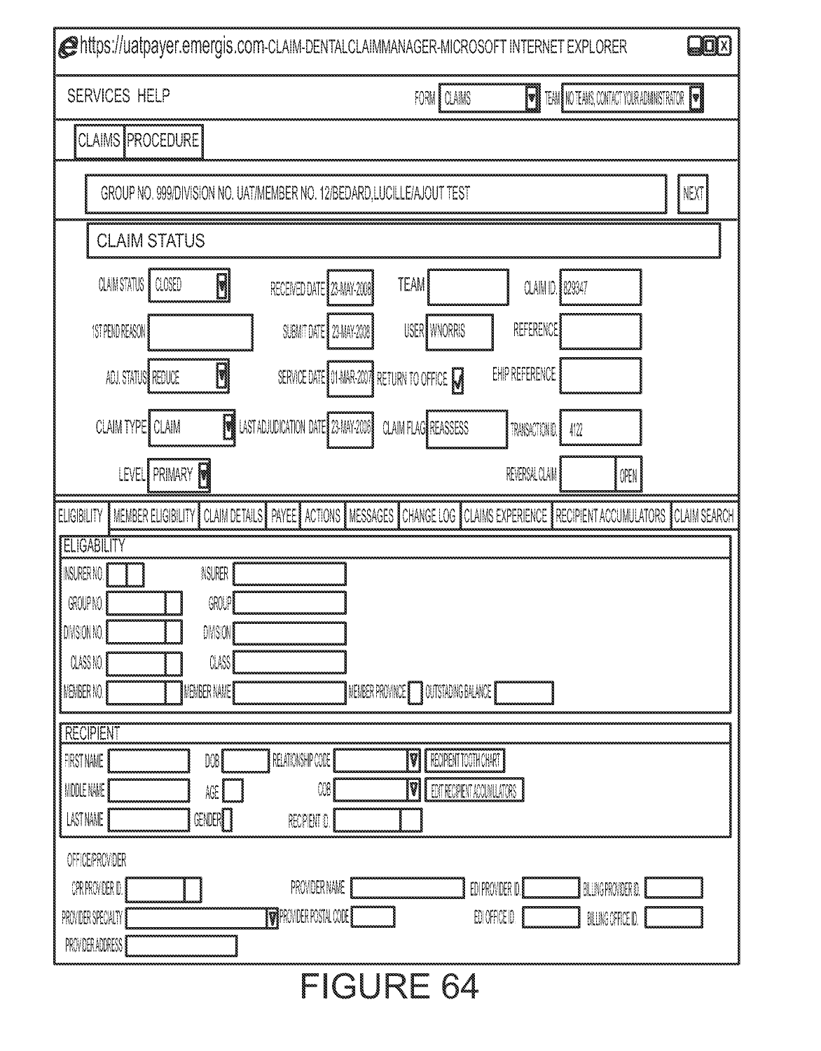

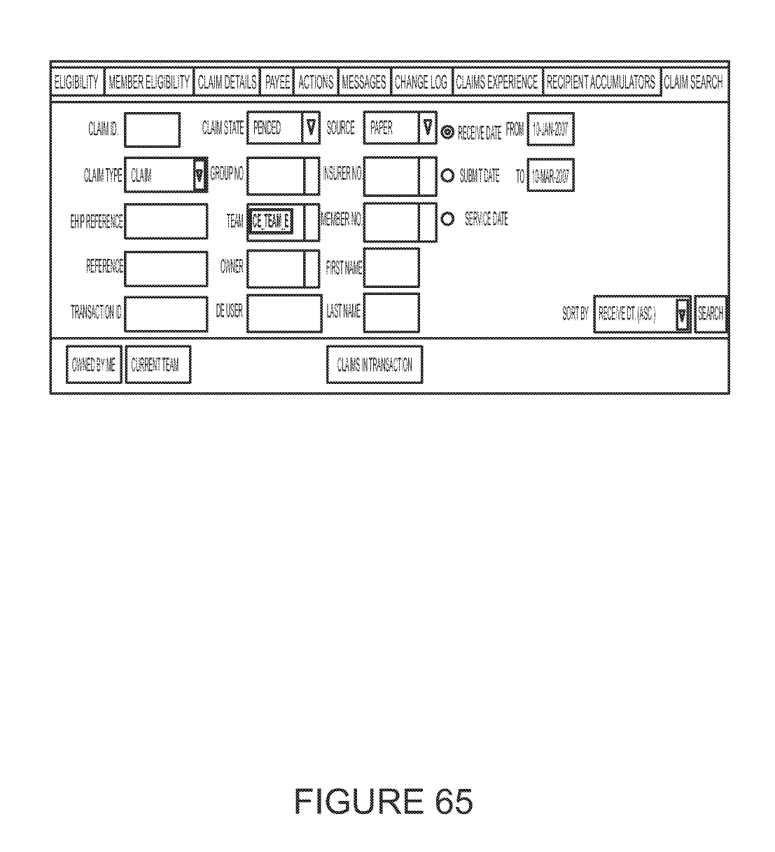

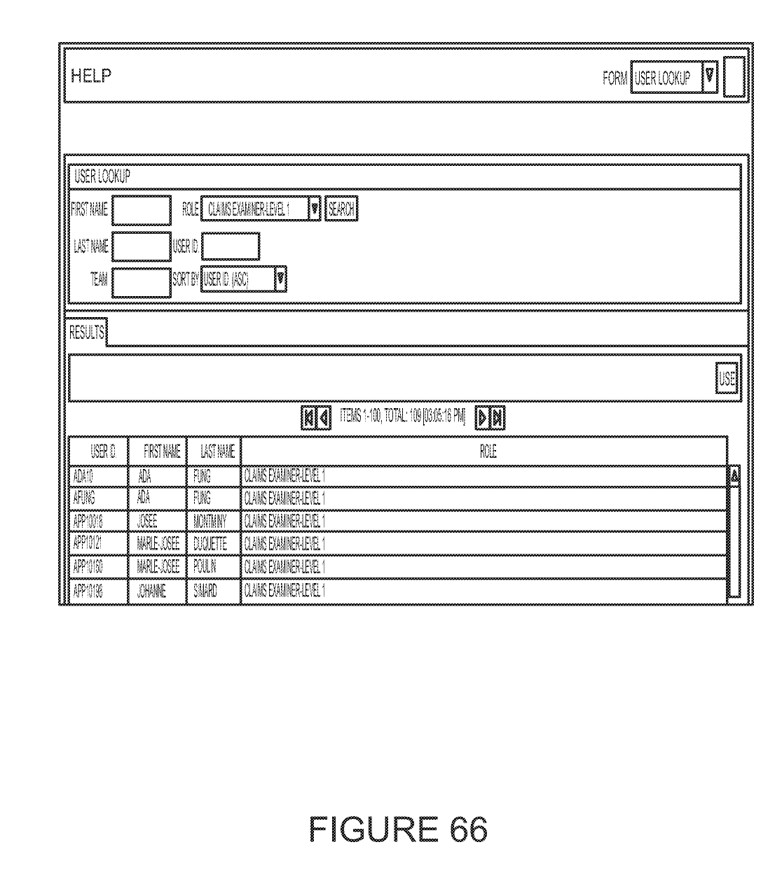

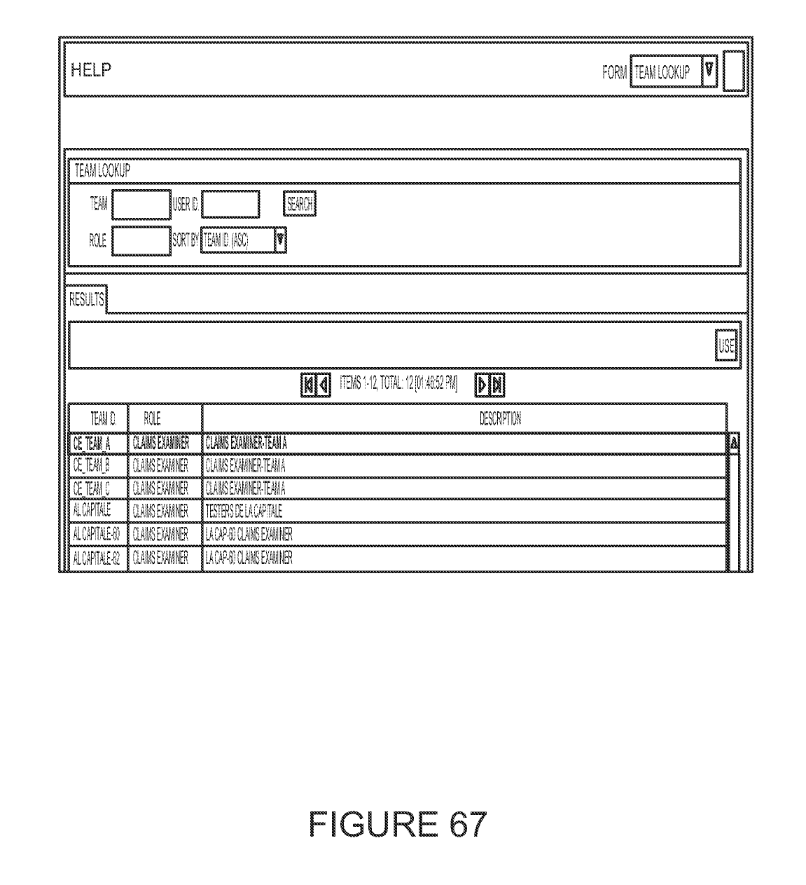

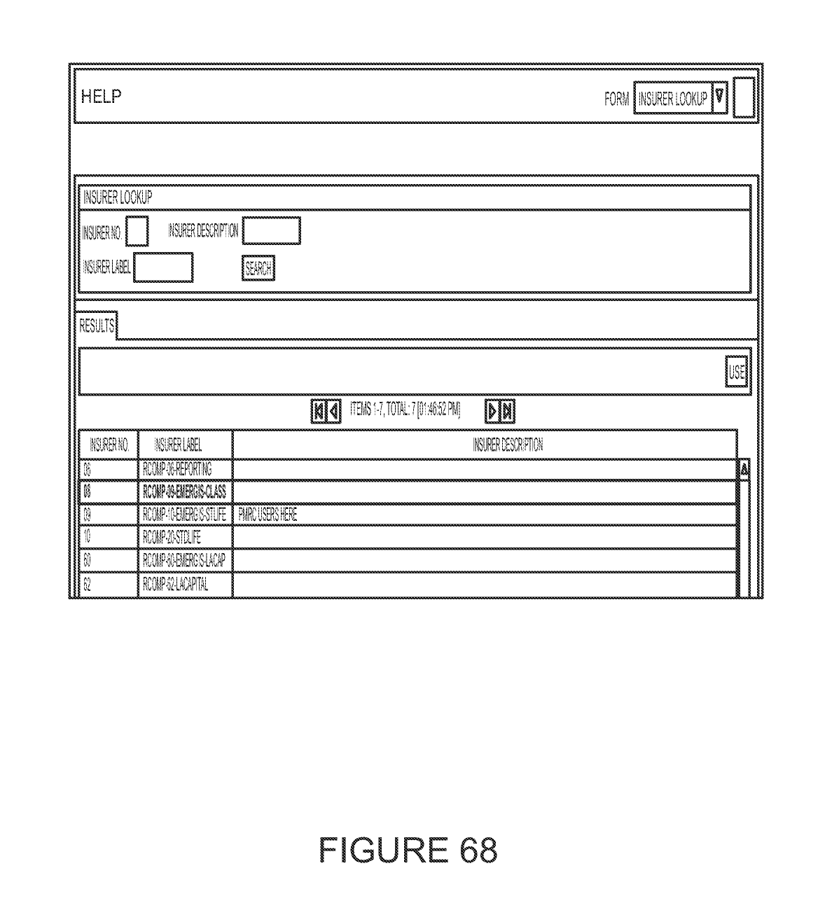

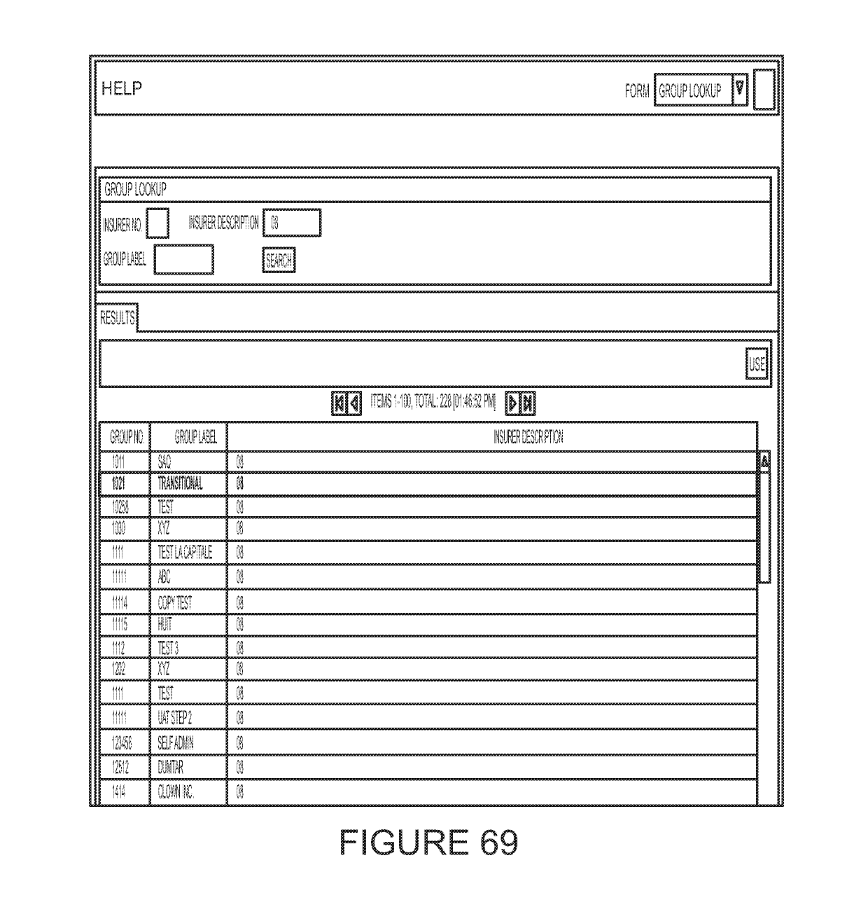

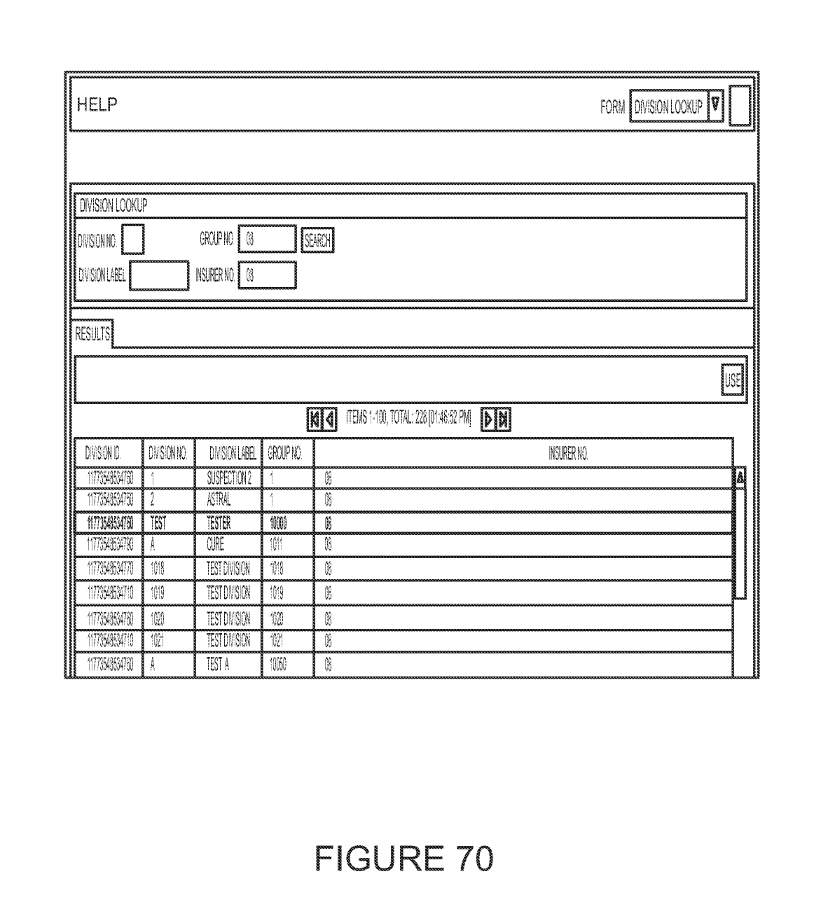

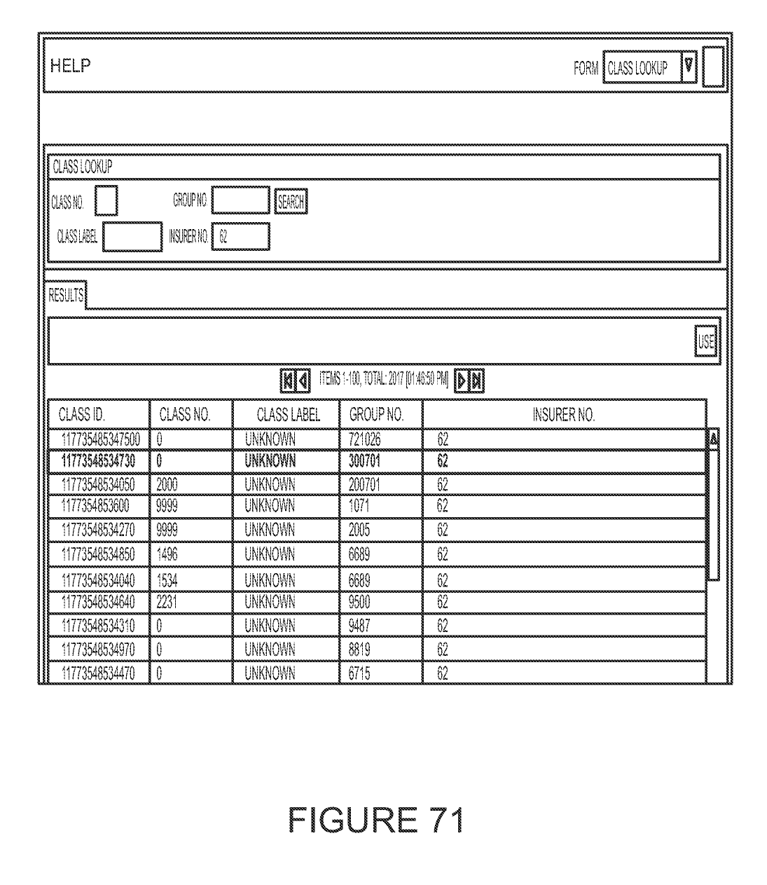

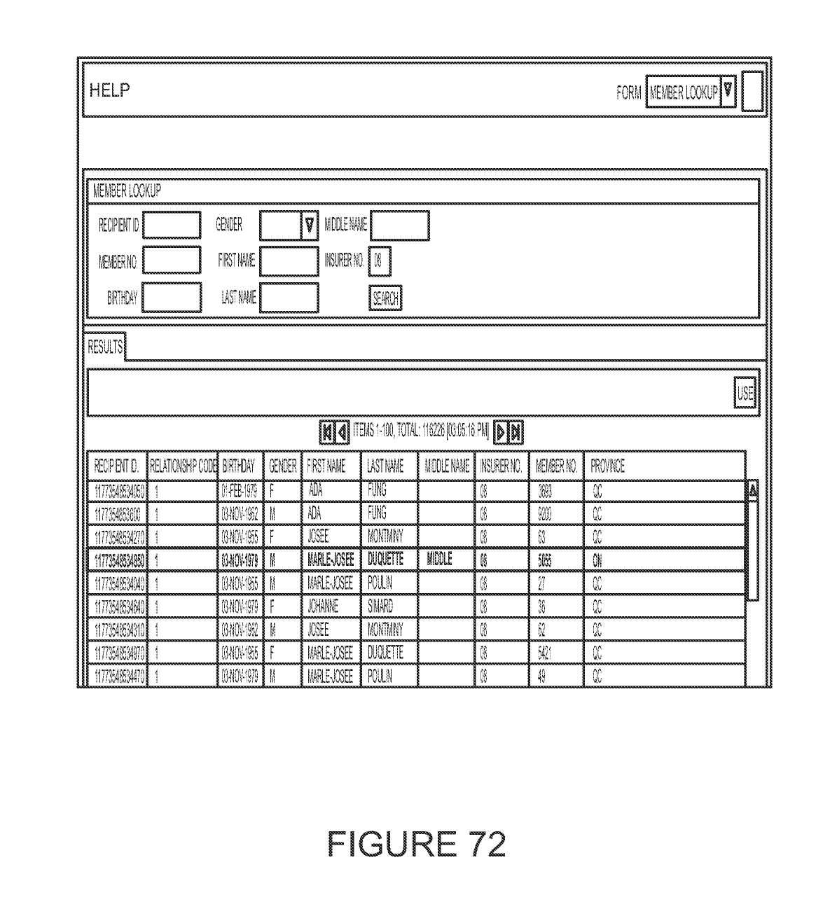

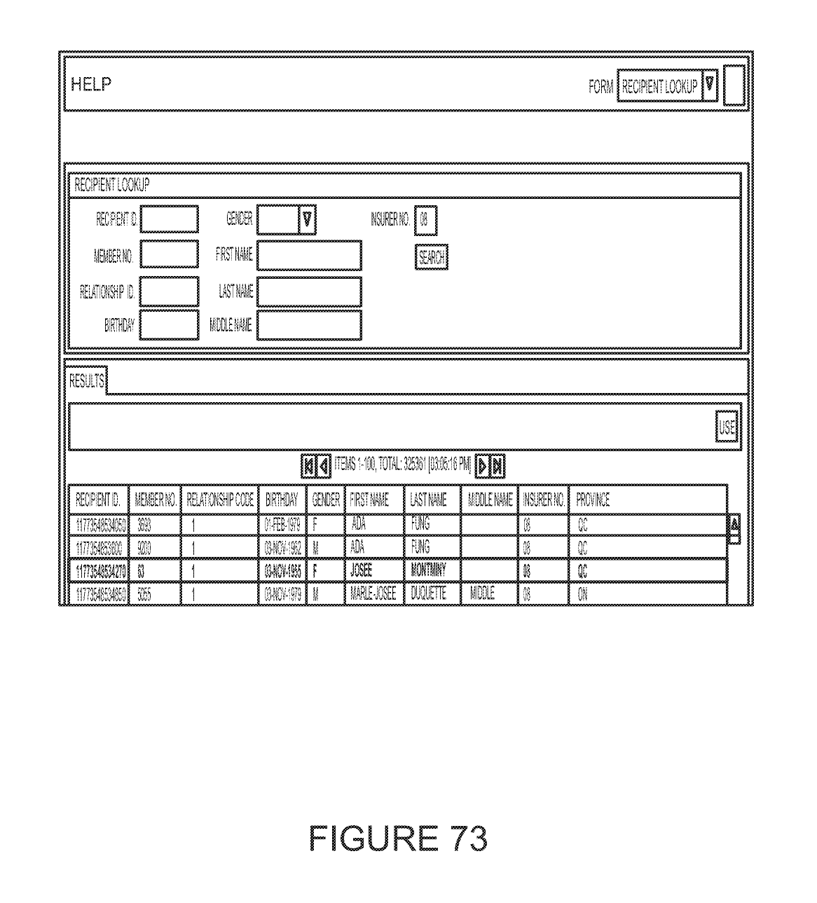

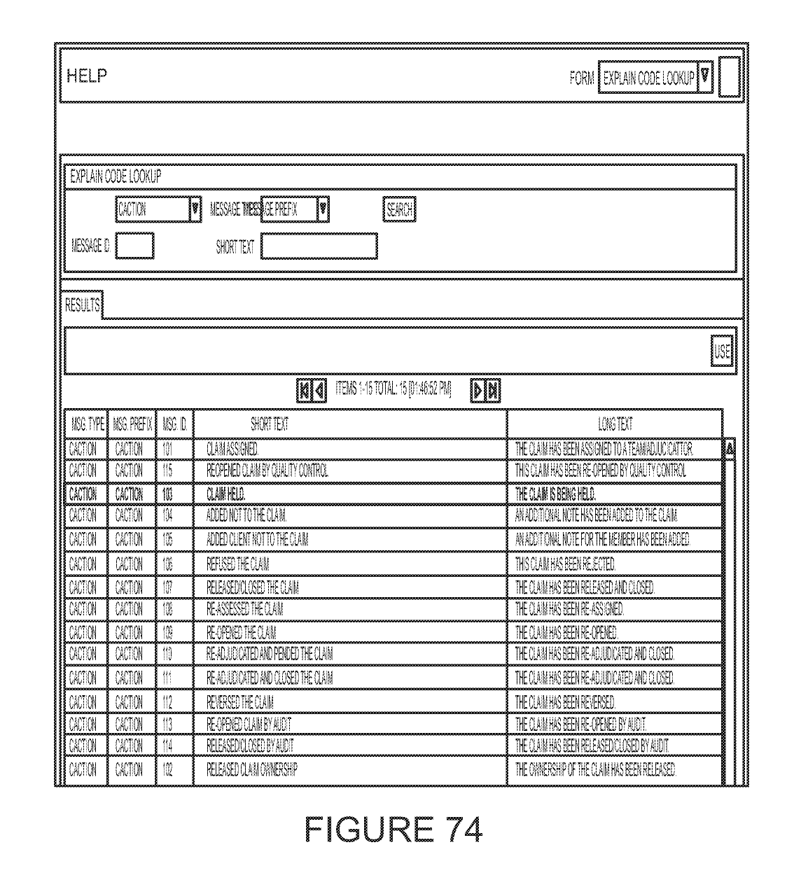

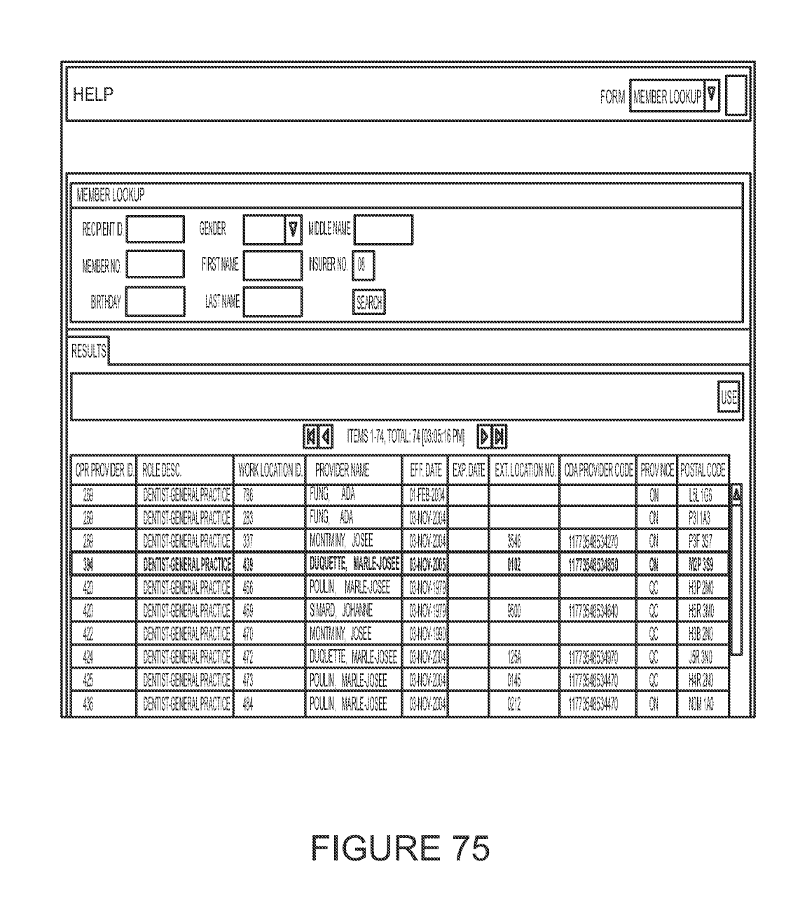

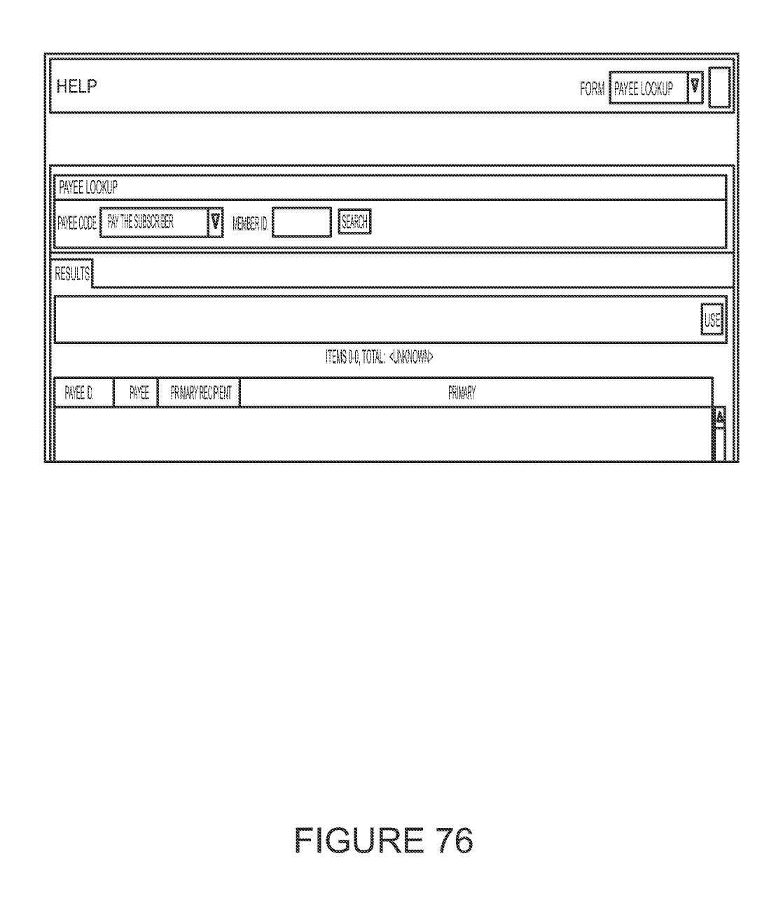

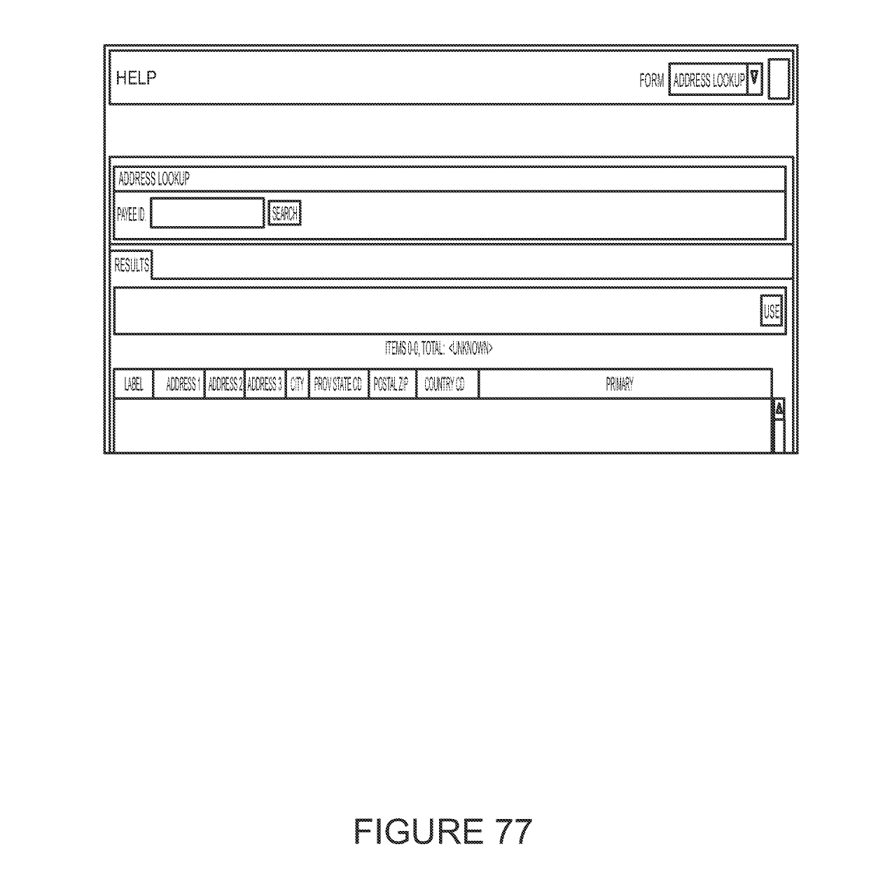

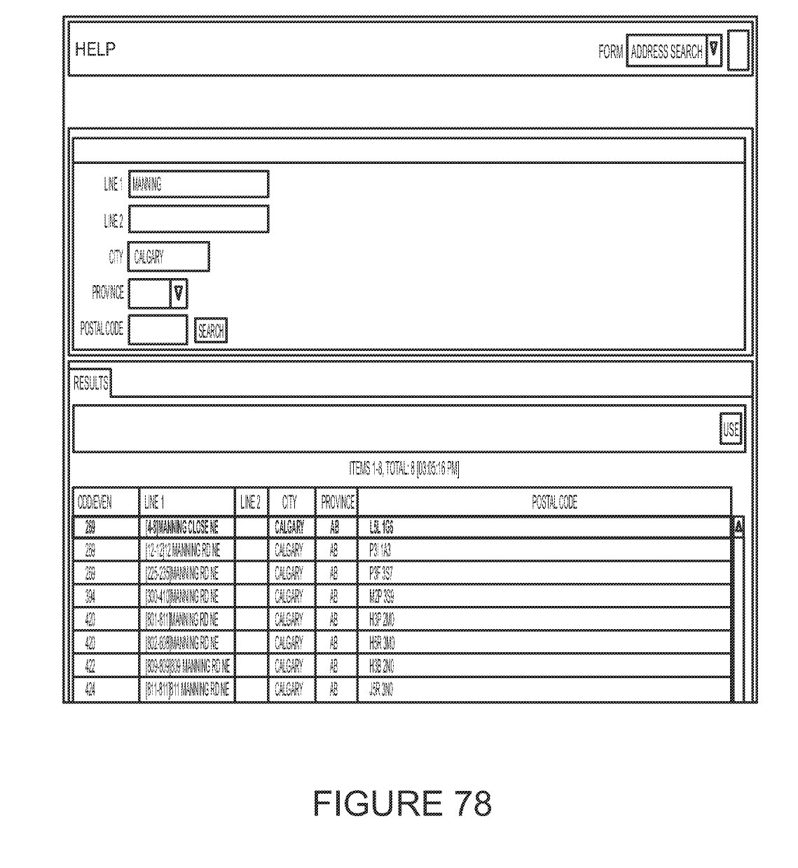

Referring to FIG. 26, operation 560 of the engine 50 is shown, for revising one or more hierarchies 260,360 of an insurance plan 42, the insurance plan 42 for use in adjudicating one or more insurance claims 12. At step 562, obtaining one or more claims 12 from a claims queue 53, the claims queue 53 for storing claims 12 selected for review (e.g. due to adjudication error(s), fraud considerations, and/or quality control considerations). At step 564; accessing at least one of a set of benefit codes 103 or a set of adjudication rules 100 associated with the insurance plan 42 of the obtained one or more claims 12, wherein at least some of the set of benefit codes 103 or the set of adjudication rules 100 are structured in a plurality of containers 226,228,326,328. At step 566, reconfiguring selected content of the at least one of a set of benefit codes 103 or the set of adjudication rules 100 in view of identified reasons for review (e.g. due to adjudication error(s), fraud considerations, and/or quality control considerations) of the one or more claims 12. At step 568 storing the reconfigured at least one of a set of benefit codes 103 or the set of adjudication rules 100 in a memory 224,528 for subsequent use as at least one of a redeployed version of the insurance plan 42 or a revised said at least one of a set of benefit codes 103 or the set of adjudication rules 100 for use in development of other insurance plans 42 for adjudication of claims 12 other than the one or more claims 12 obtained from the claims queue 53, wherein the revised insurance plan 42, once deployed, is adapted for use by an adjudication engine 40 for processing insurance claims 12 received by the adjudication engine 40.

In view of the above described system 10, it is recognised that the system 10 is not limited to dental type insurance, but other forms of insurance as well. The features of the system 10 include such as but not limited to: 1) the rule composer 200 creating containerized rule and benefit hierarchies 260,360; 2) the adjudication engine 40 using the containerized data structure 260,360 in claim 12 adjudication; management/assignment of the plans 42, using the containerized rule and benefit hierarchies 260,360 output of the rule composer 200; and 4) leveraging the containerized rule and benefit hierarchies 260,360, in the context of claim adjudication review 412, to revise/update 414 the containerized rule and benefit hierarchies 260,360 of the respective plan 42 for subsequent use by the adjudication engine 40 (i.e. to increase auto adjudication levels). Further, the aspect of the plan manager 44 can be generalized to include the creation of additional components to the hierarchies 260,360. The composer 200 is used to generate “template” hierarchies 260,360 for use by the plan manager 44 in customization and deployment of the customized hierarchies 260,360 as a plan 42 for use by the adjudication engine 40. The plan manager 44 can also add to (e.g. create) or otherwise amend the “template” hierarchies 260,360 to generate the customized hierarchies 260,360, as needed during the plan management/assignment processes.

### Example Implementation of the Reconfiguration/Review Engine 50

Referring to the following pages, the engine 50 is referred to as a claim manager, which is used as an application, i.e. a set of instructions stored on a computer readable medium that is executable by a computer processor (see FIG. 13). It is also recognised that all example display screens could be configured for display on the user interface 102 of the device(s) 101 associated with use of the engine 50 by the user. The engine 50 is used to reconfigure/revise the configured adjudication rules 100 and benefits 103 in their configured hierarchy 260,360 (e.g. of the deployed plan 42) iv view of the reviewed associated claim 12 or set of claims obtained from the claim queue 53, for use by the adjudication engine 40, see FIG. 2. It is recognised that the following example is only meant as one embodiment of a number of possible embodiments of the contents and functionality of the engine 50 and it's modules, as well as any described interaction with other engines (e.g. the rule composer aka the composer engine 200 and the plan engine 44 aka the plan manager).

1. A method for revising one or more hierarchies of an insurance plan, the insurance plan for use in adjudicating one or more insurance claims, the method comprising the steps of:
obtaining one or more claims from a claims queue, the claims queue for storing claims selected for review;
accessing at least one of a set of benefit codes or a set of adjudication rules associated with the insurance plan of the obtained one or more claims, wherein at least some of the set of benefit codes or the set of adjudication rules are structured in a plurality of containers;
reconfiguring selected content of the at least one of a set of benefit codes or the set of adjudication rules in view of identified reasons for review of the one or more claims; and
storing the reconfigured at least one of a set of benefit codes or the set of adjudication rules in a memory for subsequent use as at least one of a redeployed version of the insurance plan or a revised said at least one of a set of benefit codes or the set of adjudication rules for use in development of other insurance plans for adjudication of claims other than the one or more claims obtained from the claims queue;
wherein the revised insurance plan, once deployed, is adapted for use by an adjudication engine for processing insurance claims received by the adjudication engine.

2. The method of claim 1, wherein the set of benefit codes are structured in a plurality of benefit containers including a primary benefit container and a plurality of secondary benefit containers, each of the plurality of secondary benefit containers coupled to the primary benefit container by a respective benefit container reference, each of the plurality of secondary benefit containers containing one or more benefit codes adapted for processing claim content of the one or more claims, each of the one or more benefit codes coupled to their respective secondary benefit container by a respective benefit reference, the set of benefit codes defining a benefit hierarchy.

3. The method of claim 2, wherein the set of adjudication rules is structured in a plurality of containers including a primary rule container and a plurality of secondary rule containers, each of the plurality of secondary rule containers coupled to the primary rule container by a respective container reference, each of the plurality of secondary rule containers containing one or more adjudication rules adapted for processing the claim content of the received claim, each of the one or more adjudication rules coupled to their respective secondary container by a respective rule reference, the set of adjudication rules defining a rule hierarchy.

4. The method of claim 2 further comprising the steps of selecting the primary benefit container for reconfiguration; the reconfiguring performed by reconfiguring the benefit hierarchy by performing at least one of adding an additional benefit container reference to the primary benefit container, modifying a container benefit parameter of at least one of the benefit container references, or deleting at least one of the existing benefit container references; and

5. The method of claim 2 further comprising the steps of selecting the primary rule container for reconfiguration; the reconfiguring performed by reconfiguring the rule hierarchy by performing at least one of adding an additional rule container reference to the primary rule container, modifying a rule container parameter of at least one of the rule container references, or deleting at least one of the existing rule container references.

6. The method of claim 2 further comprising the steps of reconfiguring the benefit hierarchy by performing at least one of adding an additional benefit reference to at least one of the secondary benefit containers, modifying a benefit reference parameter of at least one of the benefit references, or deleting at least one of the existing benefit references.

7. The method of claim 2, wherein at least one of the benefit references or the benefit container references is defined to include at least one of an effective date or a expiry date.

8. The method of claim 7, wherein the benefit container parameter is said at least one of an effective date or a expiry date.

9. The method of claim 2, wherein the reconfiguration to the benefit hierarchy includes a change to the respective reference of the benefit object selected from the group comprising: a change in the effective date of the reference; a change in the expiry date of the reference; a change in the benefit object version associated with the reference; a change to the definition content of the benefit codes or the benefit containers; and a change in the ordering of the references in the respective container.

10. The method of claim 4 further comprising the step of validating the reconfiguration of the insurance plan before redeploying the reconfigured insurance plan for subsequent use by the adjudication engine.

11. A system for revising one or more hierarchies of an insurance plan, the insurance plan for use in adjudicating one or more insurance claims, the system comprising:
a claims queue for obtaining one or more claims there from, the claims queue for storing claims selected for review;
a claims module adapted for accessing at least one of a set of benefit codes or a set of adjudication rules associated with the insurance plan of the obtained one or more claims, wherein at least some of the set of benefit codes or the set of adjudication rules are structured in a plurality of containers;
a reconfiguration module adapted for reconfiguring selected content of the at least one of a set of benefit codes or the set of adjudication rules in view of identified reasons for review of the one or more claims; and
a deployment module adapted for storing the reconfigured at least one of a set of benefit codes or the set of adjudication rules in a memory for subsequent use as at least one of a redeployed version of the insurance plan or a revised said at least one of a set of benefit codes or the set of adjudication rules for use in development of other insurance plans for adjudication of claims other than the one or more claims obtained from the claims queue;
wherein the revised insurance plan, once deployed, is adapted for use by an adjudication engine for processing insurance claims received by the adjudication engine.

12. The system of claim 11, wherein the set of benefit codes are structured in a plurality of benefit containers including a primary benefit container and a plurality of secondary benefit containers, each of the plurality of secondary benefit containers coupled to the primary benefit container by a respective benefit container reference, each of the plurality of secondary benefit containers containing one or more benefit codes adapted for processing claim content of the one or more claims, each of the one or more benefit codes coupled to their respective secondary benefit container by a respective benefit reference, the set of benefit codes defining a benefit hierarchy.

13. The system of claim 12, wherein the set of adjudication rules is structured in a plurality of containers including a primary rule container and a plurality of secondary rule containers, each of the plurality of secondary rule containers coupled to the primary rule container by a respective container reference, each of the plurality of secondary rule containers containing one or more adjudication rules adapted for processing the claim content of the received claim, each of the one or more adjudication rules coupled to their respective secondary container by a respective rule reference, the set of adjudication rules defining a rule hierarchy.

14. The system of claim 12 further comprising a benefit module as the reconfiguration module adapted for selecting the primary benefit container for reconfiguration; the reconfiguring performed by reconfiguring the benefit hierarchy by performing at least one of adding an additional benefit container reference to the primary benefit container, modifying a container benefit parameter of at least one of the benefit container references, or deleting at least one of the existing benefit container references; and

15. The system of claim 12 further comprising a role module as the reconfiguration module adapted for selecting the primary rule container for reconfiguration; the reconfiguring performed by reconfiguring the rule hierarchy by performing at least one of adding an additional rule container reference to the primary rule container, modifying a rule container parameter of at least one of the rule container references, or deleting at least one of the existing rule container references.

16. The system of claim 12 further comprising a benefit module as the reconfiguration module adapted for reconfiguring the benefit hierarchy by performing at least one of adding an additional benefit reference to at least one of the secondary benefit containers, modifying a benefit reference parameter of at least one of the benefit references, or deleting at least one of the existing benefit references.

17. The system of claim 12, wherein at least one of the benefit references or the benefit container references is defined to include at least one of an effective date or a expiry date.

18. The system of claim 17, wherein the benefit container parameter is said at least one of an effective date or a expiry date.

19. The system of claim 12, wherein the reconfiguration to the benefit hierarchy includes a change to the respective reference of the benefit object selected from the group comprising: a change in the effective date of the reference; a change in the expiry date of the reference; a change in the benefit object version associated with the reference; a change to the definition content of the benefit codes or the benefit containers; and a change in the ordering of the references in the respective container.

20. The system of claim 14 further comprising a validation module adapted for validating the reconfiguration of the insurance plan before redeploying the reconfigured insurance plan for subsequent use by the adjudication engine.

21. The system of claim 12, wherein an execution order of the benefit codes is associated with the ordering of the container references in the primary benefit container.

22. The system of claim 13, wherein an execution order of the adjudication rules is associated with the ordering of the container references in the primary rule container.
